(19) United States
(12) Patent Application Publication
(10) Pub. No.: US 2024/0356334 A1
(43) Pub. Date: Oct. 24, 2024

(54) SYSTEMS AND METHODS FOR CONTROL OF ZERO-SEQUENCE STABILIZED POWER CONVERTERS

(71) Applicant: The Trustees of Columbia University in the City of New York, New York, NY (US)

(72) Inventors: Matthias Preindl, New York, NY (US); Liwei Zhou, New York, NY (US); William-Michael Eull, Oakville, Ontario (CA); Matthew Jahnes, New York, NY (US)

(21) Appl. No.: 18/292,316

(22) PCT Filed: Jul. 27, 2022
(86) PCT No.: PCT/US2022/038557

§ 371 Date: Jan. 25, 2024

Related U.S. Application Data
(60) Provisional application No. 63/226,059, filed on Jul. 27, 2021.
(60) Provisional application No. 63/226,136, filed on Jul. 27, 2021.
(60) Provisional application No. 63/242,840, filed on Sep. 10, 2021.
(60) Provisional application No. 63/270,311, filed on Oct. 21, 2021.
(60) Provisional application No. 63/319,122, filed on Mar. 11, 2022.
(60) Provisional application No. 63/345,896, filed on May 25, 2022.
(60) Provisional application No. 63/351,768, filed on Jun. 13, 2022.

(51) Int. Cl. H02J 3/32; H02M 1/00; H02M 1/08; H02M 1/12; H02M 7/797; H02M 7/81

(52) U.S. Cl. CPC H02J 3/322; H02M 1/0043; H02M 1/007; H02M 1/083; H02M 1/126; H02M 7/797; H02J 2203/20; H02M 1/0058; H02M 1/009; H02M 7/81

(57) ABSTRACT

Disclosed are implementations that include a power converter system including a non-isolated N-phase DC/AC power converter, for N≥1, with a DC voltage section and an N-phase AC voltage section, with the power converter including energy storage arrangements for each of three phases of the AC voltage section. The energy storage arrangements are commonly electrically coupled to the terminals of the DC voltage section. The system further includes a controller to control voltages at the energy storage arrangements, with the controller including one or more switching devices to control voltages at one or more terminals of the energy storage arrangements, and at least one model predictive control (MPC) module to generate control signaling, based on electrical operational characteristics of at least some of storage elements, to actuate the one or more switching devices to establish zero sequence voltage stabilization behavior at the terminals of the energy storage arrangements.

### CROSS-REFERENCE TO RELATED APPLICATIONS

This application claims priority to U.S. Provisional Application No. 63/226,136, filed on Jul. 27, 2021, U.S. Provisional Application No. 63/242,840, filed on Sep. 10, 2021, U.S. Provisional Application No. 63/345,896, filed May 25, 2022, U.S. Provisional Application No. 63/351,768, filed on Jun. 13, 2022, U.S. Provisional Application No. 63/226,059, filed Jul. 27, 2021, U.S. Provisional Application No. 63/270,311, filed Oct. 21, 2021, and U.S. Provisional Application No. 63/319,122, filed Mar. 11, 2022, each of which is hereby incorporated by reference in its entirety.

### STATEMENT REGARDING FEDERALLY SPONSORED RESEARCH

This invention was made with government support under 1653574 awarded by the National Science Foundation. The government has certain rights in the invention.

### BACKGROUND

Power converters of various types have been produced and used in many industries and contexts. Example power converters include alternating current (AC) to direct current (DC) rectifiers, DC to AC inverters, and DC to DC converters. AC to DC rectifiers, also referred to as AC/DC rectifiers, converter AC power to DC power. DC to AC inverters, also referred to as DC/AC inverters, convert DC power to AC power. Power converters can be used for various purposes, such as rectifying AC power from an AC grid power source to DC power for charging a battery, or inverting DC power from a battery to AC power to drive a motor or supply AC power to an AC grid. Further, power converters can be used in various contexts, such as in or connected to an electric vehicle, an engine generator, solar panels, and the like.

### SUMMARY

Power converters may be described in terms of power conversion efficiency, power density, and cost, among other characteristics. Generally, it is desirable to have power converters with higher power efficiency, higher power density, and lower cost. A highly efficient power converter is able to convert power (e.g., AC to DC, DC to AC, and/or DC to DC) without significant losses in energy. A low efficiency power converter experiences higher losses in energy during the power conversion. Such energy losses may manifest as heat generated by the power converter while converting power, for example. Power efficiency for a power converter, inductor, or other electronic component may be expressed as a percentage between 0 and 100% and determined based on the power input to the component and the power output from the component using the equation:

$$Power Efficiency = \frac{Power Out}{Power In} .$$

A power converter with high power density has a high ratio of power output by the power converter compared to the physical space occupied by the power converter. The power density can be calculated using the equation:

$$Power Density = \frac{Power Out}{Volume of Power Converter} .$$

Energy costs, including monetary costs and environmental costs, continue to be an important factor across many industries that incorporate power converters. Accordingly, even slight increases (e.g., of tenths of a percent) in power efficiency for a power converter can be significant and highly desirable. Similarly, reductions in materials and size of power converters can be significant and highly desirable, allowing reductions in costs and physical space to accommodate power converters in systems that incorporate power converters.

In grid-connected power converter applications, such as electric vehicle (EV) chargers and photovoltaic (PV) power supplies, leakage current and DC bus utilization are factors that influence the performance. For the leakage current issue, a bulky line frequency transformer is typically installed to block the leakage path at the point of common coupling (PCC) which increases the cost, volume, and weight of the system. For the DC bus utilization, the DC bus voltage needs to be stepped up to be at least twice of the grid voltage amplitude to avoid saturation issue which brings extra switching losses and challenges to the switch voltage tolerance capability.

Some embodiments disclosed herein address these or other issues. For example, some embodiments disclosed herein are directed to non-isolated power converters with one or more of (i) injection of a multiple of an N-th phase harmonic for zero sequence voltage control, (ii) a cascaded control system, (iii) model predictive control (MPC) for active damping to mitigate resonance, (iv) variable frequency critical soft switching (VFCSS), and (v) modular converter blocks. These features may be included in embodiments of a power converter independently or in any combination. For example, a power converter may include one of the above-noted features, any two of the above-noted features, any three of the above-noted features, any four of the above-noted features, or all five of the above-noted features. Additionally, in combination with any of these embodiments, the power converter may include at least one LC filter for each of the N phases of the power converter (where N≥1), where a capacitor of each LC filter is connected to a DC bus positive or negative terminal of the power converter and, in some cases, a further a capacitor of each LC filter is connected to the other of the DC bus positive or negative terminal of the power converter. These capacitors of multiple phases having a common point connected to the DC bus positive or negative terminals create a bypassing path for zero sequence voltage control. The capacitor coupled to the DC bus positive terminal (an upper capacitor) may also reduce both EMI and the total ripple current handling requirements of the power converter without increasing the total capacitance or volume. In some embodiments disclosed herein, an additional drain-source capacitor (C_{DS}) is coupled across the drain and source terminals of the power switching elements, which can slow a voltage rise during an ON-to-OFF transition. This slowed voltage rise can, in turn, reduce the switching losses of the power switching elements.

Some embodiments disclosed herein include systems, methods, and other implementations (including hardware, software, and hybrid hardware/software implementations) directed to a modular model predictive control (MPC) method for a novel non-isolated N-phase DC/AC, for N≥1, converter with the capabilities of zero sequence voltage stabilization and, optionally, regulated common mode voltage injection (e.g., a third harmonic injection (THI) for a three-phase system, or any other multiple of harmonic) for the purpose of increasing the available fundamental frequency AC voltage magnitude for a given DC voltage. When N=1 or N=2, the DC/AC power converter is considered to be a single-phase system. When N=3, the power converter is a three-phase system, and when N>3, the power converter is referred to as a multiphase system. Although the description herein may focus on 3-phase system, the various implementations and features described are applicable to any number of phases.

This non-isolated topology is designed to connect the common point of three-phase LC filter capacitors and positive/negative DC bus terminals to bypass the zero-sequence leakage current. A zero-sequence voltage MPC controller stabilizes the zero-sequence capacitor voltage to be, in some embodiments, a constant of approximately half DC bus voltage. Thus, the leakage current flowing through the grid or other coupled elements is attenuated. Further, the regulated third harmonic voltage injection (THI) techniques disclosed herein improve the DC bus utilization. By adding the third harmonic to the zero-sequence voltage MPC reference, the stability and robustness are improved. Compared to traditional THI techniques, the grid connection power quality is improved because no extra harmonics are injected to the grid. Per-phase, explicit MPC simplifies the execution complexity on a controller (e.g., a digital signal processor (DSP)) and does not need to update the angular speed in the state space matrix, which allows for the MPC optimization offline. Compared with a traditional proportional integral (PI) controller, embodiments of the MPC controller disclosed herein provides power converter control with improved dynamic performance and control bandwidth with faster response.

In some examples, the power converter is driven using a variable frequency critical soft switching (VFCSS) scheme. The VFCSS scheme can provide improved efficiency and reduced filter volume (i.e., improved power density) for the power converter.

In some examples, the power converter is implemented through a combination of modular converter units or modules, also referred to as autoconverter modules (ACMs) that are coupled together like building blocks to form the power converter having desired specifications. Each ACM may include, for example, a circuit board having input and output connection terminals (e.g., to couple to other ACMs and a central controller), as well as a converter block including power switching elements and an LC filter (e.g., configured in a half bridge configuration).

In one embodiment, a power converter system comprises a non-isolated n-phase power converter, for N≥1, with a DC voltage section and an N-phase AC voltage section and the power converter includes power switching elements. A control system configured to control the power converter and is also configured to determine rotational reference frame targets. The rotational reference frame targets including a zero-sequence component target, where the zero-sequence component target is based on a multiple of N-th phase harmonic injection. The control system generates N control reference targets in a stationary reference frame, one for each of the n-phases of the n-phase power converter, based on the rotational reference frame targets and also generates control signals for the power switching elements based on the n control reference targets, and drive the power switching elements in accordance with the control signals.

In one embodiment, a method of converting voltage is introduced. The method includes a first step of determining rotational reference frame targets where the rotational reference frame targets including a zero-sequence component target where the zero-sequence component target is based on a multiple of N-th phase harmonic injection. The method includes a second step of generating N control reference targets in a stationary reference frame based on the rotational reference frame targets where one control reference target is generated for each of N-phases of a non-isolated N-phase power converter, where N≥1. The power converter includes a dc voltage section, an N-phase AC voltage section, and power switching elements. The method includes a third step of driving the power switching elements of the power converter in accordance with the N control reference targets.

In one embodiment, a power converter system comprises a non-isolated N-phase power converter, for N≥1, with a DC voltage section and an N-phase AC voltage section. The power converter includes, for each of the N-phases, an LC filter, power switching elements; and a cascaded control system to control the power converter. The cascaded control system may include: a central controller including a processing unit and the central controller configured to receive electrical operational characteristics of the power converter and generate at least n control reference targets including at least one control reference target for each of the N-phases of the power converter. At least one local model predictive control (MPC) controller, each of the at least one local MPC controllers corresponding to a phase of the N-phase power converter, including a local processing unit, and being configured to: receive a control reference target of the n control reference targets, and generate, using model predictive control (MPC), control signaling based on the control reference target to actuate at least one switching element of the power switching elements corresponding to the phase of the local MPC controller.

In one embodiment, a method of power converting is introduced. The method includes a first step of receiving, by a central controller of a cascaded control system including at least one local model predictive control (MPC) controller cascaded with the central controller, electrical operational characteristics of the power converter. The electrical operational characteristics being characteristics of a non-isolated n-phase power converter, for N≥1, with a DC voltage section and an N-phase AC voltage section, the power converter including power switching elements. The method includes a second step of generating, by the central controller, at least n control reference targets including at least one control reference target for each of the N-phases of the power converter. The method includes a third step of receiving, by each of the at least one local MPC controllers, a control reference target of the N control reference targets, and generating, by each of the at least one local MPC controller using model predictive control (MPC), control signaling based on the control reference target received to actuate at least one switching element of the power switching elements corresponding to a phase of the local MPC controller.

In one embodiment, a non-isolated N-Phase power converter system comprises a DC voltage section and an N-phase AC voltage section. For each of the N-phases an LC filter includes a switch-side inductor, capacitor, output-side inductor, power switching elements, and a sensor. The sensor is configured to sense a first electrical characteristic of a first component of the LC filter selected from the group of the switch-side inductor, capacitor, or output-side inductor, and to generate sensor data indicative of the first electrical characteristic. A controller power converter includes an electronic processor and the controller is configured to receive the sensor data from the sensor, perform state estimation, based on the sensor data, estimate a second electrical characteristic of a second component of the LC filter that is different from the first component, and to generate control signaling based on the second electrical characteristic, to drive the power switching elements.

In one embodiment, a method of power conversion with a non-isolated N-phase power converter is introduced. The method includes sensing, by a sensor, a first electrical characteristic of a first component of an LC filter of the power converter to generate sensor data indicative of the first electrical characteristic. The first component of the LC filter selected from the group of a switch-side inductor, a capacitor, or an output-side inductor. The method also includes receiving, by a local controller, the sensor data from the sensor. The method also includes performing state estimation, by the local controller based on the sensor data to estimate a second electrical characteristic of a second component of the LC filter that is different from the first component. The method also includes generating, by the local controller, control signaling to drive power switching elements associated with the lc filter based on the second electrical characteristic.

In one embodiment, a power conversion system comprises one or more power converter modules. Each power converter modules includes a positive direct current (DC) terminal and a negative DC terminal. A power switching element pair includes a high side power switching element coupled to the positive DC terminal and a low side power switching element coupled to the negative DC terminal. The high side power switching element and the low side power switching element are coupled together at a midpoint node. A LC filter is coupled to the midpoint node, the positive DC terminal, and the negative DC terminal. A local controller is configured to receive a control reference target and generate control signaling to drive the power switching element pair based on the control reference target using model predictive control (MPC) and variable frequency soft switching.

In one embodiment, a method of power conversion is introduced. The method includes receiving, by a local controller of a power converter module, a control reference target. The local controller is coupled to a power switching element pair which includes a high side power switching element coupled to a positive DC terminal for of the power converter module and a low side power switching element coupled to the negative DC terminal of the power converter module. The high side power switching element and the low side power switching element are coupled together at a midpoint node and an LC filter is coupled to the midpoint node, the positive DC terminal, and the negative DC terminal. The method also includes generating, by the local controller, control signaling to drive the power switching element pair based on the control reference target using model predictive control (MPC) and variable frequency soft switching. The method also includes filtering, by the LC filter, a power signal provided to or received from the midpoint node.

In one embodiment, the power converter system comprises a non-isolated N-phase power converter. For n≥1, the non-isolated N-phase power converter includes a DC voltage section, an N-phase AC voltage section; and a cascaded control system to control the power converter. The cascaded control system may include a central controller including a processing unit. The central controller is configured to receive electrical operational characteristics of the power converter and generate at least N control reference targets including at least one control reference target for each of the N-phases of the power converter. A plurality of local model predictive control (MPC) controllers including at least two local MPC controllers per phase of the N-phase power converter. Each local MPC controller is associated with a respective converter block that includes a pair of power switching elements and an LC filter for the phase corresponding to the local MPC controller. Each of the local MPC controllers are configured to receive a control reference target of the N control reference targets for the phase associated with the local MPC controllers and generate a control signaling based on the control reference signal to drive the pair of power switching elements associated with the local MPC controller using model predictive control.

In one embodiment, a method of voltage conversion with a non-isolated N-Phase power converter for N≥1 is introduced. The method includes receiving, a plurality of local model predictive control (MPC) controllers cascaded with the central controller by a central controller of a cascaded control system. The method also receives an electrical operational characteristic of the power converter where the power converter includes a DC voltage section, and an N-phase AC voltage section. The plurality of local MPC controllers include at least two local MPC controllers per phase of the N-phase power converter. Each local MPC controller is associated with a respective converter block that includes a pair of power switching elements and an LC filter for the phase corresponding to the local MPC controller. The method also includes generating at least N control reference targets including at least one control reference target for each of the N-phases of the power converter by the central controller. The method also includes receiving, by each of the local MPC controllers, a control reference target of the N control reference targets for the phase associated with the local MPC controller. The method also includes generating control signaling based on the control reference target received to drive the pair of power switching elements associated with the local MPC controller by each of the local MPC controllers, using model predictive control (MPC).

The foregoing and other aspects and advantages of the present disclosure will appear from the following description. In the description, reference is made to the accompanying drawings that form a part hereof, and in which there is shown by way of illustration one or more embodiment. These embodiments do not necessarily represent the full scope of the invention, however, and reference is therefore made to the claims and herein for interpreting the scope of the invention. Like reference numerals will be used to refer to like parts from Figure to Figure in the following description.

### BRIEF DESCRIPTION OF THE DRAWINGS

FIG. 1 illustrates a power converter system according to some embodiments.

FIG. 2 illustrates a half-bridge power converter according to some embodiments.

FIG. 3 illustrates multiphase power converter system according to some embodiments.

FIG. 4 illustrates a converter system according to some embodiments.

FIGS. 5A and 5B illustrate waveforms for third harmonic injection according to some embodiments.

FIG. 6 illustrates a communication system for a cascaded control system according to some embodiments.

FIG. 7 illustrates an MPC-based converter system according to some embodiments.

FIG. 8 illustrates a model predictive control (MPC) control system according to some embodiments.

FIG. 9 illustrates a state estimator according to some embodiments.

FIG. 10 illustrates a timing diagram and boundary conditions for soft switching according to some embodiments.

FIG. 11 illustrates a control system for variable frequency critical soft switching according to some embodiments.

FIG. 12 illustrates a power converter system including model predictive control (MPC) with variable frequency critical soft switching (VFCSS) according to some embodiments.

FIG. 13 illustrates a control system for local MPC-VFCSS control using variable-continuous-frequency critical-soft-switching (VCFCCS) according to some embodiments.

FIG. 14 illustrates a control system for local MPC-VFCSS control using variable-discrete-frequency critical-soft-switching (VDFCCS) according to some embodiments.

FIG. 15 illustrates waveforms for VCFCCS and VDFCCS control according to some embodiments.

FIG. 16 illustrates a plot of carrier signals and sampling signals for VDFCCS control according to some embodiments.

FIGS. 17A and 17B illustrate respective plots of experimental results of a power converter according to some embodiments.

FIGS. 18A and 18B illustrate autoconverter modules according to some embodiments.

FIG. 19 illustrates a power converter incorporating autoconverter modules according to some embodiments.

FIG. 20 illustrates a control diagram for a two-phase converter according to some embodiments.

FIG. 21 illustrates a process for converting voltage using harmonic injection, according to some embodiments.

FIG. 22 illustrates a process for converting voltage using a cascaded control system, according to some embodiments.

FIG. 23 illustrates a process for converting power using state estimation, according to some embodiments.

FIG. 24 illustrates a process for converting power using MPC-based control and variable frequency critical soft switching, according to some embodiments.

FIG. 25 illustrates a process for converting power with a modular power converter having multiple parallel converters per phase, according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “comprising,” “including,” “containing,” “having,” and variations thereof herein is meant to encompass the items listed thereafter and equivalents thereof as well as additional items. Additionally, the terms “connected” and “coupled” are used broadly and encompass both direct and indirect connecting and coupling, and may refer to physical or electrical connections or couplings. Furthermore, the phase “and/or” used with two or more items is intended to cover the items individually and both items together. For example, “a and/or b” is intended to cover: a (and not b); b (and not a); and a and b.

Disclosed herein are systems and methods related to power converters, also referred to as voltage converters, that can provide power conversion with increased power efficiency, increased power density, and/or reduced cost, among other advantages.

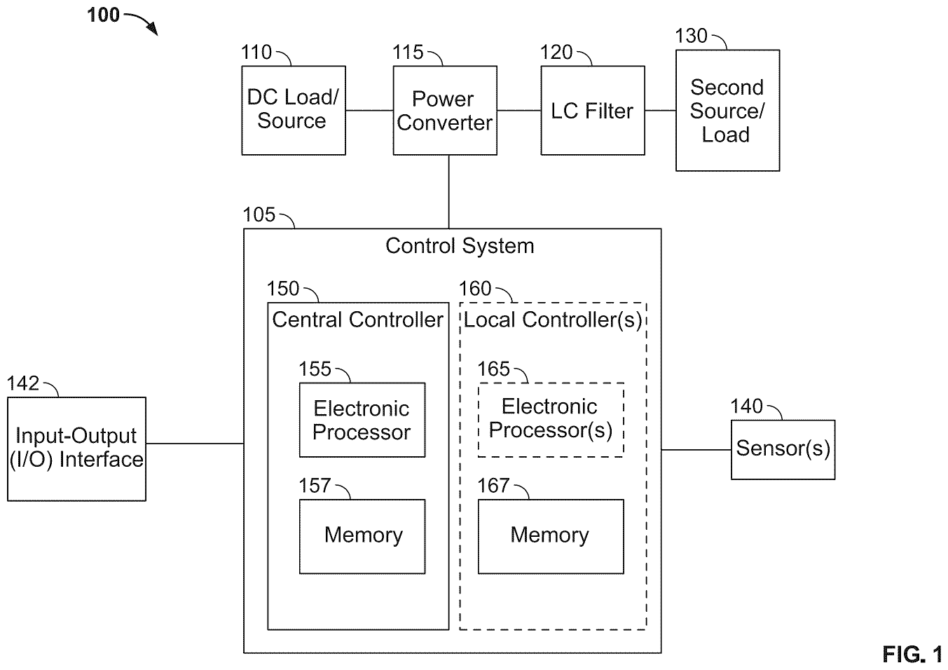

FIG. 1 illustrates a power converter system 100 in accordance with some embodiments. The power converter system 100 includes a control system 105, a first direct current (DC) load/source 110, a power converter 115, an LC filter 120, a second source/load 130, and one or more sensors 140. The control system 105 includes a central controller 150 with an electronic processor 155 and a memory 157, and, optionally, in some embodiments, includes one or more local controllers 160, each having an electronic processor 165 and a memory 167. The power converter system 100, as well as the other power converter systems provided herein, may be non-isolated power converter systems. That is, the power converter system may be coupled to an AC source (e.g., single or three phase power grid) or AC load (e.g., single or 3-phase motor) without a transformer. Use of a transformer is common in electrical circuits to provide isolation between the power converter and an AC source or load. However, such a transformer can add inefficiencies and size or volume to the power converter. Accordingly, power converter systems provided herein are non-isolated, also referred to as transformerless, to increase efficiency and/or reduce size of the power converter systems. Because the power converters are provided without isolation by a transformer, the power converters may include additional features to prevent transmission of unwanted signals or current (e.g., leakage current) from passing between the power converters and other circuit components (e.g., DC sources, DC loads, AC sources, AC loads, and other structures in contact with or supporting the power converters). These additional features may include LC filters, zero-sequence control of common mode voltage, harmonic injection, model predictive control, variable frequency critical soft switching, and the like described herein.

In operation, generally, the control system 105 controls power switching elements of the power converter 115 with control signaling (e.g., pulse-width modulated (PWM) signals) to convert power (i) from the DC load/source 110 functioning as a source to the second source/load 130 functioning as a load, or (ii) from the second source/load 130 functioning as a source to the DC load/source 110 functioning as a load. Accordingly, when the DC load/source 110 is functioning as a source for the power converter 115, the second source/load 130 is functioning as a load for the power converter 115. Conversely, when the DC load/source 110 is functioning as a load for the power converter 115, the second source/load 130 is functioning as a source for the power converter 115.

The DC load/source 110 may be a direct power (DC) load, a DC source, or both a DC load and DC source (i.e., functioning as DC source in some instances and as a DC load in other instances, depending on the mode of the power converter 115). In some examples, the DC load/source 110 is a battery. In other examples, DC load/source 110 may be a capacitor, an ultracapacitor, a DC power supply from rectified AC source (e.g., AC grid power converted to DC power by diode bridge rectifier), or the like. The second source/load 130 may be an AC load, an AC source, both an AC load and AC source (i.e., functioning as an AC source in some instances and as an AC load in other instances, depending on the mode of the power converter 115), a DC load, a DC source, both a DC load and DC source (i.e., functioning as a DC source in some instances and as a DC load in other instances, depending on the mode of the power converter 115). In some examples, the source/load 130 may be an electric (AC) motor, an AC generator, AC power supply grid, a DC battery, a DC capacitor, a DC ultracapacitor, a DC power supply from rectified AC source (e.g., AC grid power converted to DC power by diode bridge rectifier), or the like.

The DC load/source 110 is coupled to the power converter 115 at a first (DC) side or section of the power converter 115, and the second source/load 130 is coupled to the power converter 115 at a second (AC) side or section of the power converter 115. The first side may also be referred to as an input side or an output side of the power converter 115, depending on the mode of the power converter, or as a DC side of the power converter 115. The second side may also be referred to as an input side or an output side of the power converter, depending on the mode of the power converter, or as an AC side of the power converter 115. In some embodiments, the second side of the power converter 115 may be an AC side having single phase AC power, three-phase AC power, or AC power with another number of phases.

In some embodiments, the power converter 115 operates with a high DC voltage level. For example, in operation, the DC side of the power converter 115 has a DC voltage (e.g., across input terminals of the power converter 115) of at least 200 V, at least 600 V, at least 800 V, at least 1000 V, at least 1200 V, between 200 V and 1200 V, between 600 V and 1200 V, between 800 V and 1200 V, or another range. Such high DC voltage levels may be desirable in some contexts, such as some electric vehicles. For example, some current electric vehicles (e.g., passenger vehicles and hybrid electric vehicles) operate with a DC bus voltage of between about 200 V and 400 V. This DC bus voltage for passenger electric vehicle may increase in the future. Further, some current electric vehicles (e.g., class 4-8, off-road, or otherwise larger electric vehicles) can operate with a DC bus voltage of more than 1000 V. However, high DC voltage levels may introduce challenges into a typical power converter system, such as an increase in leakage currents, increases in common mode voltage, higher rates of change in common mode voltage, and the like. These challenges can lead to resonance on the LC filter 120, shaft voltages, excessive bearing currents (e.g., from discharge events when lubricant dielectric breakdown occurs) that can result in bearing failures, excessive motor shaft currents, excessive motor winding currents (e.g., insulation may be damaged), and excessive gear train currents (e.g., bearing currents can propagate into the gear train via electromagnetic interference (EMI) or noise, vibration, harshness (NVH) resulting from the damaged bearing race walls). Embodiments described herein, however, can mitigate such challenges through improved LC filters and through control techniques including control techniques that use harmonic injection, cascaded controllers, MPC control, and/or variable frequency critical soft switching (VFCSS).

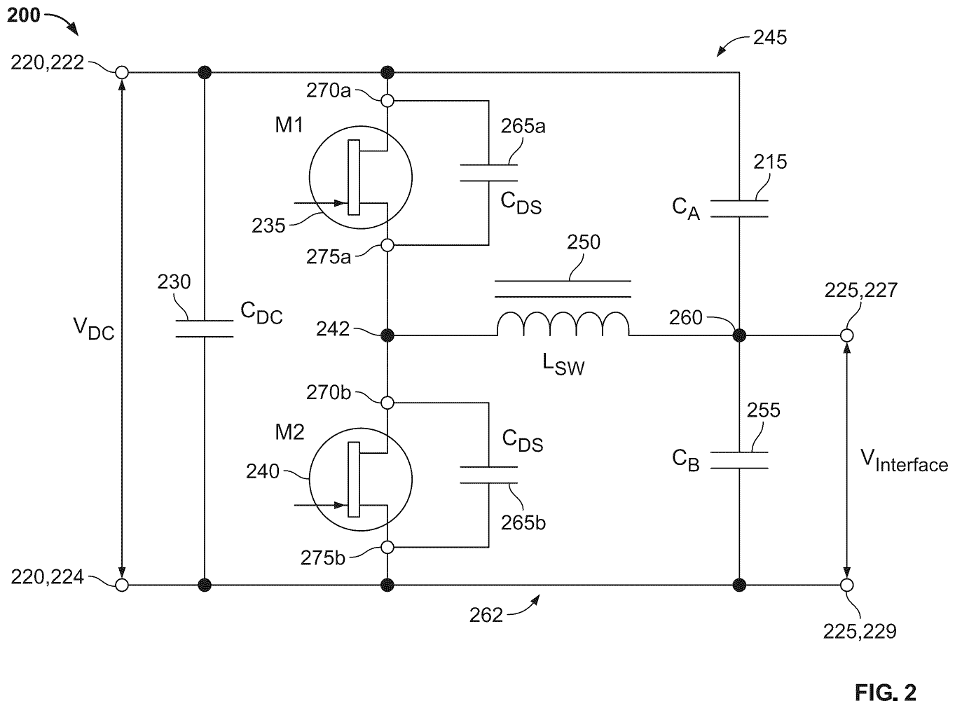

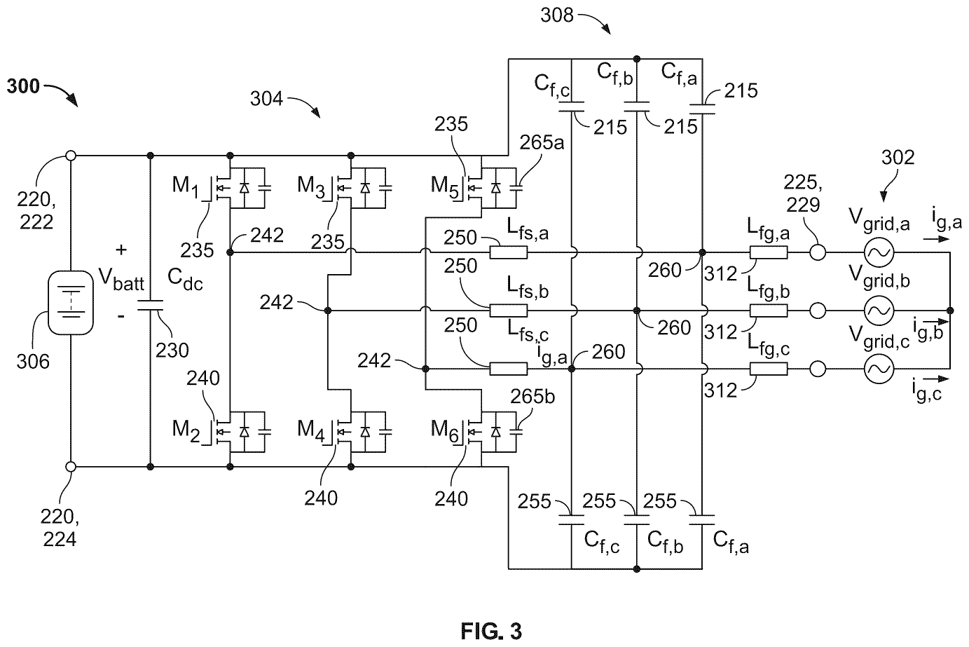

The LC filter 120 may include an LC filter for each phase of the power converter 115. Each LC filter may include at least an inductor and a capacitor, or at least an inductor and two capacitors, as described in further detail below (see, e.g., discussion of FIGS. 2 and 3).

The sensor(s) 140 include, for example, one or more current sensors and/or one or more a voltage sensors. For example, the sensor(s) 140 may include a respective current sensor and/or voltage sensor to monitor a current and/or voltage of one or more of the DC load source 110, each phase of the second source/load 130, each phase of the LC filter 120, or other nodes or components of the power converter 115. For example, when the LC filter 120 is a three-phase LC filter, the sensors 140 may include at least three current sensors, one for sensing current at each phase of a three phase LC filter 120. In some embodiments, additional or fewer sensors 140 are included in the system 100. For example, the sensors 140 may also include one or more vibration sensors, temperature sensors, and the like. In some examples, the control system 105 infers a characteristic (e.g., current or voltage) of the power converter 115, rather than directly sensing the characteristic. The sensor(s) 140 may provide sensor data to the control system 105 indicative of the sensed characteristics of the system 100. Such sensor data may, accordingly, indicate electrical operational characteristics of the system 100. In some examples, the control system 105 infers or estimates a characteristic (e.g., current or voltage) at one or more nodes of the power converter 115 based on the sensor data of a sensor 140 that senses a different type of characteristic or even a different component, rather than directly sensing the characteristic. Further description of such inferencing or estimating are provided below with respect to state estimation.

The input-output (I/O) interface 142 includes or is configured to receive input from one or more inputs (e.g., one or more buttons, switches, touch screen, keyboard, and the like), and/or includes or is configured to provide output to one or more outputs (e.g., LEDs, display screen, speakers, tactile generator, and the like). Other electronic devices and/or users may communicate with the system 100 and, in particular, the control system 105, via the I/O interface 142. For example, the control system 105 may receive commands (e.g., from a user or another device) for the power converter system 100 indicating a target torque, target speed, target power level, conversion type, or the like. The control system 105, in response, may drive the power converter 115 to achieve the target and/or conversion type indicated by the command.

The control system 105 generally monitors the system 100 including the power converter 115 (e.g., based on sensor data from the sensor(s) 140), receives commands (e.g., via the input/output interface 142), and controls the power switching elements of the power converter 115 with control signaling (e.g., pulse-width modulated (PWM) signals) to convert power (e.g., in accordance with the sensor data and/or the commands). In some embodiments, the control system 105 includes a controller (e.g., the central controller 150) that performs this monitoring and control without additional local controllers. In other embodiments, the control system 105 is a cascaded control system including a central controller 150 and one or more local controllers 160. The cascaded control system may communicate in real time (e.g., each control cycle) monitoring information (e.g., sensor data) and control information between the central controller 150 and the one or more local controller 160. In some examples, the local controller(s) 160 each implement model predictive control (MPC) or another regulation control scheme (e.g., PID control, PI control, or the like). In some examples, the central controller implements a non-MPC regulation technique, such as proportional integral derivative (PID) control or proportional integral (PI) control.

Each controller of the control system 105, including the central controller 150 and the local controllers 160, is an electronic controller that may include an electronic processor. Such an electronic controller may further include a memory (e.g., the memory 157 or 167). The memory is, for example, one or more of a read only memory (ROM), random access memory (RAM), or other non-transitory computer-readable media. The electronic processor 155, 165 is configured to, among other things, receive instructions and data from the memory 157, 167 and execute the instructions to, for example, carry out the functionality of the associated controller described herein, including the processes described herein. For example, the memory may include control software. In some embodiments, instead of or in addition to executing software from the memory to carry out the functionality of the controller described herein, the electronic processor includes one or more hardware circuit elements configured to perform some or all of this functionality. Additionally, although a particular controller, electronic processor, and memory may be referred to as a respective, single unit herein, in some embodiments, one or more of these components is a distributed component. For example, in some embodiments, an electronic processor includes one or more microprocessors and/or hardware circuit elements.

FIG. 2 illustrates an example of a half-bridge converter 200 that may serve as the power converter 115 of the system 100 of FIG. 1. As illustrated, the converter 200 includes DC terminals 220 (also referred to as DC nodes, DC links, DC rails, etc.) having a positive DC terminal 222 and a negative DC terminal 224. The converter 200 further includes interface terminals 225 (also referred to as interface nodes) having a positive interface terminal 227 and negative interface terminal 229. The converter 200 may be operated as a bidirectional converter or as a unidirectional converter (in either direction), depending on the configuration and control of the system in which it is implemented. Accordingly, the DC terminals 220 may be input terminals and the interface terminals 225 may be output terminals in some examples (e.g., DC/DC conversion and DC/AC inversion), and the DC terminals 220 may be output terminals and the interface terminals 225 may be input terminals in some examples (e.g., AC/DC rectification). Additionally, the interface terminals 225 may be AC input terminals (e.g., for AC/DC rectification), may be AC output terminals (e.g., for a DC/AC inverter), or may be DC output terminals (e.g., for DC/DC conversion).

The converter 200 further includes a DC link capacitor (CDC) 230, a, a high side (upper) power switching element (M1) 235 (also referred to as upper switch or upper FET 235), a low side (lower) power switching element (M2) 240 (also referred to as lower switch or lower FET 240), a midpoint node 242 connecting a drain terminal of upper switch 235 and a source terminal of lower switch 240, and an LC filter 245. The LC filter 245 is an example of the LC filter 120 of the system 100 of FIG. 1.

The power switching elements 235 and 240 may be field effect transistors (FETs), each having a respective gate, source, and drain terminal. The FETs may be, for example, a MOSFET, a silicon carbide (SIC) FET, a gallium nitride (GaN) FET, among other types of FETs.

The LC filter 245 includes a switch-side inductor L_{SW} 250, a lower capacitor C_{B} 255, and an upper capacitor C_{A} 215. The switch-side inductor L_{SW} 250 is coupled between the midpoint node 242 and a filter node 260. For example, a first end of the switch-side inductor L_{SW} 250 is coupled to the midpoint node 242, and a second end is coupled to the filter node 260. The lower capacitor C_{B} 255 is coupled between the filter node 206 and the negative DC terminal 224. For example, a first end of the lower capacitor C_{B} 255 is coupled to the filter node 260, and a second end is coupled to the negative DC terminal 224. The upper capacitor C_{A} 215 is coupled between the filter node 260 and the positive DC terminal 222. For example, a first end of the lower capacitor C_{A} 215 is coupled to the filter node 260, and a second end is coupled to the positive DC terminal 222.

In some examples, the LC filter 245 is an LCL filter (an LC filter with an additional inductor (L)), in which an additional (interface) inductor is coupled between the filter node 260 and the positive interface terminal 227.

The upper capacitor 215 allows for the ripple currents at both input nodes and output nodes (nodes 222, 227) of the converter 200 to be shared. Because the ripple currents on the input nodes and the ripple currents on the output nodes have some correlation, differential mode currents of these input and output nodes can be canceled through this capacitance. This reduction in differential mode current can result in improved EMI performance and decreased total capacitor ripple current when compared with a typical half-bridge converter (e.g., when the total capacitance between the two converters is held constant). Furthermore, the reduction in total capacitor ripple current can allow for a decrease in capacitor size, for example, when capacitor ripple current drives capacitor sizing.

The converter further includes drain-source capacitors Cps 265a and 265b, each respectively coupled across one of the switches 235, 240. In particular, a first drain-source capacitor 265a is provided across a source terminal 270a and drain terminal 275a of the upper switch (M1) 235, and a second drain-source capacitor 265b is provided across a source terminal 270b and drain terminal 275b of the lower switch (M2) 240. The drain-source capacitors (C_{DS}) 265a-b may be generically and collectively referred to herein as drain-source capacitor(s) (C_{DS}) 265.

The drain-source capacitors (C_{DS}) 265 can slow a voltage rise during an ON-to-OFF transition of the switches 235 and 240. This slowed voltage rise can, in turn, reduce the switching losses of the switches 235 and 240.

In some examples of the converter 200, one or both of the upper capacitor C_{A} 215 and the drain-source capacitors Cps are not included in the converter 200.

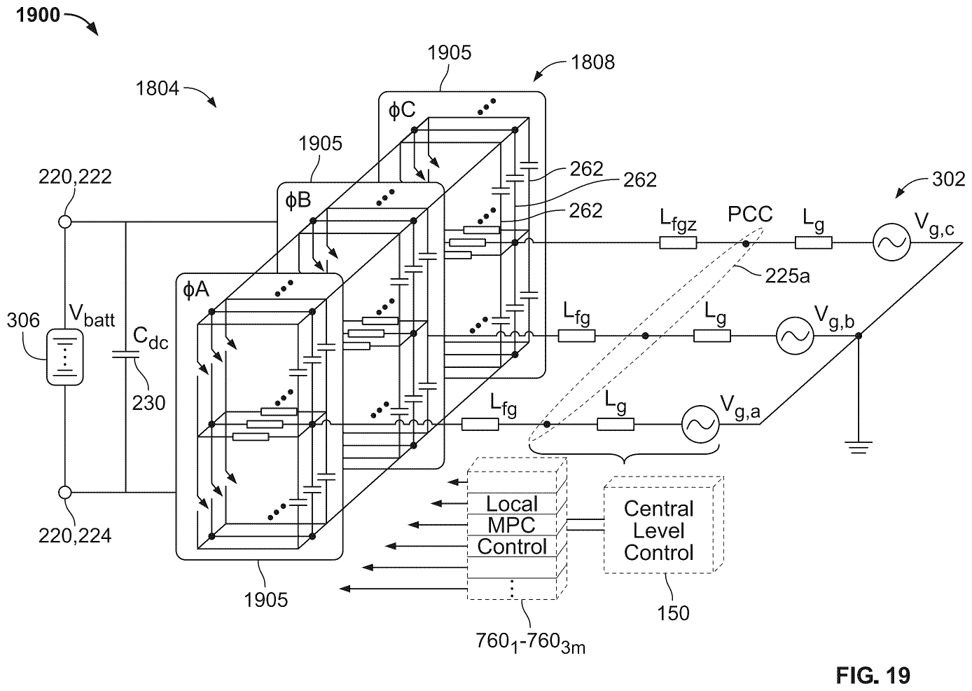

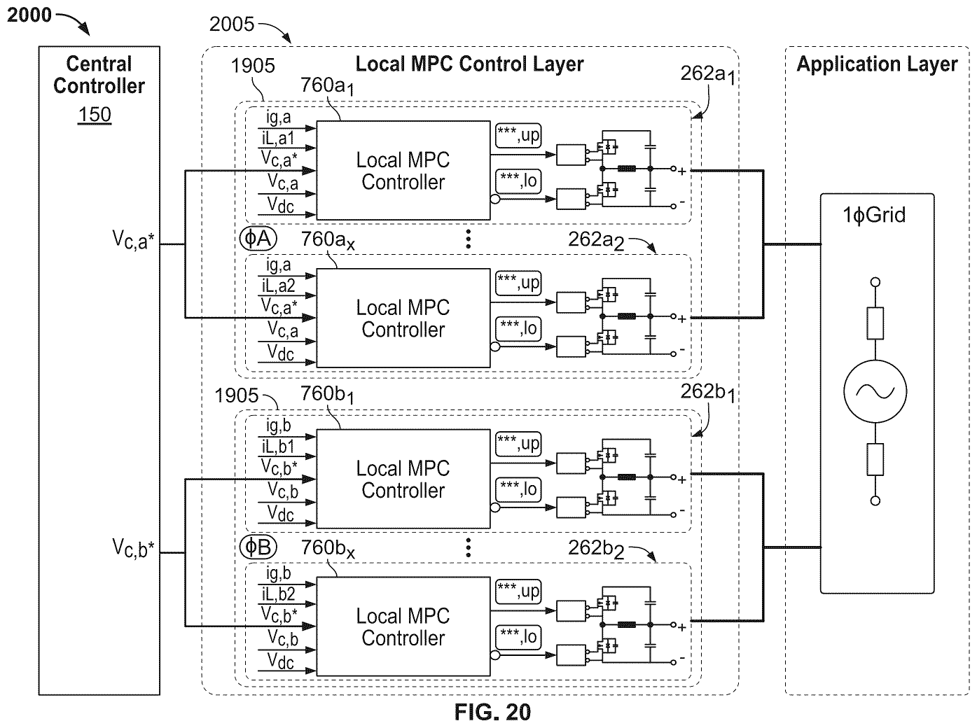

As noted, in some examples, the power converter 200 may serve as the power converter 115 of the system 100 in FIG. 1. In the context of the power converter 115 (and, thus, the power converter 200) implementing an AC/DC rectifier or a DC/AC inverter, the power converter 200 is a single-phase power converter 200. In some examples, multiple instances of the power converter 200 are paralleled to collectively serve as the power converter 115 of FIG. 1 and provide the single-phase conversion (whether rectification or inversion) or to provide a DC/DC power conversion. In some examples, the power converter 115 is a multiphase power converter (e.g., operating with three or more phases of AC power). In such examples, the power converter 115 may include multiple instances of the power converter 200, each instance associated with a phase of the AC power, each instance having shared DC terminals 220, and each instance having independent V_{interface} nodes 225. Examples of such a power converter are provided in FIGS. 3, 4, 7, and 12. In some of these examples, as shown in FIGS. 19-20, multiple instances of the power converter 200 are paralleled to collectively provide the power conversion for a respective phase (e.g., two parallel power converters 200 for phase A, two parallel power converters 200 for phase B, and two parallel power converters 200 for phase C). In some examples, the particular number of parallel power converter 200 and the number of phases varies.

As used herein, a converter block may refer to a half bridge circuit such as described with respect to the converter 200 of FIG. 2. For example, a converter block 262 may include the power switching elements 235 and 240, the LC filter 245 (including upper capacitor 215, if present, and additional interface inductor, if present), the interconnecting nodes thereof (e.g., midpoint node 242, filter node 260, DC terminals 220, and interface terminals 225), and (if present) drain-source capacitors 265.

FIG. 3 illustrates a multiphase power converter system 300 coupled to an AC grid 302. The multiphase converter system 300 includes a multiphase converter 304 coupled to a battery 306 on a DC side and coupled to the AC grid 302 via LCL filters 308. The multiphase converter 304 may serve as the power converter 115 of the system 100 in FIG. 1, and the LCL filters 308 may serve as the LC filter 120 of the system 100 of FIG. 1. In operation, the multiphase converter 300 may function as a DC/AC inverter or an AC/DC rectifier, depending on the sources and switching of the power switching elements.

The multiphase converter 304 includes three instances of the power converter 200 (or converter block 262) of FIG. 2, one for each phase of the AC grid 302. Each instance includes an upper and a lower switch 235 and 240, with drain-source capacitors coupled across each of these switches. The multiphase converter 300 is further coupled, via the DC terminals 220, to the battery 306, and via the interface terminals 225 to the AC grid 302. The multiphase converter 300 includes three LCL filters 308. Each LCL filter 308 includes components similar to the LC filter 245 of FIG. 2, with the addition of an interface inductor (L_{fg}) 312 coupled between the filter node 260 and the interface terminals 225. That is, each LCL filter 308 includes a switch-side inductor 250 (also labeled L_{fs,a}, L_{fs,b}, or L_{fs,c}), a lower capacitor 255 (also labeled C_{f,a}, c_{f,b}, and C_{f,c}), an upper capacitor 215 (also labeled C_{f,a}, C_{f,b}, or C_{f,c}). The switch-side inductor 250 is coupled between the midpoint node 242 and the filter node 260.

In the illustrated example, the multiphase converter 300 is coupled to the battery 306 and the AC grid 302. In other examples, the multiphase converter 300 is coupled to a DC source/load other than the battery 306 (e.g., a capacitor, ultracapacitor, DC power supply from rectified AC power, etc.) and/or to an AC source/load other than the grid 305 (e.g., a three-phase motor, an engine generator, etc.). Additionally, although the multiphase converter 300 includes the drain-source capacitors for each switch, an upper capacitor 215 for each phase, and an interface inductor for each phase, in some examples, one or more of these components are not included.

As illustrated in FIG. 2 and FIG. 3, in some examples of the power converter systems provided herein, the LC filter 120 (implemented as LC filter 245 in FIGS. 2 and 308 in FIG. 3) includes an LC filter for each phase, where a common point of each capacitor is connected to the DC bus negative terminal (and/or positive terminal). This connection creates a bypassing path for zero-sequence voltage control. By leveraging the topological modification and zero voltage control, the common mode voltage can be stabilized to reduce leakage current.

The systems 100 and 400 are each an example of a power converter system that may incorporate various features provided herein, alone and in combination. In the following sections, this disclosure discuses (I) three phase converter modeling, (II) harmonic injection, (III) cascaded control systems, (IV) model predictive control, (V) state estimation, (VI) variable frequency critical soft switching, and (VI) modular converter blocks. These headings are included for convenience and should not be construed in a limiting manner.

### I. Three Phase Converter Modeling

In some examples provided herein, a control scheme for controlling the power converter is based on the dq0 coordinate system. As provided herein, by using the dq0 coordinate system, the control schemes may leverage the zero-sequence voltage component to control the common mode voltage. Compared with the abc system, the active/reactive power and common mode voltage can be controlled independently with d, q, and 0 sequence components in the dq0 system. A coordinate system model of a three-phase converter (e.g., as shown in FIG. 3) can be derived from the abc reference frame.

The state space equations in abc system are expressed as:

$$\begin{matrix}{i}_{L , abc} = \frac{1}{{L}_{fs}} {Iu}_{x , abc} - \frac{1}{{L}_{fs}} {Iu}_{xc , abc} \\ {\dot{u}}_{c , abc} = \frac{1}{{C}_{f}} {Ii}_{L , abc} - \frac{1}{{C}_{f}} {Ii}_{g , abc} \\ {i}_{g , abc} = \frac{1}{{L}_{fg}} {Iu}_{c , abc} - \frac{1}{{L}_{fg}} {Iu}_{g , abc}\end{matrix} ,$$

where, with reference to FIG. 3, L_{fs}, C_{f} and L_{fg} are the switch side inductor 250, capacitor 255, and grid side inductor 312, respectively, for the LCL filter. i_{L,abc}, u_{c,abc}, i_{g,abc} and u_{x,abc} are the switch side inductor current, capacitor voltage, grid side current and grid voltage, respectively. I∈ [symbol] ^{3≥3} is the identity matrix.

Because it can be difficult to control time-varying sinusoidal references in the abc system, and convenient to calculate the active/reactive power and stabilize zero-sequence voltage in the dq0 system, the state space model is transformed to the dq0 reference frame for control purposes. For example, the dq0 coordinate system transformation is helpful because the dq0 system can transfer the time-varying sinusoidal waveforms to equivalent constant DC values. For the implementation of control, the DC values may be easier to control than AC values. However, traditional methods mainly utilize the dq system without considering the 0 (zero-sequence) component. The topology of the converter system 300, where the common point of AC three-phase capacitors are connected to the DC bus positive and/or negative terminals, permits extraction of the zero-sequence from the abc system to the dq0 system, and control of the zero-sequence voltage to be half of the DC bus voltage. Thus, the common mode voltage v_{cm} is a zero-sequence component and can be stabilized as constant accordingly.

For the reference frame transformation with zero-sequence components, abc system may first be transformed to αβ0, and then to dq0 system. From abc to aß0, the Clarke transform is applied as:

$${x}_{αβ0} = T {x}_{a b c} = \frac{2}{3} [ \begin{matrix}1 & - 1 / 2 & - 1 / 2 \\ 0 & \sqrt{3} / 2 & - \sqrt{3} / 2 \\ 1 / 2 & 1 / 2 & 1 / 2\end{matrix} ] {x}_{a b c} .$$

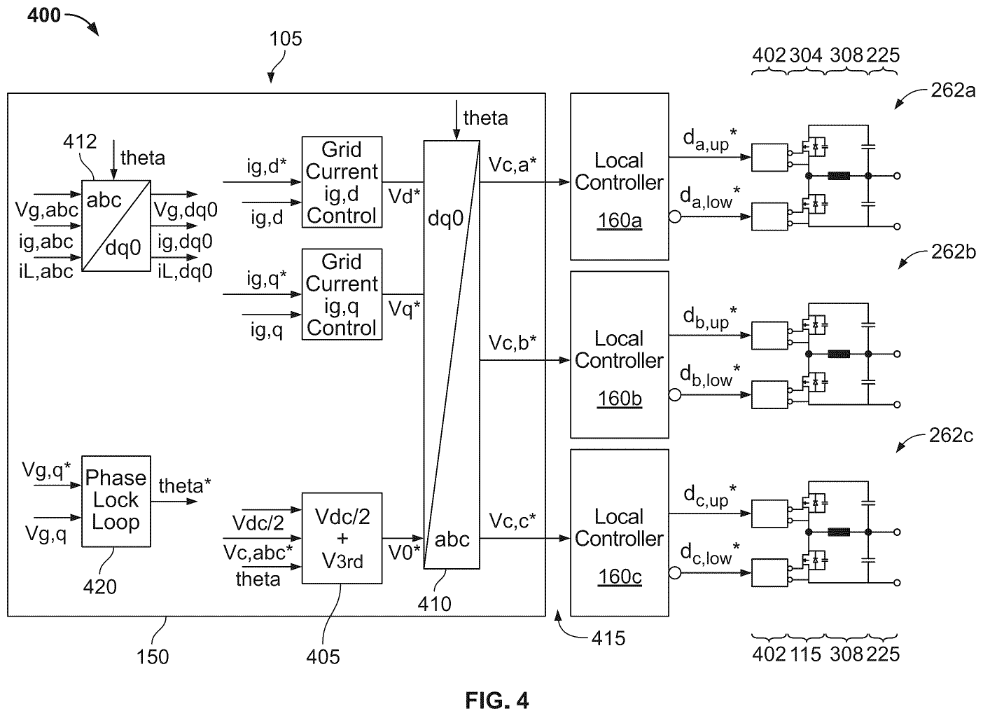

In the αβ0 system, the signls are composed of two orthogonal sinusoidal AC waveforms in α and β frames and a zero-sequence component. A Park transform is implemented secondly to convert the stationary reference frame of αβ0 to the rotating dq0 system, which is calculated as:

$${x}_{d q 0} = P ( θ ) {x}_{αβ0} = [ \begin{matrix}cos θ & sin θ & 0 \\ - sin θ & cos θ & 0 \\ 0 & 0 & 1\end{matrix} ] {x}_{αβ0} .$$

where θ is the phase angle of the grid (or other AC source/load coupled to the converter). In some examples, the phase angle θ is tracked with a phase-locked-loop (PLL) controller (see, e.g., PLL 420 in FIG. 4) by measuring the grid voltage at a point of common coupling (PCC), as described in further detail below. Thus, the AC sinusoidal signals in abc are converted to DC values in the dq0 (rotating) reference frame with a time-varying angle of θ. The control reference signals to implement the duty cycles for driving the power switching elements of the converters may be in the abc (stationary) reference frame format for the PWM modulation. Accordingly, the inverse Clarke and Park transformations may be applied to convert the output of the control signals from dq0 to abc:

$${x}_{a b c} = {T}^{- 1} {x}_{αβ0} = {T}^{- 1} {P ( θ )}^{- 1} {x}_{d q 0} .$$

Based on the above Park and Clarke equations of the coordinate system transformations, the state space equations above can be transformed from abc to dq0:

$$\begin{matrix}{i}_{L , dq 0} = \frac{1}{{L}_{fs}} {Iu}_{x , dq 0} - \frac{1}{{L}_{fs}} {Iu}_{c , dq 0} - ω {Gi}_{L , dq 0} \\ {\dot{u}}_{c , dq 0} = \frac{1}{{C}_{f}} {Ii}_{L , dq 0} - \frac{1}{{C}_{f}} {Ii}_{g , dq 0} - ω {Gu}_{c , dq 0} \\ {i}_{g , dq 0} = \frac{1}{{L}_{fg}} {Iu}_{c , dq 0} - \frac{1}{{L}_{fg}} {Iu}_{g , dq 0} - ω {Gi}_{g , dq 0}\end{matrix}$$

where ω is the angular velocity of the grid in rad/s. G is the matrix for the coupling terms resulted from the transformation:

$$G = [ \begin{matrix}0 & - 1 & 0 \\ 1 & 0 & 0 \\ 0 & 0 & 0\end{matrix} ] .$$

By leveraging the dq0 state space equations and the connection of three-phase capacitors common point with DC bus positive/negative terminals, the zero-sequence voltage can be controlled explicitly to stabilize the u_{cm}.

In some examples, another rotating reference frame other than the dq0 reference frame is used by the control system 105.

### II. Harmonic Injection for Zero Sequence Voltage Control

In some power converter applications, such as a grid-connected power converter for an electric vehicle (EV) charger for photovoltaic (PV) array, leakage current and DC bus utilization are two factors that influence converter performance. To address leakage current, a bulky line frequency transformer is typically installed to block the leakage path at the point of common coupling (PCC) which increases the cost, volume and weight of the system. To improve DC bus utilization, the DC bus voltage may be stepped up (e.g., to be at least twice of the grid voltage amplitude to avoid a saturation issue), which brings extra switching losses and challenges to the switch voltage tolerance capability.

To address these and other issues, in some examples, a harmonic signal is injected into the power converter systems provided herein, which may also be non-isolated (transformerless) converters. Conventional harmonic injection involves direct injection in a duty cycle used to modulate switching elements, which reduces control stability and robustness, divergence can occur in the PWM modulation, and extra harmonics are injected into the grid, which deteriorates the power quality of the grid voltage and current. In contrast, in some examples provided herein, systems and methods provide harmonic injection for zero sequence voltage control. The disclosed systems and methods improve DC bus utilization without reduced control stability and robustness, and without injecting additional harmonics into a grid (or other AC source or load).

In some embodiments, a power converter system (e.g., the system 100) has a non-isolated N-phase power converter and a control system that injects a multiple of an N-th phase harmonic for zero sequence voltage control. For example, in the case of a three-phase power converter (i.e., N=3), the injected harmonic may be a third harmonic injection (THI), a sixth harmonic injection, etc. Additionally, rather than injecting a harmonic directly to a duty cycle for modulation, in some examples, the system injects the harmonic (e.g., a sinusoidal or triangular wave voltage signal) into a zero-sequence voltage control signal of a set of direct quadrature zero-sequence (dq0) rotational reference frame control signals. The control signals may also be referred to as rotational reference frame reference targets. This approach provides additional regulation via constraints on the dq0 rotational reference frame control signals that would not otherwise be applied if the harmonic was injected directly to a duty cycle for modulation. Thus, the stability and robustness of the system may be improved relative to direct duty cycle side injection techniques.

For example, with reference to FIG. 4, a power converter system 400 is illustrated, which may be an example of the power converter system 100 of FIG. 1. As illustrated, the power converter system 400 is a non-isolated, three-phase power converter that includes a control system 105 including the central controller 150 and three local controllers 160a-c (each an instance of the local controller 160 of FIG. 1). The local controllers 160a-c may each be associated with and control a respective converter block 262a-c corresponding thereto. The converter blocks 262a-c may be instances of the converter block 262 described with respect to FIG. 2. The local controllers 160a-c may implement a particular control scheme to perform the control of the associated converter block 262a-c. For example, the local controller 160a-c may implement model predictive control (MPC), as described further below, a proportional-integral (PI) control, a proportional-integral-derivative (PID) control, or another type of control or regulation. In some embodiments, rather than a cascaded control system as illustrated, the control system 105 does not include the local controllers 160a-c. For example, instead, the reference voltages generated by the central controller 150 are mapped directly to respective duty cycle values (e.g., by a lookup table) that are provided to respective gate drivers 402 for each power switching element of the converter.

As illustrated, the central controller 150 receives electrical characteristics of the power converter 304 (e.g., i_{L,abc}; i_{g,abc}, v_{g,abc}) in the stationary (abc) reference frame, receives reference electrical characteristics (e.g., i_{g,d}*; i_{g,q}*, v_{g,q}*), and determines a fundamental frequency (theta or θ) of the AC load/source (e.g., AC grid) coupled to the terminals 225. Based on these received and determined values, the central controller 150 generates control reference signals in the dq0 reference frame. The central controller 150 then translates the control reference signals to the stationary (abc) reference frame via a dq0/abc reference frame translator 410 and provides these control reference targets or 415 (e.g., vₐ*,v_{b}*, and v_{c}*) to the local controllers 160a-c.

More particularly, the central controller 150 translates the received electrical characteristics of the power converter 304 from the stationary reference frame to the dq0 reference frame (e.g., via abc/dq0 translator 412). The central controller 150 further compares the translated electrical characteristics to the reference electrical characteristics in the dq0 reference frame (e.g., i_{g,d}* to i_{g,d}, and i_{g,q}* to i_{g,q}) to generate d and q components of a voltage control reference signal (e.g., v_{d}* and v_{q}*). For example, a regulator 413 (e.g., PI or PID controller) may perform the comparison of the d component of the reference and translated grid current values (i_{g,d}* and i_{g,d}) to generate a resulting d component of the voltage control reference signal (v_{d}*). Similarly, a regulator 414 (e.g., PI or PID controller) may perform the comparison of the q component of the reference and translated grid current values (i_{g,q}* and i_{g,q}) to generate a resulting q component of the voltage control reference signal (v_{q}*). These d and q components of the voltage control reference signal are provided to the dq0/abc translator 410. The d and q components of the reference electrical characteristics (e.g., i_{g,d}* and i_{g,q}*) may be provided to the central controller 150 by the I/O interface 142 (see FIG. 1) based on a received user input command, from a memory (e.g., the memory 157), or another source.

For the zero-sequence (0) reference component, the power converter system 400, uses a harmonic injector 405 (e.g., provided as part of the central controller 150). That is, the harmonic injector 405 generates the harmonic injection and provides the zero-sequence component target to the dq0/abc reference frame translator 410.

As illustrated in FIG. 4, the harmonic injector 405 receives a DC offset (e.g., V_{dc}/2), the fundamental frequency of an AC section of the power converter 115 (theta or θ), and the control reference targets 415 for each phase of the power converter 115. In this example, the control reference targets 415 (also referred to as power reference targets) are voltage references V_{c,a}+, V_{c,b}+, and V_{c,c}+output by the translator 410 that refer to a target voltage for the lower capacitor of the control block 262a-c (e.g., with reference to FIGS. 2 and 3, capacitor 255). The harmonic injector 405 may calculate the zero-sequence component target based on these characteristics. In some embodiments, the harmonic injector 405 calculates the zero-sequence reference component by summing two components (i) the DC offset and (ii) a multiple of N-th phase harmonic injection.

The first component, the DC offset, may be set to be half of the DC bus voltage (V_{dc}/2). This DC offset component of the zero-sequence reference ultimately blocks leakage current from flowing to the grid. That is, the zero-sequence output current can be attenuated by the stabilization control of zero-sequence capacitor voltage, which is provided by this DC offset being used as an input for the zero-sequence voltage reference. The working principle of zero sequence voltage control is based on the three-phase output capacitor voltage reference tracking. Specifically, in the central controller, the zero-sequence component of the reference is designed as half of DC bus voltage measurement, V_{dc}/2. This reference is combined with dq components references from the output of grid side inductor current controllers and then transformed into abc reference frame as control reference targets 415 for the local controllers 160a-c. Each of the control reference targets 415 may thus be composed of a sinusoidal AC component (based on the dq inputs to the translator 410) and a zero sequence DC component (based on the zero-sequence (0) input to the translator 410). Thus, based on the control reference targets 415 having zero-sequence control integrated therein, the local controllers 160a-c regulate zero sequence voltage control, providing a stabilized common mode capacitor voltage and low leakage current. In some examples of the converter 300, because this DC offset as a zero-sequence voltage reference provides advantages on its own, the DC offset is provided to the translator 410 as the zero-sequence voltage reference without the addition of harmonic injection (e.g., the output of injector 405 may be the DC offset (V_{dc}/2)).

In other examples, injection of a N-th phase harmonic along with this DC offset can further improve DC bus utilization. By injecting the N-th harmonic into the zero-sequence voltage reference (i.e., summing with the DC offset), these two components form the zero-sequence portion of the control reference targets 415 for the local controllers 160a-c. Thus, the local controllers 160a-c of each phase will regulate the capacitor voltage (v_{c,abc}) with the same zero-sequence DC offset and third order harmonic to stabilize the common mode voltage and reduce the peak-to-peak voltage value.

The harmonic injector 405 may calculate the multiple of N-th phase harmonic injection based on the fundamental frequency and the control reference targets 415. Thus, in some embodiments, the multiple of N-th phase harmonic injection may be considered a feedback signal that is calculated from N previous control reference targets generated by the control system in the stationary (abc) reference frame based on previously received rotational reference frame targets. In some embodiments, the multiple of N-th phase harmonic injection is a sinusoidal signal. The harmonic injector 405 may derive the sinusoidal signal based on an N-th order of a fundamental frequency of the AC voltage section of the power converter. In other embodiments, the N-th phase harmonic injection is a triangular signal. The harmonic injector 405 may derive the triangular signal based on mean values of maximum and minimum values of the fundamental frequency (θ) of the AC voltage section of the power converter. Example equations that the harmonic injector 405 may use to calculate the sinusoidal or triangular signals are provided below.

The sinusoidal injection for a third harmonic injection (Sin-RTHI), may be implemented by deriving the third order of grid fundamental frequency (θ) component to be superimposed to the zero-sequence voltage reference. The Sin-RTHI zero-sequence voltage reference can be expressed as:

$${v}_{0 , 3 rd}^{*} = {v}_{d c} / 2 + {V}_{m} {D}_{3 r d} sin ( 3 ω t ) .$$

Thus, the abc frame Sin-RTHI three-phase capacitor voltage references, v*_{c,abc}, distributed to the local controllers 160a-c can be expressed as

$$\begin{matrix}{v}_{c , a}^{*} = {v}_{c , a}^{*} + {V}_{m} {D}_{3 r d} sin ( 3 ω t ) \\ {v}_{c , b}^{*} = {v}_{c , b}^{*} + {V}_{m} {D}_{3 r d} sin ( 3 ( ω t - \frac{2 π}{3} ) ) \\ {v}_{c , c}^{*} = {v}_{c , c}^{*} + {V}_{m} {D}_{3 r d} sin ( 3 ( ω t + \frac{2 π}{3} ) )\end{matrix} .$$

where Vₘ and D_{3rd} are the amplitude of fundamental component and third harmonic injection depth, respectively. The angular speed, w, and phase shift can be derived based on fundamental frequency theta (θ). A phase-locked loop (PLL) controller 420 of the central controller 150 may provide theta (θ) to provide real-time phase angle information of the AC voltage (e.g., grid or AC motor voltage). For example, a PI controller may be used to control the q component of the grid voltage, v_{g,q}, to be zero to derive the angular velocity, ω, of the phase angle. Then, theta (θ) can be calculated with a period of 2π, and based on the active/reactive power calculation in

$$[ \begin{matrix}P \\ Q\end{matrix} ] = \frac{3}{2} [ \begin{matrix}{u}_{g , d} & {u}_{g , q} \\ {u}_{g , q} & - {u}_{g , d}\end{matrix} ] [ \begin{matrix}{i}_{g , d} \\ {i}_{g , q}\end{matrix} ]$$

where the d-axis and q-axis represent the active and reactive power, respectively. Specifically, theta (θ) can be derived by accumulating the product of control time period, Ts, and angular velocity, ω, in each control period and by performing a modulus operator function to ensure the theta (θ) is within [0,2pi]. Theta (θ) is also used in other calcaluations of the converter system, such as the translations by the translator 410 and the translator 412,

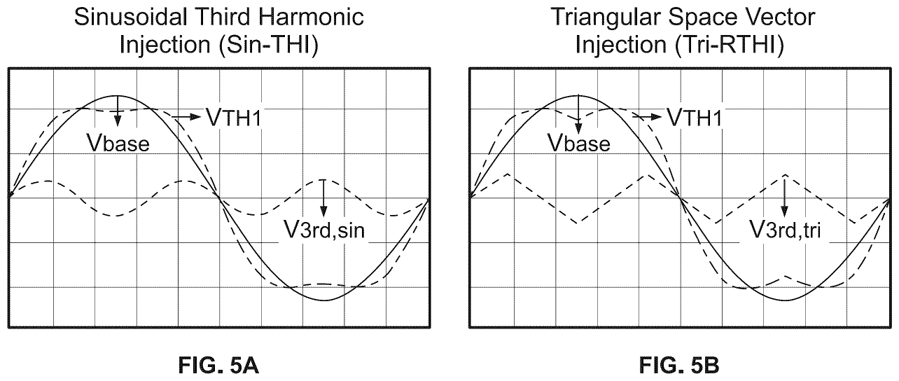

By leveraging the harmonic injection to the zero-sequence voltage, the peak-to-peak capacitor voltage can be reduced to improve the DC bus utilization and avoid the duty cycle saturation in lower DC bus voltage. FIG. 5A shows, for Sin-RTHI, the simulation waveforms of third order, fundamental frequency, and injected capacitor voltages in one grid period.

The triangular space vector for a third harmonic injection (Tri-RTHI) may be implemented by deriving the mean value of maximum and minimum grid fundamental frequency component capacitor voltage to be superimposed to the zero-sequence voltage reference. The Tri-RTHI zero-sequence voltage reference can be expressed as:

$${v}_{0 , 3 rd}^{*} = {v}_{d c} / 2 - {D}_{3 r d} [ max ( {v}_{c , abc}^{*} ) + min ( {v}_{c , abc}^{*} ) ] .$$

Thus, the abc frame Tri-RTHI three-phase capacitor voltage references, v*_{c,abc}, distributed to the local controllers 160a-c can be expressed as

$$\begin{matrix}{v}_{c , a}^{*} = {v}_{c , a}^{*} - {D}_{3 r d} [ max ( {v}_{c , abc}^{*} ) + min ( {v}_{c , a b c}^{*} ) ] \\ {v}_{c , b}^{*} = {v}_{c , b}^{*} - {D}_{3 r d} [ max ( {v}_{c , abc}^{*} ) + min ( {v}_{c , a b c}^{*} ) ] \\ {v}_{c , c}^{*} = {v}_{c , c}^{*} - {D}_{3 r d} [ max ( {v}_{c , abc}^{*} ) + min ( {v}_{c , abc}^{*} ) ]\end{matrix} .$$

FIG. 5B shows, for Tri-RTHI, the simulation waveforms of third order, fundamental frequency and injected capacitor voltages in one grid period.

As is shown in FIGS. 5A-B, the DC bus utilization can also be improved to avoid the duty cycle saturation issue. To evaluate the effectiveness of the injected third harmonic in FIGS. 5A-B, a voltage gain can be defined as the ratio of the fundamental component capacitor voltage peak value, v_{base}, to the reference modulation waveform peak value, v_{THI}

$${G}_{v} = \frac{{v}_{b a s e}}{{v}_{THI}} .$$

The maximum voltage gain of the continuous third harmonic injection methods can be derived at the π/3 when the third harmonic is at zero crossing point. Thus,

$${G}_{v , max} = \frac{1}{sin ( π / 3 )} \approx 1.155 .$$

By leveraging the disclosed harmonic injection techniques, the DC bus voltage can be reduced (e.g., by a factor of 1.15) and the voltage stress and switching losses on the power switching elements can be decreased, accordingly.

In some embodiments, instead of using the control reference targets 415 for each phase of the power converter 115 (here, V_{c,a*}, V_{c,b*}, and V_{c,c*}) to calculate the multiple of N-th phase harmonic injection, the harmonic injector 405 may derive the N-th phase harmonic injection from direct or indirect voltage measurements of each phase of the power converter 115. For example, for direct voltage measurements, the harmonic injector 405 may receive an output from a respective voltage sensor for each of the N phases of the power converter 115, or from an analog-to-digital converter (ADC) that converts the respective analog outputs of the voltage sensors to digital signals indicative of the voltage measurements. As another example, for indirect voltage measurements, the harmonic injector 405 may receive one or more communications from the local controller(s) 160 that indicates voltage measurements for each of the N phases of the power converter 115. Here, the local controller(s) 160 may directly measure the voltages and communicate the measured values as the voltage measurements to the harmonic injector 405. In both the direct and indirect examples, the voltage measurements may each be a voltage measured across a capacitor (e.g., lower capacitor C_{B} or C_{f} 255) of an LC filter of each phase of the power converter 115 (e.g., V_{c,a}, V_{c,b}, and V_{c,c}).

In these embodiments that use direct or indirect voltage measurements, the multiple of N-th phase harmonic injection may be considered a feedback signal that is calculated from at least N voltage measurements including at least one voltage measurement per phase of the power converter 115. In some of these embodiments, the multiple of N-th phase harmonic injection is a sinusoidal signal or a triangular signal. The above-noted example equations that the harmonic injector 405 may use to calculate the sinusoidal or triangular signals, may similarly be used to calculate the sinusoidal or triangular signals in these embodiments, with the voltage measurement signals replacing the control reference targets in the equations, respectively.

Additionally, in some embodiments of the power converter system 100, N is 3 and the multiple of N-th phase harmonic injection is a third order of a fundamental frequency of the AC voltage section of the power converter. However, as previously noted, in some embodiments, N may be another integer value, and/or another multiple of the N-th phase harmonic may be selected as well.

Although described with respect to the system 400 of FIG. 4, the harmonic injection feature may be incorporated into the other power converter systems disclosed herein, at least in some examples.

### III. Cascaded Control System

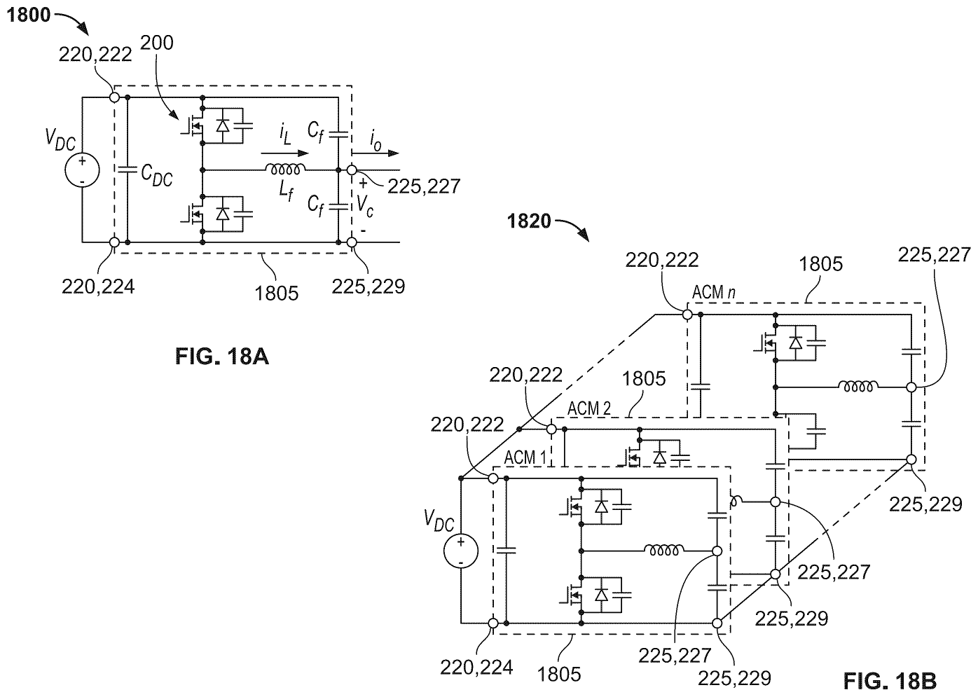

In some embodiments, a power converter system has a non-isolated N-phase power converter and a cascaded control system. A cascaded control system includes a central controller and at least one local controller. For example, with reference to the systems 100 and 400 of FIGS. 1 and 4 above, the control system 105 may be a cascaded control system including the central controller 150 cascaded with one or more local controllers 160. When the control system 105 is referred to as the cascaded control system 105 herein, the control system 105 should be understood to include at least one of the optional local controllers 160 in addition to the central controller 150. The cascaded control system 105 may provide, for example, resonance damping, improved dynamic performance, and/or leakage current attenuation capabilities. Additionally, the cascaded control system 105 can improve the modularity of the components (e.g., easing the addition and removal of local controllers and corresponding converter blocks as modular autoconverter modules), as described in further detail below with respect to FIGS. 18A-20.

In some embodiments of the cascaded control system 105, the central controller 150 provides an outer loop of control, while each of the local controllers 160 provides a distinct inner loop of control. For example, the central controller 150 may implement a PI controller, PID controller, or other regulating controller, that regulates the control for the power converter 115 in a rotating reference frame (e.g., the dq0 reference frame). As part of the outer loop of control, the central controller 150 generates control reference targets (e.g., targets 415) based on the regulation in the rotating reference frame. The control reference targets may be generated in the stationary (abc) reference frame. Additionally, the central controller 150 may provide the control reference targets to the local controllers 160. The local controllers 160 may be configured to control one or more of the N phases of the power converter 115, where the control of the N phases of the power converter 115 is divided up among the local controllers 160. Thus, each phase of the power converter 115 may be associated with and controlled by a particular local controller 160.

Each respective local controller 160 implements the inner loop control via model predictive control (MPC), PI control, PID control, or another regulating technique, based on the control reference targets (e.g., targets 415) received from the central controller 150. For example, each local controller 160 may also receive a voltage measurement or estimate for the voltage across the lower capacitor 255 (v_{c}) associated with the same phase or converter block 262 as the local controller. Based on the measured or estimated capacitor voltage (v_{c}) and the control reference target (e.g., v_{c}*), each local controller 160 may control its associated converter block 262 to adjust or control the switching of the power switching elements to achieve (or tend towards) a capacitor voltage (v_{c}) that is equal to the reference control target. The inner loop control provided by the respective local controllers 160 includes the generation of control signaling provided to the power switching elements of the power converter 115 (or, in FIG. 3, converter 304). For example, with reference to FIGS. 3 and 4, the local controller 160a provides control signaling to the power switching elements 235, 240 (M1, M2) of a first phase of the power converter 115, the local controller 160b provides control signaling to the power switching elements 235, 240 (M3, M4) of a second phase of the power converter 115, and the local controller 160c provides control signaling to the power switching elements 235, 240 (M5, M6) of a third phase of the power converter 115.

The central controller 150 and the local controllers 160 may communicate with each other in real time (e.g., each control cycle) both monitoring information (e.g., sensor data) and control information. For example, each local controller 160 may determine and transmit, in real time to the central controller 150, electrical operational characteristics particular to the phase or phases of the power converter 115 with which the local controller 160 is associated. For example, with reference to FIG. 4, these electrical operational characteristics may include one or more of V_{g,abc}, i_{g,abc}, and i_{L,abc} (e.g., V_{g,a}, i_{g,a}, and i_{L,a} from local controller 160a; V_{g,b}, i_{g,b}, and i_{L,b} from local controller 160b; and V_{g,c}, i_{g,c}, and i_{L,c} from local controller 160c). In some embodiments, the local controllers 160 provide other electrical operational characteristics. Additionally, the central controller 150 may determine and transmit, in real time to the respective local controllers 160, the control reference targets (e.g., 415). Although the control reference targets 415 are illustrated as voltage reference targets, in some examples, the control reference targets 415 are current reference targets (e.g., i_{L,abc}* or i_{g,abc}*). In such examples, the local controllers 160 may control the power switching elements of their respective phases in accordance with the current reference targets.

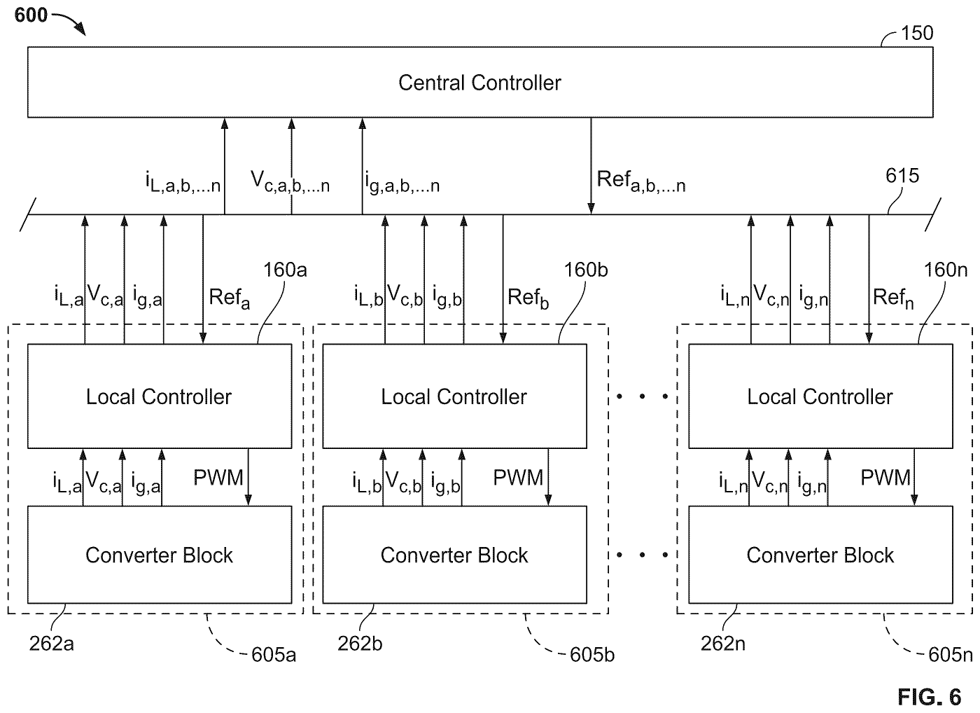

FIG. 6 illustrates a communication system 600 for a cascaded control system, such as described above with respect to the converter system 400 and other converter systems provided herein. The communication system 600 illustrates an example of the communications for at least some examples of the converter system 100 and the converter system 400 (e.g., where n=3). For example, the communication system 600 is an example of a communication system that enables the communications described above with respect to the cascaded control system of FIG. 4.

The communication system 600 includes the central controller 150 and local systems 605a-n. Each local system includes a respective local controller 160a-n and a respective local converter or converter block 262a-n (instances of the converter block 262 described with respect to FIG. 2). The central controller 150 and local controllers 160a-n are communicatively coupled via a communication bus 615. The communication bus 615 may include a collection of dedicated communication paths between each local controller 160 and the central controller 150, may include shared communication paths between the local controllers 160 and the central controller 150 (e.g., where communications include addressing information to identify an intended destination device), or a combination thereof.

As noted, the central controller 150 and the local controllers 160 may communicate with each other in real time (e.g., each control cycle) both monitoring information (e.g., sensor data) and control information. For example, the local controllers 160 may determine and transmit to the central controller 150 electrical operational characteristics including one or more of V_{g,abc}, i_{g,abc}, and i_{L,abc}, and the central controller 150 may determine and transmit the control reference targets 415 (e.g., which may be v_{c,abc}*, i_{L,abc}*, or i_{g,abc}*) based on the received electrical operational characteristics. The local controllers 160 may further generate and transmit PWM control signals to their corresponding converter block 262. The PWM control signals output by the local controllers 160 may indicate a duty cycle and/or a frequency for a PWM signal that drives a gate terminal of each power switching element of the converter block 262, or may be the PWM signal itself. Each converter block 262 may further includes a respective gate driver for driving the power switching elements of the converter block, or the gate driver for a local converter system 605 may be considered part of the corresponding local controller 160.

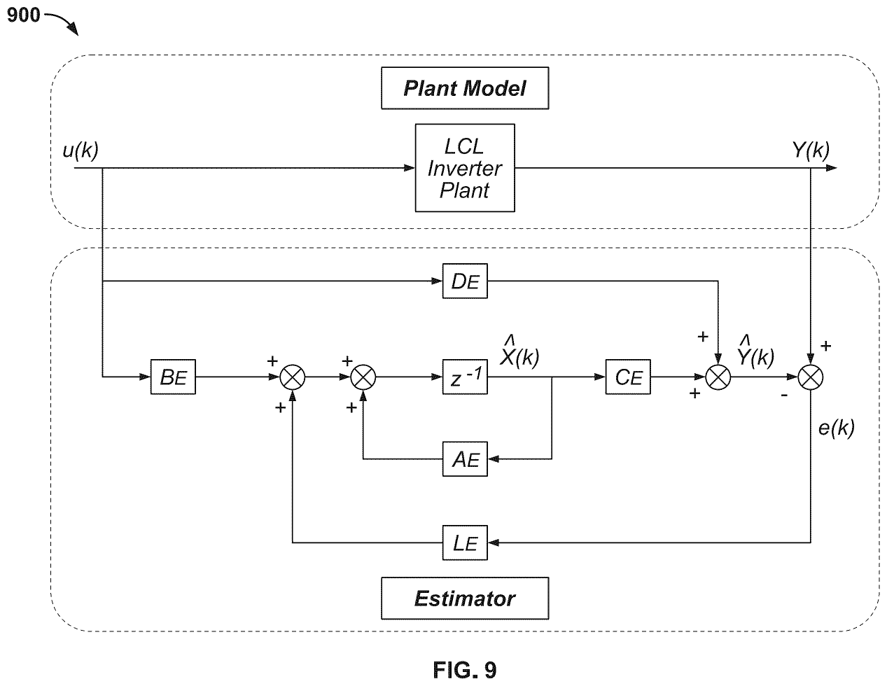

As discussed in further detail below, in some embodiments, a state estimator (e.g., state estimator 900 of FIG. 9) is associated with each of the local controllers to provide an estimation of one or more of the electrical operational characteristics for the phase associated with the local controller based on samplings of other electrical characteristics for the phase. For example, the state estimator may implement a Luenberger observer technique that estimates the switch side inductor current for a phase (also referred to herein as inductor current i_{L,abc}) based on the capacitor voltage (v_{c,abc}) and grid side inductor current (i_{g,abc}) for the phase. Use of a state estimator can reduce the number of sensors used in the system to provide the MPC controllers with the electrical characteristics, thereby reducing costs and/or size of the motor circuitry.

In some embodiments, the cascaded control system further incorporates one or both of harmonic injection, as described above, or MPC for active damping to mitigate resonance, as described below.

### IV. Model Predictive Control

In some embodiments, a power converter system has a non-isolated N-phase power converter and a control system that utilizes model predictive control (MPC). When used in a power converter system (e.g., the system 100 and 400), MPC may provide, for example, active resonance damping, improved dynamic performance, and/or leakage current attenuation capabilities.

A controller of the control system 105, such as the central controller 150 or the local controllers 160, implementing MPC may be referred to as an MPC controller. The MPC controller may be configured to determine electrical operational characteristics of the power converter 115 (e.g., characteristics for each phase of the converter), determine one or more control reference targets for the power converter 115 (e.g., a target per phase of the converter), and then generate control signaling, based on an MPC algorithm using the electrical operational characteristics and the control reference target. The control signaling may be applied to actuate the power switching elements of the power converter 115 to perform voltage conversion and active damping to mitigate resonance in filter circuit(s) 120 of the power converter 115.

The MPC controller (or MPC controllers) may implement an MPC algorithm for each phase of the power converter 115 to generate the control signaling. As used herein, MPC can refer to a control algorithm that relies on or is aware of a system dynamic (e.g., implements or uses a dynamic model representing the converter under control) and predicts, through computation based on electrical characteristics of the converter and the dynamic model, input commands or reference values to control the system's behavior. Accordingly, MPC, as used herein, may refer to a model predictive control algorithm in a stricter use of the term (such as described in further detail below) as well as other dynamic prediction algorithms (e.g., a linear-quadratic regulator (LQR) control algorithm).

In one example, to implement the MPC algorithm for a particular phase, the MPC controller may, in each control period, solve a cost function using the electrical characteristics and the control reference target for that phase. By solving the cost function, the MPC controller can predict future steps of control signaling to actuate the power switching elements to control power on that phase of an AC voltage section of the power converter to trend towards the control reference target. The MPC controller may then generate the control signaling for that particular phase based on a first step of the future steps of control signals. Accordingly, in contrast to a PI control algorithm, the MPC algorithm derives an optimal duty cycle by processing a state variable and tracking error in a linear way with specific coefficients. Because no integration procedure is needed in MPC, the dynamic performance of MPC may be improved relative to a PI technique with less overshoot and higher tracking speed. Additionally, because MPC has higher control bandwidth, the MPC controller can provide an active damping term to mitigate (reduce or eliminate) LC or LCL resonance that may otherwise be present in a filter circuit in the AC section of the power converter 115.

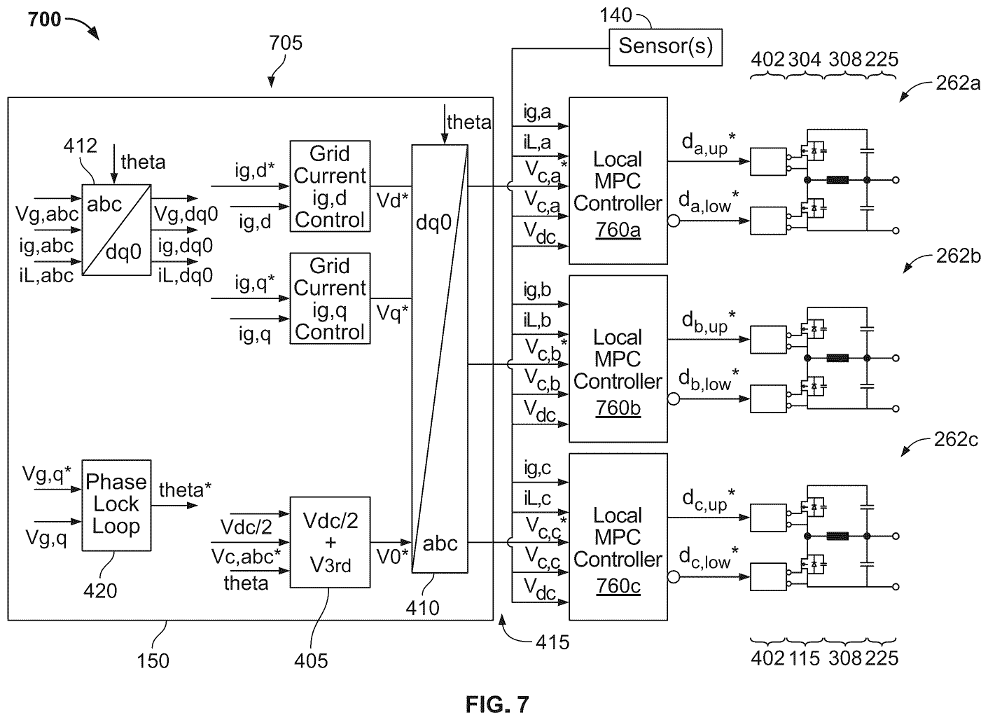

FIG. 7 illustrates a power converter system 700 including MPC control. The converter system 700 is an example of the system 100 and the system 400, described above, in which the local controllers 160 are implemented as MPC controllers. In particular, in FIG. 7, these local controllers are identified as local MPC controllers 760a-c. Accordingly, the discussion above with respect to the system 400 of FIG. 4 applies also to the system 700 of FIG. 7, and like numbers are used for like components.

As is shown in FIG. 7, the converter system 700 includes a control system 705, which is a particular example of the control system 105 referenced above (e.g., with respect to FIGS. 1 and 4). The control system 705 includes the central controller 150 and the local controllers 760a-c. Although illustrated separately, the gate drivers 402 may also be considered part of the local controllers 760a-c. The converter system 700 is a three-phase converter that is configured to serve as an AC/DC rectifier and/or a DC/AC inverter.

The central controller 150 generates three-phases of control references (three-phase capacitor voltages references v_{c,abc}*) in the stationary abc, based on electrical characteristics of the converters 304 from the local controllers 760a-c, for example, in a similar manner as described above with respect to FIGS. 4 and 6. The local MPC controllers 760a-c also regulate switch side inductor currents i_{L,abc} by adjusting the weighting factor between i_{L,abc} and v_{c,abc}.

Each local MPC controller 760 implements MPC-based control per phase in the stationary abc frame. In this example, MPC-based control includes application of a dynamic model of a corresponding converter circuit under control (e.g., the converter block 262a-c of a particular phase associated with each MPC controller 760a-c). More particularly, MPC-based control includes solving an optimization function defined based on the dynamic model to identify an (optimal) control input (or inputs). The dynamic model may include measured or estimated values for the dynamic system, as well as target or reference commands. In some examples, MPC-based control includes solving, for each control period, the optimization function over a finite time-horizon to identify control inputs for each step in the time-horizon to achieve the desired output. Then, the control input for the first step is applied, while the other control inputs are discarded. In the next control period, the process repeats to identify the next control input. In some examples, another MPC control algorithm is implemented.

Using a local MPC controller 760 to implement MPC-based control per phase in the stationary abc frame include, for example: (1) a state space matrix of LC per phase is simpler than the rotational dq (or dq0) system to implement an offline piecewise affine optimization code in a less costly controller hardware (e.g., a less costly DSP controller); (2) the time-varying angular speed term, w, otherwise used in computations can be omitted in the explicit MPC state space matrix for the offline optimization calculation; and (3) per phase MPC for LC is more flexible for a modular design perspective to extend the paralleled phase number and other topologies, e.g., DC/DC, single-phase DC/AC converters.

For the MPC implementation, in every control period, the local MPC controllers 760a-c may receive electrical characteristics from the sensors 140 (e.g., a switch side inductor current (i_{L,abc}), a capacitor voltage (v_{c,abc}), and a grid current (i_{g,abc})), and the control reference target 415 (here, a capacitor voltage reference, v*_{c,abc}) from the central controller 150. As previously noted, each of the electrical characteristics from the sensors 140 may be directed sensed (e.g., by a current or voltage sensor), or one or more of the electrical characteristics may be inferred from another sensed electrical characteristic (see, e.g., state estimation discussion below).

In some examples, the local MPC controllers 760a-c each include an offline-generated piecewise affine search tree that they employ to derive a duty cycle (e.g., an optimal duty cycle) for the explicit MPC control. To this end, state equations of a switch side LC filter (e.g., the LC filters 308) can be expressed as

$$\begin{matrix}{i}_{L} ( k + 1 ) = {i}_{L} ( k ) - \frac{{T}_{s}}{{L}_{f s}} {v}_{c} ( k ) + \frac{{v}_{d c} {T}_{s}}{{L}_{f s}} d ( k ) \\ {v}_{c} ( k + 1 ) = \frac{{T}_{s}}{{C}_{f}} {i}_{L} ( k ) + {v}_{c} ( k ) - \frac{{T}_{s}}{{C}_{f}} {i}_{g} ( k )\end{matrix} .$$

For the flexibility of implementing the explicit MPC and the convenience of experimentally adjusting the DC bus voltage during test, the last term, U_{dc}d(k), can be replaced by the phase leg output voltage, uₓ(k). The state-space model can be expressed in standard matrix format of

$${X}_{k + 1} = {AX}_{k} + {Bv}_{k} + {Ee}_{k}$$

where the variables and matrices represent

$$A = [ \begin{matrix}1 & - \frac{{T}_{s}}{{L}_{fs}} \\ \frac{{T}_{s}}{{C}_{f}} & 1\end{matrix} ] , B = [ \begin{matrix}\frac{{T}_{s}}{{L}_{fs}} \\ 0\end{matrix} ] , E = [ \begin{matrix}0 \\ - \frac{{T}_{s}}{{C}_{f}}\end{matrix} ] , \\ {X}_{k} = [ \begin{matrix}{i}_{L} ( k ) \\ {v}_{c} ( k )\end{matrix} ] , {v}_{k} = [ {v}_{dc} d ( k ) ] , {e}_{k} = [ {i}_{g} ( k ) ] .$$

In the MPC formulation, the inductor current/capacitor voltage references can be defined as X̅ and the tracking errors between the measurement and the references are expressed as \tilde{X} which are composed of

$${\overline{X}}_{k} = [ \begin{matrix}{i}_{Lr} ( k ) \\ {v}_{cr} ( k )\end{matrix} ] , {\tilde{X}}_{k} = [ \begin{matrix}{i}_{Lr} ( k ) - {i}_{L} ( k ) \\ {v}_{cr} ( k ) - {v}_{c} ( k )\end{matrix} ] .$$

Thus, the cost function includes two terms

$$min {\sum }_{k = 0}^{{N}_{c}} {\tilde{X}}_{k}^{T} Q {\tilde{X}}_{k} + {\sum }_{k = 0}^{{N}_{p} - 1} Δ {v}_{k}^{T} R Δ {v}_{k} .$$

For the penalties of the cost function, Q and R represent the weighting factor matrices that are implemented on the state values and input values, respectively. Specifically, Q is a 2×2 matrix, [Q₁₁, 0; 0, Q₂₂], which is applied for the tracking errors between the state variables and the references. Because a goal of the local MPC controllers 760a-c is to track the output capacitor voltage references, in some examples, the corresponding weighting factor, Q₂₂, is configured to be larger (e.g., 1000 times larger) than the switch side inductor current term, Q₁₁. R is a 1×1 matrix, [R₁₁] which is applied for stabilizing the variation between the adjacent input variables. R₁₁ is set to be smaller (e.g., 100 times smaller) than Q₂₂. In other examples, other weighting factors may be used.

The constraints of the MPC controller can be expressed as

$${\tilde{X}}_{k + 1} = A {\tilde{X}}_{k} + {Bv}_{k} + {Ee}_{k} ∈ 𝒳 , \\ Δ {v}_{k} = {v}_{k} - {v}_{k - 1} ∈ 𝒰 , \\ [ \begin{matrix}- {I}_{L , max} \\ 0\end{matrix} ] \leq {X}_{k} \leq [ \begin{matrix}{I}_{L , max} \\ {v}_{dc}\end{matrix} ] , \\ [ 0 ] \leq {u}_{k} \leq [ {U}_{dc} ] , \\ [ - {I}_{g , max} ] \leq {e}_{k} \leq [ {I}_{g , max} ] .$$

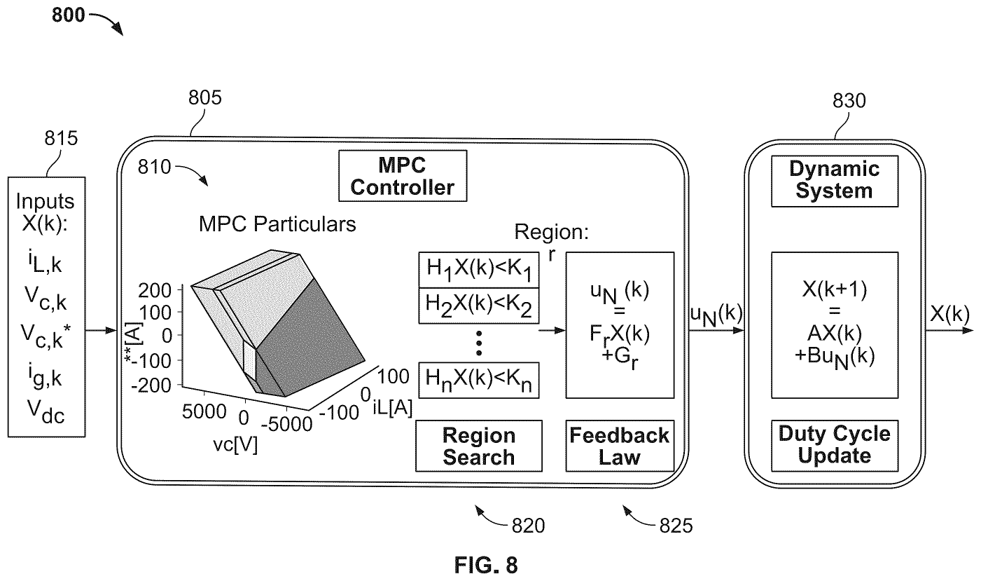

FIG. 8 illustrates an example implementation of an MPC control system 800 that may be executed by each of the local MPC controllers 760a-c. In this example, the MPC algorithms are implemented in an explicit way. The MPC control algorithm executed by the local MPC controllers 760a-c is represented by the MPC control block 805. Specifically, a piecewise affine (PWA) feedback law is generated offline based on the pre-selected state space modeling and constraints. Then, the corresponding MPC partitions 810 are stored on a memory of each local MPC controller 760a-c to be available for online searching. In each controlling time period, the MPC control block 805 searches the n regions of the PWA MPC partitions 810 (in block 820) to identify an active region, r, based on the inputs 815 received by the MPC control block 805. For example, the MPC control block 805 may employ a binary search tree to search and quickly find the active region r from the n regions. Further, each of the n regions is associated with a respective pair of identification H and K matrices. Accordingly, the applicable active region r, is identified based on matrices Hᵣ and Kᵣ. Accordingly, the applicable active region 4 is identified based on the matrices Hᵣ and Kᵣ. Then, for the active region r, the corresponding feedback law matrices, Fᵣ and Gᵣ are applied (block 825) to calculate the input matrix that includes optimal input values over the prediction horizon (or time window). The first value of the input matrix is then output and applied to the dynamic system for MPC control, while the other input values of the input matrix are discarded.

Accordingly, the (offline-generated) MPC partition 810 represents the n regions of the PWA feedback law for the MPC control block 805 to search. During operation of the MPC control block 805 (online), the identification matrices Hᵣ and Kᵣ will lead to an active region of the MPC partition 810, and the corresponding matrices Fᵣ and Gᵣ will help calculate the optimal input value (u_{N}(k)) for the PWM modulation based on the updated state values of switch side inductor current/output capacitor voltage. Here, u_{N}(k)=(v_{dc}*d(k)), where vdc is the DC bus voltage across DC terminals 220 (see, e.g., FIG. 3), and d(k) is the duty cycle for the PWM control signal. The control matrices Fᵣ and Gᵣ are derived based on the above-described cost function and constraints.

In each control period, the MPC control block 805 takes the inputs 815 (e.g., i_{L} (k), v(k), i_{g}(k), and the reference of v_{c,ref}(k), where k indicates the phase a, b, or c) to find the active region r with the corresponding searching matrices Hᵣ and Kᵣ. Then, the duty cycle d(k) is derived with the specific control law matrices of F_{s,c} and G_{s,c} for the PWM modulation and output by the control block 805 (e.g., as part of uN(k)). The output duty cycle (d(k)) may be a value between 0 to 1. The output duty cycle is provided to the dynamic system 830, which represents the converter block 262 (e.g., the gate driver(s) associated with the local MPC controller 760a-c implementing the MPC control block 805 may receive the output duty cycle).

In some examples, the control system 105 includes N MPC controllers (e.g., N local controllers 160, where N≥1), one for each phase of the power converter 115. In some embodiments, each of the MPC controllers receives, from a central controller (e.g., central controller 150), a control reference target for the phase associated with the MPC controller. In other (non-cascaded control system) embodiments, the MPC controllers each determine a respective control reference target locally. For example, the MPC controllers may execute a separate MPC algorithm to derive the control reference targets, or may include a non-MPC algorithm (e.g., a PI control algorithm, a PID control algorithm, or the like) that is executed to derive the control reference targets.

In some embodiments, a state estimator is associated with each of the N MPC controllers to provide an estimation of one or more electrical characteristics for the phase associated with the MPC controller based on samplings of other electrical characteristics for the phase. For example, the state estimator may implement a Luenberger observer technique that estimates the switch side inductor current for a phase (also referred to herein as inductor current i_{L,abc}) based on the capacitor voltage (v_{c,abc}) and grid side inductor current (i_{g,abc}) for the phase. Use of a state estimator can reduce the number of sensors used in the system to provide the MPC controllers with the electrical characteristics, thereby reducing costs and/or size of the motor circuitry.

In some embodiments, MPC for active damping to mitigate resonance may be included in a power converter that includes one or both of a cascaded control system and harmonic injection, as described above.

### V. State Estimator

As noted herein, in some examples, the control system 105 or a controller 150, 160, 760, or 805 uses or implements a state estimator to determine one or more electrical characteristics of a corresponding converter under control. Use of a state estimator can reduce sensor count of the system, which can reduce sensor cost, reduce volume for the converter (improving power density), and/or improve control performance through an anti-noise capability (i.e., reduction in noise) compared to sensing certain electrical characteristics.

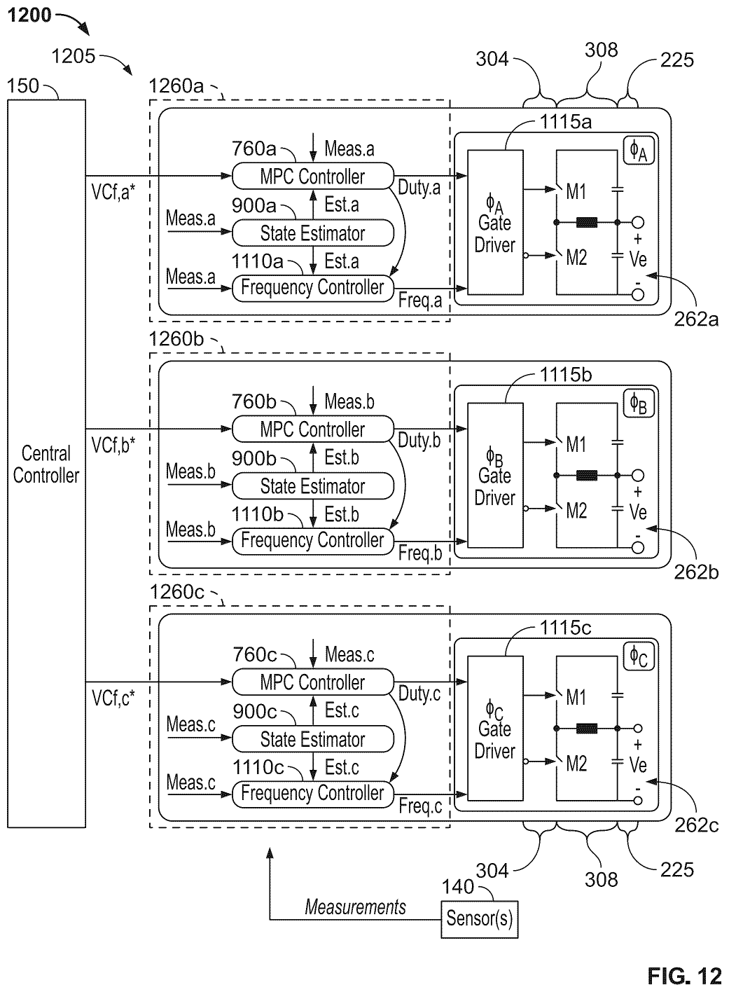

For example, with reference the various power converters systems described herein (e.g., converter systems 100, 200, 300, 700), one of the three variables, switch side inductor current (i_{Lfs}), filter capacitor voltage (v_{Cf}), and grid filter inductor (i_{Lfg}), can be estimated by the other two variables. FIG. 9 illustrates a state estimator 900 for use, for example, with a cascaded model predictive control of an LCL filter system, such as the converter 700 of FIG. 7. However, the state estimator 900 is also applicable to the other converters using similar principles. The state estimator 900 may be implemented by one of the controllers (e.g., controller 150, 160, 760, 805), e.g., as a hardware or executable software block of the controller. For example, with reference to FIG. 7, the state estimator 900 may be incorporated into each of the local MPC controllers 760. Additionally, an example of the state estimator 900 included within local MPC controllers is shown in FIG. 12.

Specifically, the state estimator 900 may implement a Luenberger observer that is designed to estimate the switch side inductor current, î_{Lfs}, capacitor voltage, \hat{v}_{Cf}, and grid side inductor current, î_{Lfg}, with the samplings of capacitor voltage, v_{Cr}, and grid side inductor current, i_{Lfg}. In other examples, however, the state estimator 900 may estimate the variables based on samplings of any two of the three variables. In still further examples, the state estimator 900 may estimate the variables based on samples of any one of the three variables, which may allow reduction of one further sensor, but may reduce the accuracy of the estimation. The samplings may be measurements (e.g., of current and voltage) provided to the state estimator 900 by the sensors 140.

The state-space equations for the discrete-time state estimator can be expressed in standard matrix format of

$${\hat{X}}_{k + 1} = {A}_{E} {\hat{X}}_{k} + {B}_{E} {u}_{k} + {L}_{E} ( {Y}_{k} - {\hat{Y}}_{k} ) \\ {\hat{Y}}_{k + 1} = {C}_{E} {\hat{X}}_{k} + {D}_{E} {u}_{k}$$

where the variables and matrices for Luenberger observer represent

$${A}_{E} = [ \begin{matrix}0 & - \frac{1}{{L}_{fs}} & 0 \\ \frac{1}{{C}_{f}} & 0 & - \frac{1}{{C}_{f}} \\ 0 & 0 & 0\end{matrix} ] , {B}_{E} = [ \begin{matrix}\frac{1}{{L}_{fs}} \\ 0 \\ 0\end{matrix} ] , \\ {C}_{E} = [ \begin{matrix}0 & 1 & 0 \\ 0 & 0 & 1\end{matrix} ] , {D}_{E} = [ \begin{matrix}0 \\ 0\end{matrix} ] , \\ {\hat{X}}_{k} = [ \begin{matrix}{\hat{i}}_{Lfs} ( k ) \\ {\hat{v}}_{Cf} ( k ) \\ {\hat{i}}_{Lfg} ( k )\end{matrix} ] , {\hat{Y}}_{k} = [ \begin{matrix}{\hat{v}}_{Cf} ( k ) \\ {\hat{i}}_{Lfg} ( k )\end{matrix} ] .$$

L_{E} is a 3×2 observer gain matrix that can be tuned to achieve minimal estimation errors. The diagram of the state estimator is shown in FIG. 9. The state observer minimizes the estimation error, e(k), with a dynamic equation of

$${e}_{k + 1} = ( {A}_{E} - {L}_{E} {C}_{E} ) {e}_{k} .$$

The estimation gain can be derived by

$${L}_{E}^{T} = {RM}^{- 1}$$

where R is composed of tuning factors and M is determined by solving the Sylvester equation

$${A}_{E}^{T} M - M Λ = {C}_{E}^{T} R$$

in which Λ is a matrix with the desired eigenvalues.

In this particular example, the system incorporating the state estimator 900 may have no current sensor for directly sensing switch side inductor current and may, instead, rely on the estimation of this current value (e.g., based on sensed voltage of the lower capacitor and/or sensed current of a grid-side inductor). This approach may be beneficial because directly sensing the switch side inductor current with a current sensor can be challenging, for example, due to noise from the proximity of the sensor to the power switching devices of the converter.

In some embodiments, a state estimator as described may be included in a power converter that includes one or more of a cascaded control system, harmonic injection, or MPC-based control, as described above.

### VI. Variable Frequency Critical Soft Switching

In some examples, one or more of the controllers provided herein (e.g., controllers 150, 160, 760) drive their corresponding power converter blocks 262 (e.g., forming the converter 115, 200, 300, or 304) using a variable frequency critical soft switching (VFCSS) scheme. The VFCSS scheme can provide improved efficiency and reduced filter volume (i.e., improved power density) for the power converter. Soft switching allows for the substitution of turn-on switching losses for turn-off switching losses, which is beneficial at least because turn-on losses for at least some FETs (e.g., SiC FETs) are typically much greater than turn-off losses. This VFCSS technique makes possible an increase in switching frequency (e.g., by a factor of 5) and a reduction in inductance (e.g., by a factor of 20) while reducing the FET switching losses, which results in improved power density and efficiency.

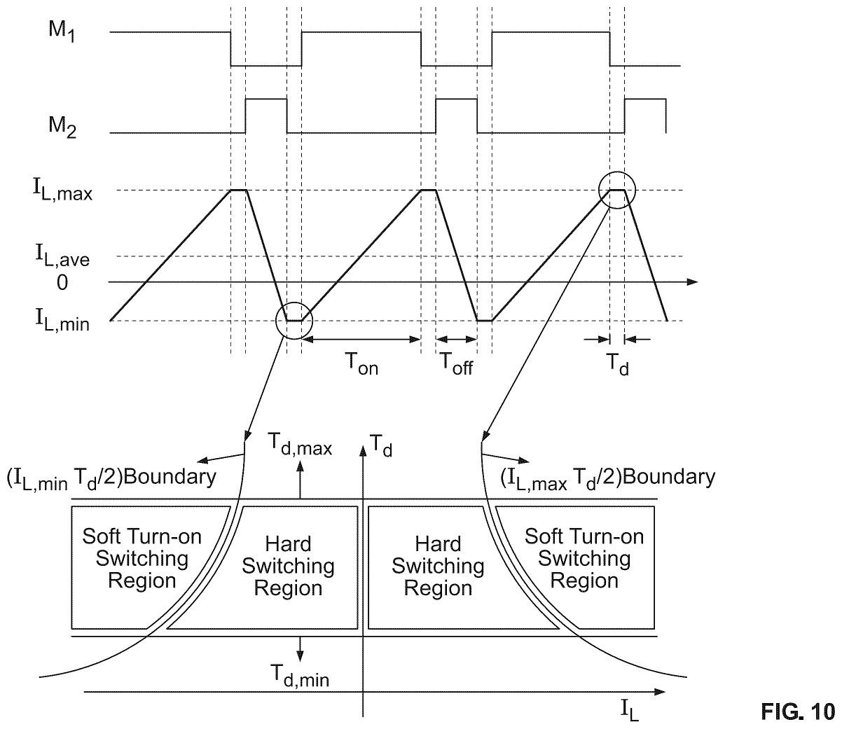

VFCSS is implemented by varying the switching frequency to achieve a desired inductor ripple current in the LC filter (e.g., in the switch-side inductor 250 of the LC filter 245 and LC filter 308 in FIGS. 2 and 3) to provide a soft switching transition. The desired inductor ripple current may be derived such that the valley point of the inductor current reaches a predetermined value of inductor threshold current I_{L,thr}. For a converter, such as the converter 200 of FIG. 2 or 304 of FIG. 3, I_{L,thr} is set in accordance with the boundary conditions of dead time and peak/valley inductor current for inductor 250, which can be derived from the output capacitance of the corresponding switching elements 235, 240. FIG. 10 shows the boundary relationships of the dead time (T_{d}) and peak and valley inductor current I_{L,max} and I_{L,min}, respectively. Inductor current and dead time values that result in soft switching are identified as soft turn-on switching areas or regions, and inductor current and dead time values that do not result in soft switching are identified as hard switching areas or regions. The soft switching regions represent the areas of operation where there is sufficient time and current for discharging the output capacitance of the power switching element (M1 or M2) before it is turned on. Analytically, these boundaries are expressed as

$$( 1 / 2 ) {I}_{L , max} {T}_{d} \leq {Q}_{min} \leq 0 , \\ ( 1 / 2 ) {I}_{L , min} {T}_{d} \geq {Q}_{max} \geq 0 ,$$

where Qₘᵢₙ and Qₘₐₓ are the minimum discharge thresholds of the switch output capacitance for the soft switching.

For high positive values of DC inductor current, a large current ripple (e.g., more than 200%, or a value within a range of 200%-300%, of the current through the inductor) is used or required to maintain a valley inductor current point that is lower than the threshold current level-I_{L,thr}. The negative inductor current will discharge the upper switch output capacitance in the turn-off transient period of the lower switch. Similarly, for high negative values of DC inductor current, a large current ripple is also used or required to ensure the peak inductor current point is greater than the threshold current I_{L,thr}. Zero voltage switching (ZVS) of the lower switch will be achieved if the lower switch output capacitance is fully discharged by the positive inductor current during the turn-off transient of the upper switch. Generally, to achieve full soft switching over an entire cycle (e.g., an entire grid cycle), the current ripple should be sufficiently large to guarantee bidirectional inductor current paths or the dead time should be expanded. As unnecessarily large dead times can result in distortion, VFCSS adjusts the switching frequency to maintain critical soft switching over the full cycle. The VFCSS scheme is implemented to maintain a positive threshold current during the negative portion of the cycle and a negative threshold current during the positive portion of the cycle. The switching frequency to achieve this for an arbitrary threshold value can be calculated with the following equation:

$${f}_{sw} = \frac{( 1 - d ) {dv}_{DC}}{2 ( \vert {I}_{L} \vert + {I}_{L , thr} ) {L}_{SW}}$$

where I_{L,thr} is the boundary threshold current for soft switching, which can be derived from FIG. 10 with a given dead time (T_{d}), IL is the switching side inductor current, and where d is the reference duty cycle (a value between 0 and 1).

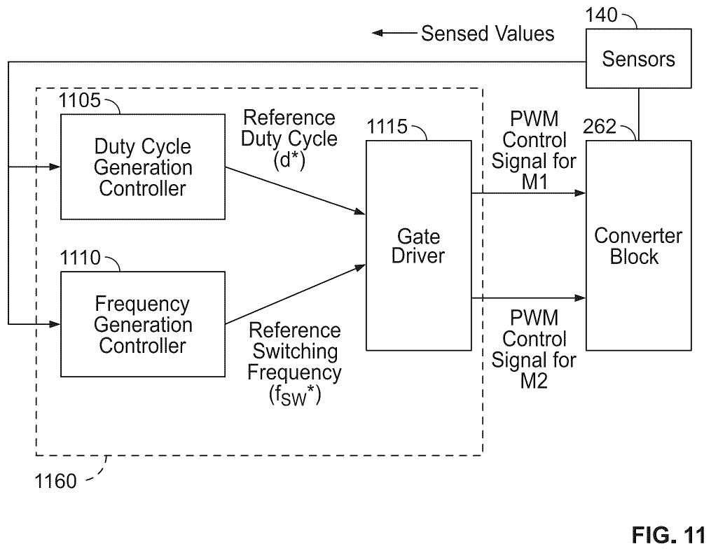

FIG. 11 illustrates a control system 1100 for controlling a pair of switching elements of a power converter. In particular, the control system 1100 illustrates a controller 1160 implementing an example control scheme for VFCSS control of the converter block 262 (see FIG. 2). In some examples, the controller 1160 is a particular implementation of one or more of the controllers 150, 160, 750, 760. The controller 1160 includes a duty cycle generation controller 1105 and a frequency generation controller 1110, which may be regulators for generating, respectively, a reference duty cycle (d*) and a reference switching frequency (f_{SW}*). The duty cycle generation controller 1105 may generate the reference duty cycle (d*) based on sensed (or estimated) characteristics of the power converter 210, such as currents and/or voltages provided by the sensors 140, the state estimator 900, or a combination thereof. For example, the duty cycle generation controller 1105 may implement a PID controller, an MPC controller (see, e.g., MPC control block 805), or another type of regulator. The frequency generation controller 1110 may generate the reference switching frequency (f_{SW}*) based on sensed (or estimated) characteristics of the converter block 262 and the above noted equation for calculating F_{SW}*.

The gate driver 1115 receives the reference duty cycle (d*) and a reference switching frequency (f_{SW}*) from the controllers 1105 and 1110, respectively. Based on these received reference values, the gate driver 1115 generates a first PWM control signal for the upper switch (M1) 235 and a second PWM control signal for the lower switch (M2) 240. For example, the gate driver 1115 generates the first PWM control signal having a frequency (f_{SW}) equal to the reference switching frequency, and with a duty cycle (d₁) equal to the reference duty cycle (d*). Similarly, the gate driver 1115 generates the second PWM control signal having the frequency (f_{SW}) equal to the reference switching frequency (f_{SW}*), and with a duty cycle d₂ equal to 1−d₁−(T_{d}/f_{SW}) and/or (1−D)*T_{SW}−(Td/f_{SW}), and where the ON edge of the second PWM control signal lags the OFF edge of the first PWM control signal by a time T_{d}/2, and the OFF edge of the second PWM control signal leads the ON edge of the PWM signal by a time Td/2.

While FIG. 11 illustrates a VFCSS control for a single phase, FIG. 12 illustrates the VFCSS scheme implemented in a three-phase MPC-control-based power converter. More particularly, FIG. 12 illustrates a power converter system 1200 including MPC control with variable frequency critical soft switching (VFCSS). The converter system 1200 is another example of the power system 100 and is similar to the systems 400 and of the system 700 described above, except that the local controllers 160 are implemented as MPC-VFCSS controllers. In particular, in FIG. 12, these local controllers are identified as local MPC-VFCSS controllers 1260a-c. Accordingly, the discussion above with respect to the system 100 of FIG. 1, 400 of FIG. 4 and system 700 of FIG. 7 applies also to the system 1200 of FIG. 12, and like numbers are used for like components. Additionally, because the system 1200 is, in some respects, an extrapolation of the single phase VFCSS of FIG. 11 to a multiphase system, like numbers are used for like components, in some cases with the addition of a phase designation of “a,” “b,” or “c” (e.g., each of the three instances of the frequency controller 1110 from FIG. 11 is identified as the frequency controller 1110a, 1110b, or 1110c in FIG. 12).

As is shown in FIG. 12, the converter system 1200 includes a control system 1205, which is a particular example of the control system 105, and which is similar to the control system 705, referenced above (e.g., with respect to FIGS. 1, 4, and 7). The control system 1205 includes the central controller 150 and the local MPC-VFCSS controllers 1260a-c. Although illustrated separately, the gate drivers 1115a-c may also be considered part of the local MPC-VFCSS controllers 1260a-c. The converter system 1200 implements a three-phase converter that is configured to serve as an AC/DC rectifier and/or DC/AC inverter. Accordingly, the converter circuit (e.g., the power switching elements), which is identified as the converter 304, may include a respective converter block 262a-c for each phase a, b, c.

The central controller 150 generates three-phases of control references (three-phase capacitor voltages references v_{c,abc}*) in the stationary abc reference frame, based on electrical characteristics of the converters 304 from the local controllers MPC-VFCSS 1260a-c, for example, in a similar manner as described above with respect to FIGS. 4 and 6.

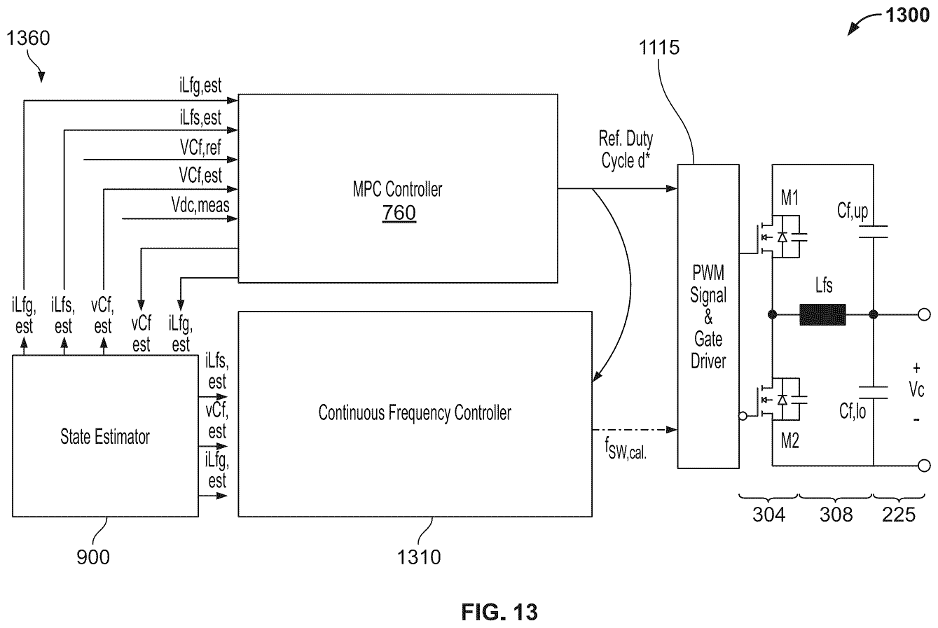

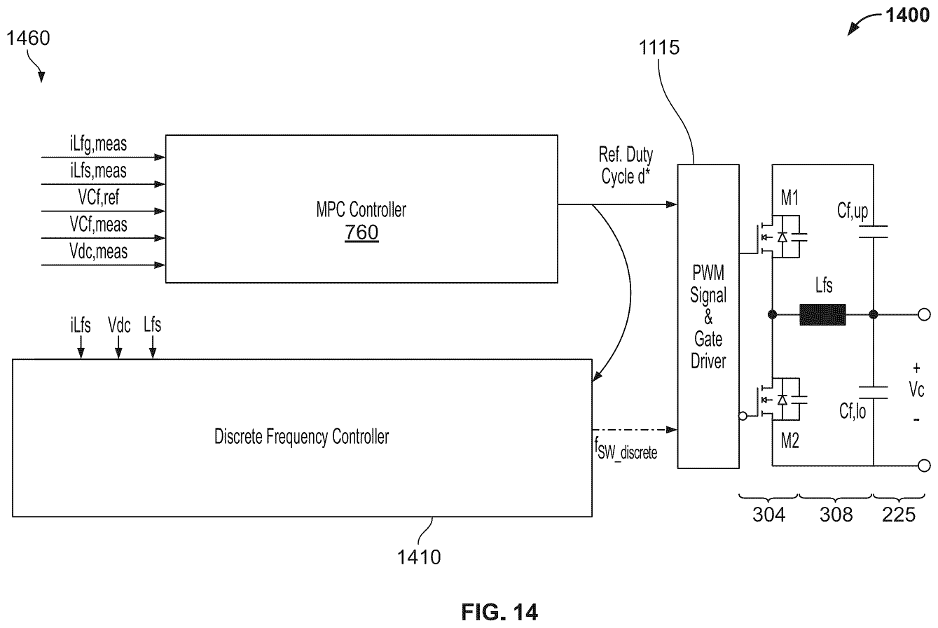

As shown in FIG. 12, the local MPC-VFCSS controllers 1260a-c each include a respective MPC controller 760a-c, a respective state estimator 900a-c, and a respective frequency controller 1110a-c. The MPC controllers 760a-c may function similar to the MPC controllers 760a-c of FIG. 7, providing a duty cycle reference dₐ*, d_{b}*, or d_{c}* output for the phase a, b, or c corresponding to the particular MPC controller 760a-c. The state estimators 900a-c may function similar to the state estimator 900 of FIG. 9, providing estimated values for the phase a, b, or c corresponding to the particular state estimator 900a-c based on measurements provided by the sensors 140. The frequency controller 1110a-c may function similar to the frequency controller 1110 of FIG. 11, providing a reference frequency f_{SW}* for the phase a, b, or c corresponding to the particular frequency controller 1110a-c. Further examples of the frequency controllers 1110a-c are described with respect to FIGS. 13-14 below. The gate drivers 1115a-c may function similar to the gate driver 1115 of FIG. 11, providing PWM control signals to the power switching elements of the converter 304 for the phase a, b, or c corresponding to the particular gate driver 1115a-c based on the received duty cycle references d_{abc}* and reference switching frequencies f_{SW,abc}*.

In some examples, the state estimators 900a-c are not provided in the system 1200 and, instead, each of the measured values used by the MPC controller 760a-c and the frequency controller 1100a-c are provided through direct sensing via sensors 140 (such as shown in FIG. 11 and FIG. 14). In some examples, in place of the MPC controllers 760a-c, another local controller 160a-c (e.g., a PI or PID controller) is provided for the local PWM regulation of each phase of the converter 304.

FIGS. 13 and 14 each illustrate an example of the local MPC-VFCSS controller 1260, each with a different control strategy for generating the reference switching frequency f_{SW}*. More particularly, FIG. 13 illustrates a control system 1300 with a local MPC-VFCSS controller 1360 (an example of the local MPC-VFCSS controller 1260 of FIG. 12) implementing variable-continuous-frequency critical-soft-switching (VCF-CSS), while FIG. 14 illustrates a control system 1400 with a local MPC-VFCSS controller 1460 (another example of the local MPC-VFCSS controller 1260 of FIG. 12) implementing variable-discrete-frequency critical-soft-switching (VDF-CSS). Accordingly, the controller 1360 may be referred to as a local MPC-VCFCSS controller 1360, or a continuous frequency controller 1360 to simplify the discussion, and the controller 1460 may be referred to as a local MPC-VDFCSS controller 1460, or a discrete frequency controller 1460 to simplify the discussion.

The two controllers 1360 and 1460 are implemented to achieve critical soft switching operation for high efficiency with different types of frequency. The continuous frequency controller 1360 derives a continuous switching frequency based on the critical soft switching boundary conditions and then directly implements the frequency value to the PWM control signals (via gate driver 1115). The continuous frequency controller 1360 also receives an estimate of the switch side inductor current value (I_{Lfs,est}) from the state estimator 900 and, in some examples, of other electrical characteristics of the associated LC filter. On the other hand, the discrete frequency controller 1460 discretizes the calculated switching frequency with multiple times of the sampling frequency for PWM and may not use the state estimator 900 to derive the switch side inductor current value.

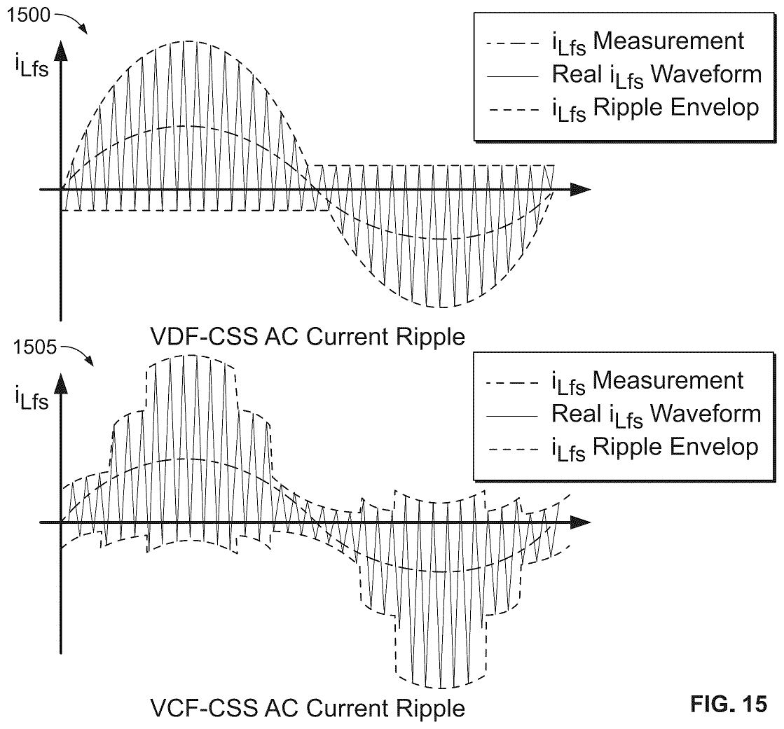

FIG. 15 shows the switch side inductor current waveform 1500 for VCF-CSS and the switch side inductor current waveform 1505 VDF-CSS, respectively. The envelopes of VCF-CSS and VDF-CSS are smooth and discretized due to the varying types of switching frequency. Both techniques can achieve critical soft switching operation for an improvement of efficiency. Both the VCF-CSS and VDF-CSS techniques may be combined with MPC-based control to address the time-varying switching frequency, and the MPC-based control may improve the transient performance with less oscillation and spikes, even for the discretized frequency VDF-CSS technique. Accordingly, the corresponding di/dt stress on the power switching elements of the converters are low.

Turning to FIG. 13 more specifically, the continuous frequency controller 1360 may be designed to calculate the desired continuous switching frequency based on the peak/valley switch side inductor current and the critical soft switching boundary conditions. More particularly, the continuously varying switching frequency, f_{SW, cal}, is derived based on the threshold current (Iₜₕ) of critical soft switching boundary conditions. The switch side inductor current ripple, Δi_{Lfs}, can be calculated as

$$Δ {i}_{Lfs} = \frac{d ( 1 - d ) {v}_{dc}}{{f}_{s} {L}_{fs}} .$$

The critical soft switching boundary conditions require the peak/valley inductor current values to be higher than Iₜₕ and lower than −Iₜₕ, respectively. Thus, the calculation of the continuously varying switching frequency, f_{SW, cal}, can be expressed as

$${f}_{SW , cal} = \frac{( 1 - d ) {dv}_{dc}}{2 ( {i}_{Lfs , ave} + {I}_{th} ) {L}_{fs}} , {i}_{Lfs , ave} \geq 0 \\ {f}_{SW , cal} = \frac{( 1 - d ) {dv}_{dc}}{2 ( {I}_{th} - {i}_{Lfs , ave} ) {L}_{fs}} , {i}_{Lfs , ave} \leq 0$$

where i_{Lfs,ave} is the average value of switch side inductor current without considering the high current ripple for critical soft switching calculation. The i_{Lfs,ave} has also been plotted as the sine waveform line of waveforms 1500 in FIG. 15.

As is shown in FIG. 13, a continuous frequency control block 1310 (an example of the frequency controllers 1110a-c of FIG. 12) receives the estimated values of i_{Lfs,est}, v_{Cf,est} and i_{Lfg,est} from the state estimator 900 and reference duty cycle value (d*) from the MPC controller 760. Based on these received values, the continuous frequency control block 1310 calculates the reference switching frequency, f_{SW,cal}. The frequency controller 1310 outputs the reference switching frequency, f_{SW,cal} to the gate driver 1115.

The state estimator 900 can provide a more accurate switch side inductor current value for the reference switching frequency calculation compared with direct sampling of the current (e.g., via the sensors 140) For example, with direct sampling via the sensors 140, the varying switching frequency can result in a deviation of sampling from the true averaged inductor current value, especially when the current ripple is large for critical soft switching. However, this deviation error can be mitigated as a result of the calculations that are performed by the state estimator 900.

Turning now to FIG. 14, the discrete frequency controller 1460 includes similar components to the continuous frequency controller 1360 (which are like numbered), except for the inclusion of a discrete frequency control block 1410 in place of the continuous frequency control block 1310 and the state estimator 900. Like the continuous frequency control block 1310, the discrete frequency control block 1410 is another example of the frequency controllers 1110a-c of FIG. 12. Instead of the state estimator 900, the discrete frequency controller 1460 (including the MPC controller 760 and discrete frequency control block 1410) receive measurements from the sensors 140 for the relevant currents and voltages.

In the discrete frequency controller 1460, the continuously varying switching frequency in the previously described equations is further discretized into pre-defined frequency bandwidth sections, which is designed as an integral multiple of the fundamental sampling frequency, f_{SW,base}. Thus, the discretized varying switching frequency for PWM signals can be n times of f_{SW,base} (n∈ [symbol] ). To ensure the soft switching operation, the multiple value of n may be rounded down during the discretization by choosing a relatively lower switching frequency section.

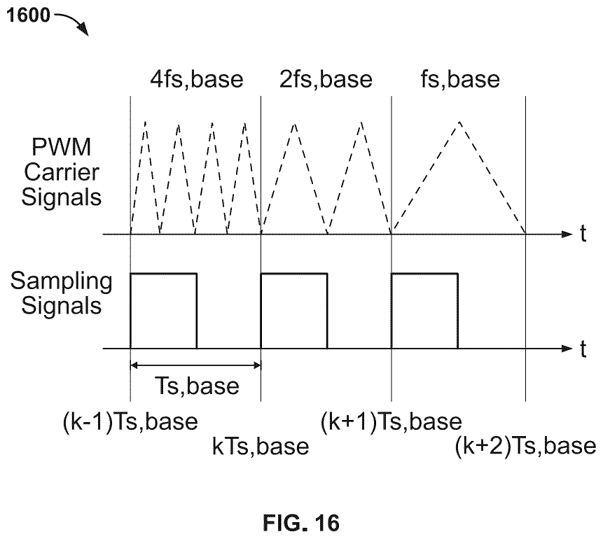

A relationship of PWM switching carrier signals and sampling signals (for the sensors 140) are shown in plot 1600 of FIG. 16. In plot 1600, a varying switching frequency from 4f_{SW,base} to 2f_{SW,base} then to f_{SW,base} is illustrated. The process of frequency discretization can be expressed as

$${f}_{SW , discrete} = {nf}_{s , base} = floor ( \frac{{f}_{SW , cal}}{{f}_{SW , base}} ) {f}_{SW , base} .$$

The discretized frequency may be ringing back and forth by the oscillation of sampling noise during frequency changing transients. A hysteresis loop is configured after the frequency discretization process to eliminate the frequency oscillation. Then, the reference discretized frequency (f_{SW,discrete}) is output to the gate driver 1115 to control the frequency of the PWM control signals to the converter 304.

Compared with the VCF-CSS, the VDF-CSS discretizes the switching frequency to be multiple times of the fundamental sampling frequency. Thus, the switch side inductor current can be sampled at the average points of the current ripple, without deviation from the accurate values as is shown in FIG. 16. Thus, even without the state estimator for the estimation of i_{Lfs}, the inductor current sampling can be accurate for the critical soft switching calculation at high current ripple.

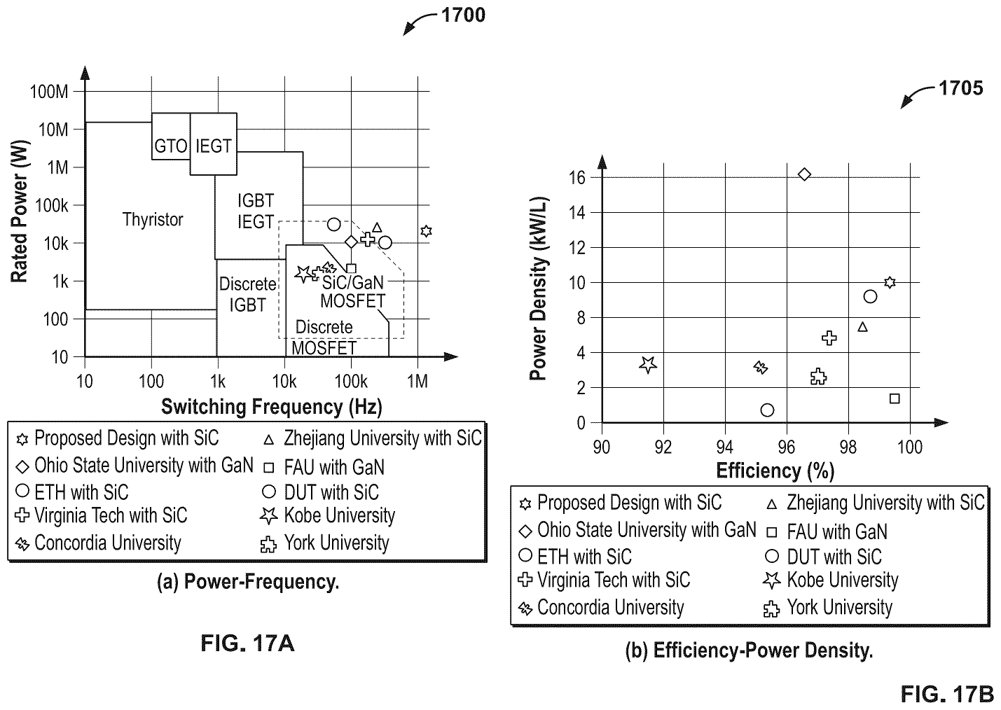

FIGS. 17A and 17B include plots 1700 and 1705, respectively, which illustrate example experimental results for one example of a power converter system 1200, such as described herein, that incorporates: a three-phase converter with SiC FETs (see, e.g., FIG. 3), third harmonic injection (see, e.g., FIG. 4), a cascaded control system (see, e.g., FIGS. 4, 6, and 7), MPC-based local controllers within the cascaded control system (see, e.g., FIGS. 7), and variable frequency soft switching (see, e.g., FIGS. 11-14). In other examples power converters provided, one or more of these features is not included (e.g., instead of third harmonic injection, Vdc/2 is provided of the zero-sequence voltage control reference; or, instead of local MPC-based control, another local regulator is included).

In FIG. 17A, plot 1700 illustrates rate power (W) versus switching frequency (Hz) of the power converter system 1200 as well as several other examples systems. In FIG. 17B, plot 1705 illustrates power density (kW/L) versus efficiency (%). As illustrated, relative to other systems, the power converter system 1200 may obtain high switching frequencies and a balance of both high-power density and high efficiency.

In some embodiments, a VFCSS as described may be included in a power converter that includes one or more of a cascaded control system, harmonic injection, MPC-based control, or a state estimator, as described herein.

### VII. Modular Power Converter

This Section describes systems and methods related to modular power converters constructed from one or more modular power converter units, also referred to as autoconverter modules or power converter modules. Such autoconverter modules (ACMs) may be easily connected together for different applications and remain highly efficient power converters across the different applications. As described further below, in some examples, each modular power converter may provide a single phase of a multi-phase power output (e.g., in a DC/AC inverter application), or may receive a single phase of a multi-phase power input (e.g., in an AC/DC rectifier application). In some examples, multiple modular power converters are coupled together in parallel for each phase of a multiphase modular power converter. Any of the previously described power converters herein may be implemented as a modular power converter based on the principles described in this section. That is, in some examples, one or more of the above-described power converters 100, 400, 700, and 1200 are modular power converters constructed form one or more ACMs.

Turning to FIG. 18A, a modular power converter 1800 with a single ACM 1805 is illustrated. In FIG. 18B, a modular power converter 1820 is illustrated with n ACMs 1805 connected in parallel. Each ACM 1805 may include an instance of the converter 200 which may also be referred to as the converter block 262 (see FIG. 2), including a DC link capacitor (C_{DC}), a high side (upper) switch, a low side (lower) switch, a midpoint node connecting a drain terminal of upper switch and a source terminal of lower switch, and an LC filter. As illustrated, the converter 200 of the ACM 1805 includes a source-drain capacitor for each of the upper and lower switches, and the LC filter includes both an upper capacitor and lower capacitor, as described in further detail with respect to FIG. 2. In some examples, one or more of the source-drain capacitor and the upper capacitor of the LC filter are not included in the converter 200 of the ACM 1805. Like in FIG. 2, the converter 200 of the ACM 1805 further includes DC terminals 220, including positive DC terminal 222 and negative DC terminal 224, and interface terminals 225, including positive interface terminal 227 and negative interface terminal 229.

Further, each ACM 1805 may include a single printed circuit board (PCB) on which the elements of the converter 200 are mounted. Additionally, although not illustrated in FIGS. 18A-B, a local controller 160 (e.g., in the form of a local MPC controller 760 or local MPC-VCSS controller 1260) may be part of each ACM 1805 and mounted or otherwise included on the same PCB as the converter 200 for the ACM. The PCB may be represented by the dashed-line box around each ACM 1805. Each ACM 1805 may be of a similar size, orientation, and general configuration such that they are modular and can be swapped in and out of a converter system with another ACM 1805.

In some examples, a modular power converter is provided, such as the modular power converter 1820, that includes n ACMs 1805 coupled together as shown in FIG. 18B, and further coupled to a central controller (e.g., central controller 150) as shown in various power converter systems of this disclosure (see, e.g., FIGS. 4, 6, 7, and 12). As explained with respect to those examples, the central controller 150 may determine target operational parameters (e.g., at a macro level) for the modular ACMs 1805 and provide these target operational parameters to the local controllers of these ACMs 1805. The local controllers, in turn, can control and regulate the power switching elements of their respective ACMs 1805 in accordance with those target operational parameters.

As shown in FIG. 18B, in some examples, the n ACMs 1805 include at least two power converter modules or three power converter modules that are coupled in parallel such that the positive DC terminal 222 of each of the ACMs 1805 are coupled together, the negative DC terminal 224 of each of the ACMs 1805 are coupled together, and the negative interface terminal 229 of each of the ACMs 1805 are coupled together. Additionally, the positive interface terminals 227 of the ACMs 1805 for a particular phase of AC may be coupled together, or, in the example of one ACM 1805 per phase, each positive interface terminal 227 may be independent (i.e., not coupled to) any other positive interface terminal 227 of an active ACM 1805.

In some examples, the modular power converter 1800 and 1820 are an AC-to-DC rectifier, a DC-to-AC inverter, or a multi-mode power converter having an AC-to-DC rectifier mode and a DC-to-AC inverter mode.

In some examples of the modular power converter 1800 and 1820, each local controller is configured to drive the power switching element pair of the one or more ACMs 1805 using variable frequency critical soft switching at a frequency of at least 100 kHz, between 100 kHz and 1 MHz, or between 300 kHz and 1 MHz. In some examples, the LC filter of each of the one or more power converter modules is configured to filter an AC power signal received by the LC filter, the AC power signal having a current ripple of at least 200% of a local average current.

In some embodiments, a process of converting power with a modular power converter is provided. For example, the process may include receiving, by one or more power converter modules, input power. Each of the one or more power converter modules may include, as described above, a positive direct current (DC) terminal and a negative DC terminal; a capacitor coupled across the positive and negative DC terminals; a power switching element pair; an LC filter including a capacitor and an inductor; a local controller coupled to the power switching element pair; and a circuit board having the positive and negative DC terminals, the capacitor, the power switching element pair, the LC filter, and the local controller. The process may further include driving, by the local controller, the power switching element pair using variable frequency soft switching to convert the input power to output power. The process may further include communicating, by a central controller, with the local controller of each of the one or more power converter modules.

FIG. 19 illustrates a modular three-phase power converter 1900. The converter system 1900 is another example of the power system 100, and may incorporate elements of the systems 400, 700, and 1200 described above. Accordingly, the discussion above with respect to the system 100 of FIG. 1, and like aspects of the system 400 of FIG. 4, the system 700 of FIG. 7, and the system 1200 of FIG. 12 apply also to the system 1900 of FIG. 19, and like numbers are used for like components.

The modular three-phase power converter 1900 includes three ACMs 1905, one for each phase of the three-phase power converter 1900. Each ACM 1905 is generally similar to the ACMs 1805 of FIGS. 18A and 18B, but for the inclusion of m parallel-connected converter blocks 262 on each ACM 1905. For example, three converter blocks 262 of the ACM 1905 for phase C are labeled in FIG. 19, although additional converter blocks 262 may be present for phase C. Three converter blocks 262 are illustrated in FIG. 19 for phases A and B as well, but not labeled, to simplify the illustration. Each ACM 1905, as illustrated, includes shared DC terminals and interface terminals for the m converter blocks 262 making up the particular ACM 1905. Additionally, each converter block 262 of each ACM 1905 may have associated therewith a local controller on the same PCB as the converter block 262. Accordingly, the converter 1900 may include 3×m local controllers for a one-to-one relationship with the 3×m converter blocks 262. In other examples, a local controller may control multiple of the converter blocks 262. The local controller may be implemented as one of the local controllers described herein, such as the local controller 160, 760, or 1260. In FIG. 19, the 3×m local controllers are implemented as local MPC controllers 7601-7603m.

Although the ACMs 1905 of FIG. 19 are described as each having m converter blocks 262 and corresponding local MPC controllers, in some examples, the ACMs 1905 are ACM assemblies that comprise m ACMs 1805. In other words, each phase of the converter 1900 may include a plurality of ACMs 1805 connected together to form the ACM 1905. Further still, in some embodiments, the power converter 1900 is constructed without the modular ACMs 1805 or ACMs 1905 (e.g., the circuits may not be modularized and, rather, may be on multiple circuit boards, custom boards, etc.).

FIG. 20 illustrates a control diagram for a single-phase converter 2000 to be connect to one phase of the grid, which is another example of the power system 100, and may be similar to the three-phase converter 1900 except for the lack of a third (C) phase and corresponding components (e.g., ACM 1905 for the C phase). The single-phase converter 200 is composed of two-phase legs ΦA and ΦB and the two legs are connected to the two terminals of the single-phase grid. Accordingly, the control diagram is similarly applicable to the three-phase converter 1900, except that, in that three-phase example, an additional reference voltage (vc,c*) would be provided to the local MPC control layer 2005 and the local MPC control layer 2005 would have an ACM 1905 for a third (C) phase.

In FIG. 20, the local MPC control layer 2005 includes ACMs 1905 for phase A and phase B. The ACM 1905 for phase A includes x local MPC controllers 760a1-760aₓ, with each local MPC controller 760a corresponding to a pair of gate drivers 402 and an instance of the converter block 262 (e.g., including a pair of FETs and LC filter). Similarly, the ACM 1905 for phase B includes x local MPC controllers 760b₁-760bₓ, with each local MPC controller 760b corresponding to a pair of gate drivers 402 and an instance of the converter block 262 (e.g., including a pair of FETs and LC filter). In some examples, the ACMs 1905 of the power converter 2000 of FIG. 20 may use the local MPC-VFCSS controllers 1260 of FIG. 12, rather than the local MPC controllers 760, and, therefore, also incorporate variable frequency critical soft switching and/or a state estimator 900.

The modular, multiphase MPC power converters of FIGS. 19 and 20 implement converters with parallel-stacked power modules in each phase to increase the current and power rating for each phase of the converters. Each of the stacked power modules is controlled with a local MPC controller (e.g., local MPC controller 760 or local MPC-VCSS controller 1260) by following the control reference targets (e.g., the reference voltages (v_{cf,abc}) for each respective phase from the central controller 150. Each local MPC controller in the converters 1900 and 2000 of FIGS. 19-20 function in a similar manner as the local MPC controllers 760 and local MPC-VCSS controllers 1260 described with respect to FIGS. 7 and 12, respectively, to control the converter block 262 corresponding to the particular local MPC controller.

Accordingly, the ACMs 1805 and 1905 and cascaded MPC control described herein provide for a modular power converter system whereby the ACMs 1805 and/or 1905 may be used as modular building blocks to design a modular power converter that meets the specifications desired in terms of number of phases, current rating, power rating, and the like.

Although the various converter circuits provide herein has mainly been described in the context of a power switching element pair including an upper switch and a lower switch, in some examples, one or more of these converters includes power switching elements arranged in a multi-level switch topology (e.g., a three-level or five-level switch topology), such that the power switching element pair of each power converter module may include more than one high side switching element and more than one low side switching element.

In addition to the functionality and operation of the various power converters discussed above, below are examples of operational processes for the disclosed power converters.

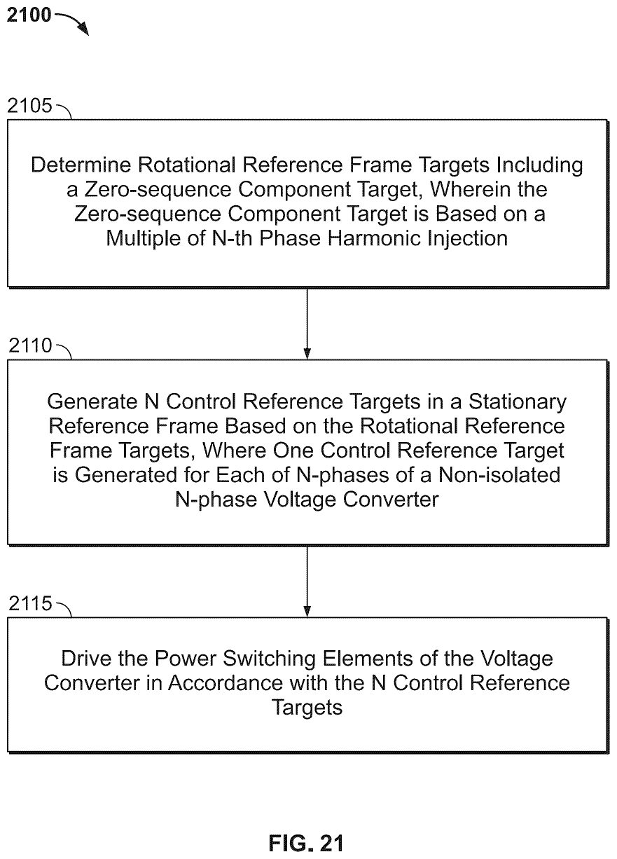

In FIG. 21, a process 2100 for converting voltage using harmonic injection is provided. The process 2100 is described as being carried out by the power converter system 100 implemented as the power converter system 400 of FIG. 4. However, in some embodiments, the process 2100 may be implemented by another power converter system or by the power converter system 100 implementing another power converter system (e.g., the converter system 700, 1200, 1900, 2000, or another system provided herein). Additionally, although the blocks of the process 2100 are illustrated in a particular order, in some embodiments, one or more of the blocks may be executed partially or entirely in parallel, may be executed in a different order than illustrated in FIG. 21, or may be bypassed.

In block 2105, the control system 105 determines rotational reference frame targets including a zero-sequence component target, wherein the zero-sequence component target is based on a multiple of N-th phase harmonic injection. For example, with reference to FIG. 4, the central controller 150 may determine rotational reference frame targets v_{d}*, v_{q}*, and v₀*, as previously described. The zero-sequence component target is generated by the harmonic injector 405, as previously described. For example, the harmonic injector 405 which may calculate the zero-sequence component target based on summing two components (i) the DC offset (e.g., Vdc/2) and (ii) a multiple of N-th phase harmonic injection (e.g., a 3rd harmonic).

In block 2110, the control system 105 generates N control reference targets in a stationary reference frame based on the rotational reference frame targets (where N≥1, where one control reference target is generated for each of N-phases of a non-isolated N-phase power converter. For example, with reference to FIG. 4, the central controller 150 translates, via translator 410, the rotational reference frame targets to control reference targets in the stationary reference frame. In particular, the translator 410 generates control reference targets v_{c,a}*, v_{c,b}*, and v_{c,c}*.

In block 2115, the control system 105 drives the power switching elements of the power converter in accordance with the N control reference targets. For example, with reference to FIG. 4, the local controllers 160a-c drive the power switching elements of the converter 304 (see also, e.g., FIG. 3) based on the control reference targets v_{c,a}*, v_{c,b}*, and v_{c,c}* received from the central controller 150. The local controllers 160a-c may drive the power switching elements using various techniques, as provided herein, including, for example, MPC-based control, PID control, PI control. The local controllers 160a-c may further include variable frequency critical soft switching (see, e.g., FIGS. 11-16) and/or may be based on state estimation (see, e.g., state estimator 900 of FIG. 9).

A previously noted, although the process 2100 is described with respect to the converter 400 of FIG. 4, the process 2100 may similarly be executed by the converter 700, 1200, 1900, and/or 2000. In such cases, the central controller 150 (present in each of these converters) may function similarly as provided above to execute blocks 2105 and 2110, and the local controller of each respective converter system (e.g., local MPC controllers 760 or local MPC-VCSS controller 1260), may execute block 2115 to drive their associated power switching elements in accordance with the N control reference targets as described herein (e.g., in the discussions of these local controllers 760 and local MPC-VCSS controllers 1260).

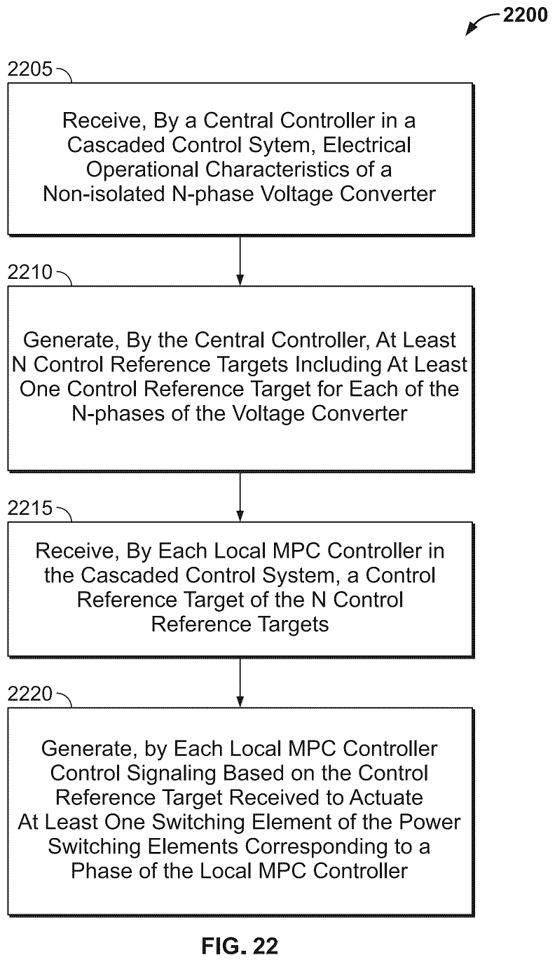

In FIG. 22, a process 2200 for converting voltage using a cascaded control system is provided. The process 2200 is described as being carried out by the power converter system 100 implemented as the power converter system 700 of FIG. 7. However, in some embodiments, the process 2200 may be implemented by another power converter system or by the power converter system 100 implementing another power converter system (e.g., the converter system 400, 1200, 1900, 2000, or another system provided herein). Additionally, although the blocks of the process 2200 are illustrated in a particular order, in some embodiments, one or more of the blocks may be executed partially or entirely in parallel, may be executed in a different order than illustrated in FIG. 22, or may be bypassed.

In block 2205, a central controller receives electrical operational characteristics of a non-isolated N-phase power converter (for N≥1). For example, with reference to FIG. 7, the central controller 150 receives the electrical operational characteristics v_{g,abc}, i_{g,abc}, and i_{L,abc}. In some examples, the central controller 150 receives fewer, additional, and/or different electrical operational characteristics of the power converter. The central controller 150 may receive the electrical operational characteristics from one or more local MPC controllers 760a-c and/or the sensors 140. As described with respect to FIG. 7, the central controller 150 and local MPC controllers 760 form a cascaded control system.

In block 2210, the central controller generates at least N control reference targets including at least one control reference target for each of the N-phases of the power converter. For example, with reference to FIG. 7, the central controller 150 translates, via translator 410, rotational reference frame targets (e.g., v_{d}*, v_{q}*, and v₀*), to control reference targets in the stationary reference frame. In particular, the translator 410 generates control reference targets v_{c,a}*, v_{c,b}*, and v_{c,c}*, which represent a target voltage across a lower capacitor 255 (see, e.g., FIGS. 2 and 3) for each phase of the converter.

In block 2215, each of the local MPC controllers 760a-c receives a control reference target of the N control reference targets. For example, the local MPC controller 760a receives control reference target v_{c,a}*, the local MPC controller 760b receives control reference target v_{c,b}*, and the local MPC controller 760c receives control reference target v_{c,c}*.

In block 2220, each of the local MPC controllers generates, using model predictive control (MPC), control signaling based on the control reference target received to actuate at least one switching element. For example, with reference to FIG. 7, the local MPC controllers 760a-c drive the power switching elements of the converter 304 (see also, e.g., FIG. 3) based on the control reference targets v_{c,a}*, v_{c,b}*, and v_{c,c}* received from the central controller 150. The local MPC controllers 760a-c use MPC to generate the control signaling, as described in further detail above with respect to the MPC controllers 760a-c and FIG. 7. In some examples, the local MPC controllers 760a-c may further include variable frequency critical soft switching (see, e.g., FIGS. 11-16) and/or may be based on state estimation (see, e.g., state estimator 900 of FIG. 9).

The control signaling may be a PWM control signal (or signals) provided to one (or both) of the power switching elements 235, 240 (e.g., to the gate terminal of the switching elements), a reference duty cycle (d*) indicating the duty cycle for the PWM control signals, and/or a reference switching frequency f_{SW}* indicating the switching frequency for the PWM control signals (e.g., in the case of VFCSS).

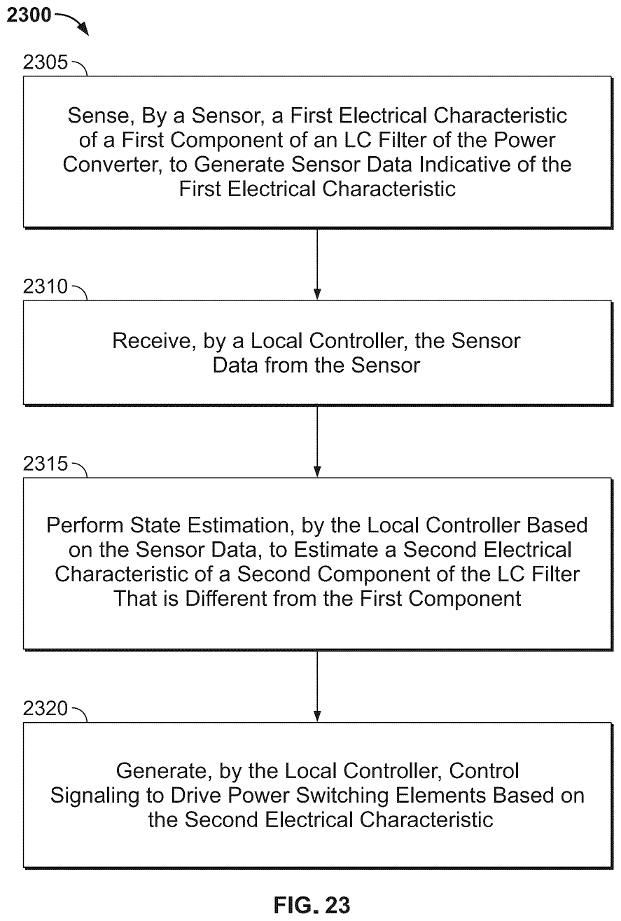

In FIG. 23, a process 2300 for converting power using state estimation is provided. The process 2300 is described as being carried out by the power converter system 100 implemented as the power converter system 700 of FIG. 7. However, in some embodiments, the process 2300 may be implemented by another power converter system or by the power converter system 100 implementing another power converter system (e.g., the converter system 400, 1200, 1900, 2000, or another system provided herein). Additionally, although the blocks of the process 2300 are illustrated in a particular order, in some embodiments, one or more of the blocks may be executed partially or entirely in parallel, may be executed in a different order than illustrated in FIG. 23, or may be bypassed.

In block 2305, a sensor (e.g., a sensor of the sensors 140 or the sensors 140 collectively) senses a first electrical characteristic of a first component of an LC filter (e.g., LC filter 308) of the power converter system 700 to generate sensor data indicative of the first electrical characteristic. The first component of the LC filter may be a switch-side inductor, a capacitor, or an output-side inductor. For example, with reference to FIG. 3, the LC filter 308 (which is also present in the power converter system 400 of FIG. 7) includes a switch side inductor 250, a lower capacitor 255, and an output-side inductor (grid inductor) 312.

In block 2310, a local controller (e.g., of an MPC controller 760a, 760b, or 760c of FIG. 7) receives the sensor data from the sensor. The local controller may include a state estimator, such as the state estimator 900 (see FIG. 9).

In block 2315, the local controller (e.g., the local MPC controller 760a, 760b, or 760c) performs state estimation based on the sensor data to estimate a second electrical characteristic of a second component of the LC filter that is different from the first component. For example, with reference to FIGS. 3 and 7, the LC filter 308 includes three LC filters, one for each phase A, B, and C. Accordingly, in the context of this block 2315, the LC filter may refer to such an LC filter for one phase (e.g., phase A in FIG. 3) and associated with a pair of power switching elements (e.g., upper switch (M1) 235 and lower switch (M2) 240 in FIG. 3) and one local controller (e.g., local MPC controller 760a of FIG. 7). In some examples, in block 2315 (and with reference to FIG. 3), when the first component is the lower capacitor 255 of phase A, the second component may be the switch-side inductor 250 of phase A or the output side inductor 312 of phase A. Alternatively, when the first component is the output side inductor 312 of phase A, the second component may be the switch-side inductor 250 of phase A or the lower capacitor 255 of phase A.

To perform the state estimation, the state estimator of the local controller 160 may solve state-space equations to implement a Luenberger observer, as described above with respect to the state estimator 900 of FIG. 9. Other estimation techniques may be used instead of the Luenberger observer such as, but not limited to, an optimization-based estimator, a sliding mode estimator, and a disturbance estimator

In block 2320, the local controller generates control signaling to drive the power switching elements associated with the LC filter based on the (estimated) second electrical characteristic. The power switching elements 235, 240 associated with the LC filter may be the power switching elements 235, 240 coupled to the LC filter via a midpoint node 242 that connects the power switching elements 235, 240, as shown in FIG. 3. For example, in the context of the converter system 700 of FIG. 7, the local MPC controllers 760a, 760b, or 760c generate the control signaling, as described in further detail above with respect to the MPC controllers 760a-c and FIG. 7. In some examples, the local MPC controllers 760a-c may further include variable frequency critical soft switching (see, e.g., FIGS. 11-16) and/or may be based on state estimation (see, e.g., state estimator 900 of FIG. 9). In some examples, the local controller of block 2320 uses a regulation technique other than MPC, such as a PID control or PI control technique, to generate the control signaling based on the second electrical characteristic.

The control signaling may be a PWM control signal provided to the power switching elements 235, 240 (e.g., to the gate terminal of the switching elements), a reference duty cycle (d*) indicating the duty cycle for the PWM control signals, and/or a reference switching frequency f_{SW}* indicating the switching frequency for the PWM control signals (e.g., in the case of VFCSS).

Although the power converter 700 illustrated in FIG. 7 is a three-phase converter with a cascaded control system, in some examples, the process 2300 is executed with a single-phase converter with cascaded control system (e.g., with one central controller 150 and one local MPC controller 760), or the process 2300 is executed with a single-phase converter without cascaded control system (e.g., with one local MPC controller 760 and no central controller 150). Additionally, as noted, in some examples, the power converter system 400 (including one of the local controller 160a, 160b, or 160c) executes the process 2300, the power converter system 1200 (including the local MPC-VCSS controller 1260a, 1260b, or 1260c) executes the process 2300, the power converter 1900 (with one of the local MPC controllers 760₁₋₃m) executes the process 2300, and/or the power converter 2000 (with one of the local MPC controllers 760) executes the process 2300. Further, in some examples of power converters having multiple phases with one or multiple controllers per phase (see, e.g., the power converter systems 400, 700, 1200, 1900, and 2000), each local controller includes a state estimator to estimate one or more electrical characteristics for a component of an associated LC filter based on sensor data for another component of the LC filter.

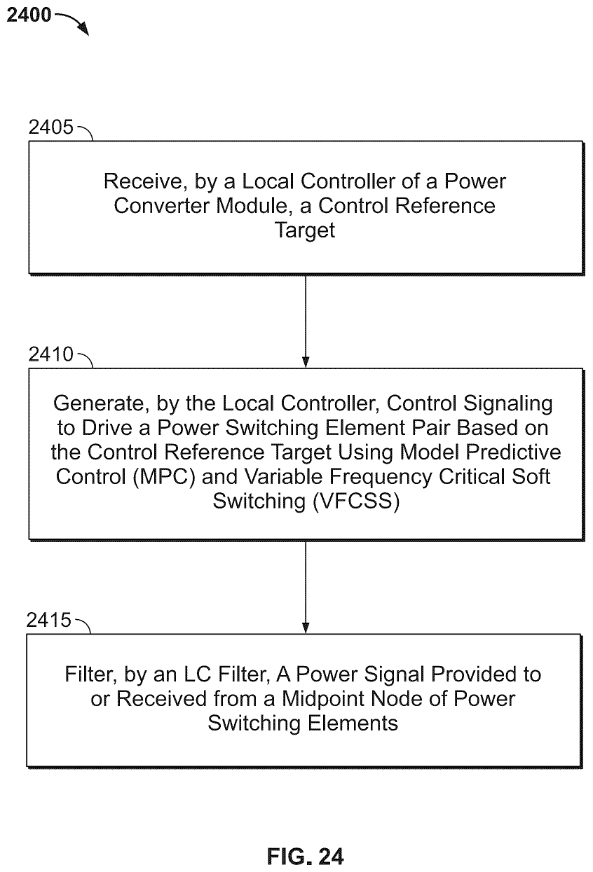

In FIG. 24, a process 2400 for converting power using MPC-based control and variable frequency critical soft switching is provided. The process 2400 is described as being carried out by the power converter system 100 implemented as the power converter system 1200 of FIG. 12. However, in some embodiments, the process 2400 may be implemented by another power converter system or by the power converter system 100 implementing another power converter system (e.g., the converter system 400, 700, 1900, or 2000, or another system provided herein). Additionally, although the blocks of the process 2400 are illustrated in a particular order, in some embodiments, one or more of the blocks may be executed partially or entirely in parallel, may be executed in a different order than illustrated in FIG. 24, or may be bypassed.

In block 2405, a local controller of a power converter system receives a control reference target. For example, the local MPC-VCSS controller 1260a may receive a control reference target v_{c,a}* from the central controller 150, as described above with respect to FIG. 12. As illustrated in FIG. 12, the local MPC-VCSS controller 1260a is coupled to a power switching element pair of the converter 304 including a high side power switching element coupled to a positive DC terminal of the power converter system and a low side power switching element coupled to the negative DC terminal of the power converter system, wherein the high side power switching element and the low side power switching element are coupled together at a midpoint node. Further, an LC filter of the LC filter 308 is coupled to the midpoint node, the positive DC terminal, and the negative DC terminal. Additional details of these connections related to the converter 304 and LC filter 308 are illustrated in FIG. 3.

In block 2410, the local controller generates control signaling to drive the power switching element pair based on the control reference target using model predictive control (MPC) and variable frequency soft switching. The control signaling may be a PWM control signal (or signals) provided to one (or both) of the power switching elements of the power switching element pair (e.g., to the gate terminal of the switching elements), a reference duty cycle (d*) indicating the duty cycle for the PWM control signals, and/or a reference switching frequency (f_{SW}*) indicating the switching frequency for the PWM control signals (e.g., in the case of VFCSS).

For example, with reference to FIG. 12, the local MPC-VCSS controller 1260a generates control signaling to drive the power switching element pair of the converter 304. For example, the MPC controller 760a of the local MPC-VCSS controller 1260a generates a reference duty cycle (d*), and the frequency controller 1110a generates a reference switching frequency (f_{SW}*), each of which is provided to the gate driver 1115a. The gate driver 1115a, in turn, drives the associated power switching element pair of the converter 304 with respective PWM control signals with a switching frequency and duty cycle (or approximately 1-duty cycle) indicated by the received reference values. Further details regarding an example of generation of the reference duty cycle (d) based on MPC and the reference switching frequency (f_{SW}*) based on VFCSS are provided above with respect to the MPC controller 760a and the frequency controller 1110a.

In block 2415, the LC filter filters a power signal provided to or received from the midpoint node. For example, the LC filter (of the LC filter 308) that is associated with the power switching element pair for phase A and associated with the local MPC-VCSS controller 1260a performs filtering of a power signal provided to the midpoint node by the power switching element pair (e.g., in the case of the converter functioning DC/AC inverter) and/or filtering of a power signal received by the power switching element pair from the midpoint node (e.g., in the case of the converter functioning as an AC/DC rectifier).

Although the power converter 1200 illustrated in FIG. 12 is a three-phase converter with a cascaded control system, in some examples, the process 2400 is executed with a single-phase converter with cascaded control system (e.g., with one central controller 150 and one local MPC-VCSS controller 1260), or the process 2400 is executed with a single-phase converter without cascaded control system (e.g., with one local MPC-VCSS controller 1260 and no central controller 150), Additionally, as noted, in some examples, the power converter system 400 (including one of the local controller 160a, 160b, or 160c) executes the process 2300, the power converter system 700 (including the local controller 760a, 760b, or 760c) executes the process 2400, the power converter 1900 (with one of the local MPC controllers 760₁₋₃m) executes the process 2400, and/or the power converter 2000 (with one of the local MPC controllers 760) executes the process 2400. Further, in some examples of power converters having multiple phases with one or multiple local controllers per phase (see, e.g., the power converter systems 400, 700, 1200, 1900, and 2000), each local controller (in combination with its associated LC filter) executes the process 2400.

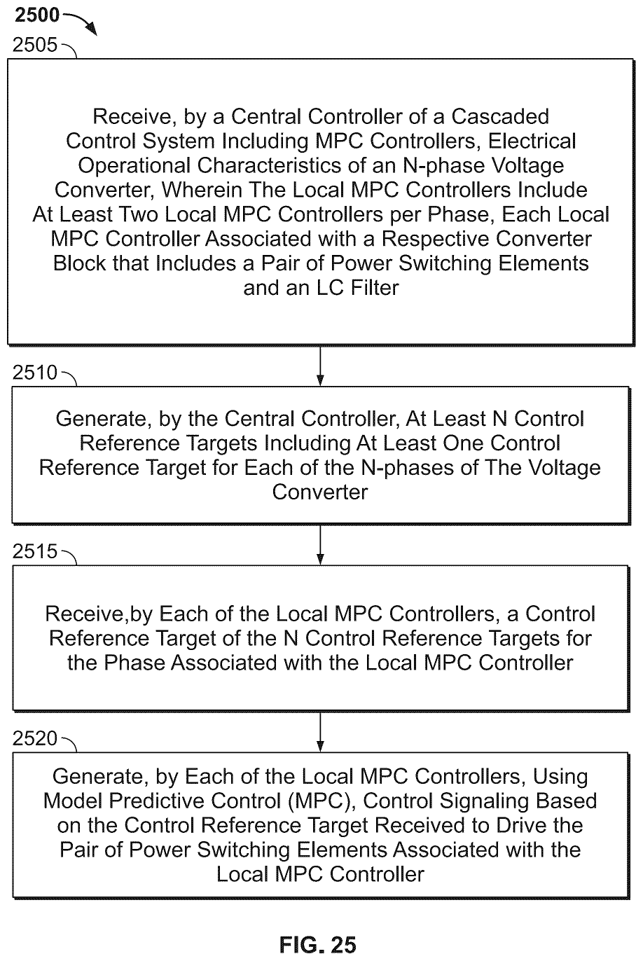

In FIG. 25, a process 2500 for converting power with a modular power converter having multiple parallel converters per phase is provided. The process 2500 is described as being carried out by the power converter system 100 implemented as the power converter system 1900 of FIG. 4. However, in some embodiments, the process 2500 may be implemented by another power converter system or by the power converter system 100 implementing another power converter system (e.g., the converter system 700, 1200, 1900, 2000, or another system provided herein). Additionally, although the blocks of the process 2500 are illustrated in a particular order, in some embodiments, one or more of the blocks may be executed partially or entirely in parallel, may be executed in a different order than illustrated in FIG. 25, or may be bypassed.

In block 2505, a central controller receives electrical operational characteristics of a power converter, the power converter including a DC voltage section, and an N-phase AC voltage section. The central controller is part of a cascaded control system including a plurality of local model predictive control (MPC) controllers cascaded with the central controller. For example, with reference to FIG. 19, the central controller 150 receives electrical operational characteristics for the power converter. The electrical operational characteristics may be received from each of the local MPC controllers 760₁₋₃m, in a similar manner as the electrical operational characteristics are received by the central controller 150 in the converter systems 400, 700, and 1200 described above. For example, the operational characteristics may include a grid voltage for each phase of the converter (v_{g,abc}), a grid current for each phase of the inverter (i_{g,abc}), and a filter switch side inductor current for each phase of the inverter (i_{L,abc}).

Additionally, in the power converter for the process 2500 (e.g., the converter 1900), the plurality of local MPC controllers 760₁-760₃m include at least two local MPC controllers per phase of the N-phase power converter. Additionally, each local MPC controller is associated with a respective converter block that includes a pair of power switching elements and an LC filter for the phase corresponding to the local MPC controller. For example, in the converter system 1900 of FIG. 19, each ACM module 1905 associated with a particular phase (e.g., phase A, B, or C) includes three converter blocks 262 shown (with potentially more shown with ellipses).

In block 2510, the central controller generates at least N control reference targets including at least one control reference target for each of the N-phases of the power converter. In some examples, the central controller 150 of FIG. 19 is shown in further detail in FIG. 7. Accordingly, with reference to FIG. 7, the central controller 150 translates, via translator 410, rotational reference frame targets (e.g., v_{d}*, v_{q}*, and v₀+), to control reference targets in the stationary reference frame. In particular, the translator 410 generates control reference targets v_{c,a}*, v_{c,b}*, and v_{c,c}*, one for each of three phases.

In block 2515, each of the local MPC controllers receives a control reference target of the N control reference targets for the phase associated with the local MPC controller. For example, where a local MPC controller 760a, 760b, and 760c are each associated with a respective converter block of phase A, these local MPC controllers 760a, 760b, and 760c may each receive the control reference target for phase A (e.g., v_{c,a}+) from the central controller 150.

In block 2520, each of the local MPC controllers, using MPC, generates control signaling based on the control reference target received to drive the pair of power switching elements associated with the local MPC controller. For example, each of the local MPC controllers 760₁₋₃m drive an associated pair of the power switching elements of the converter based on the control reference targets received by the particular local MPC controller 760₁₋₃m (e.g., one of v_{c,a}*, v_{c,b}*, and v_{c,c}*). The local MPC controllers 760₁₋₃m use MPC to generate the control signaling, as described in further detail above with respect to the MPC controllers 760a-c and FIG. 7. In some examples, the local MPC controllers 760a-c may further include variable frequency critical soft switching (see, e.g., FIGS. 11-16) and/or may use state estimation (see, e.g., state estimator 900 of FIG. 9), similar to the local MPC-VFCSS controllers 1260.

The control signaling may be a PWM control signal (or signals) provided to one (or both) of the power switching elements 235, 240 (e.g., to the gate terminal of the switching elements), a reference duty cycle (d) indicating the duty cycle for the PWM control signals, and/or a reference switching frequency f_{SW}* indicating the switching frequency for the PWM control signals (e.g., in the case of VFCSS).

Performing the various techniques and operations described herein may be facilitated by an electronic controller (e.g., a processor-based computing device), such as a central controller 150, local controller 160, local MPC controller 760, local MPC VFCSS controller 1260, or the like as described herein. Such an electronic controller may include a processor-based device such as a computing device, and so forth, that may include a central processor unit (CPU) or a processing core. In addition to the CPU or processing core, the system includes main memory, cache memory, and bus interface circuits. The electronic controller may include a memory storage device, such as a hard drive (solid state hard drive, or other types of hard drive), or flash drive associated with the computer system. The electronic controller may further include a keyboard, or keypad, or some other user input interface, and a monitor, e.g., an LCD (liquid crystal display) monitor, that may be placed where a user can access them.

The electronic controller is configured to facilitate, for example, the implementation of a power converter (e.g., by controlling the switching devices of, for example, a non-isolated three-phase DC/AC power converter system). The storage device may thus include a computer program product that when executed on the electronic controller (which, as noted, may be a processor-based device) causes the processor-based device to perform operations to facilitate the implementation of procedures and operations described herein. The electronic controller may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the electronic controller. Other modules that may be included with the electronic controller may include a user interface to provide or receive input and output data. The electronic controller may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

### FURTHER EXAMPLES

Example 1: A method, apparatus, and/or non-transitory computer-readable medium storing processor-executable instructions for a power converter system comprising: a non-isolated n-phase power converter, for N≥1, with a DC voltage section and an N-phase AC voltage section and the power converter includes power switching elements. A control system configured to control the power converter and is also configured to determine rotational reference frame targets. The rotational reference frame targets including a zero-sequence component target, where the zero-sequence component target is based on a multiple of N-th phase harmonic injection. The control system generates N control reference targets in a stationary reference frame, one for each of the n-phases of the n-phase power converter, based on the rotational reference frame targets and also generates control signals for the power switching elements based on the n control reference targets, and drive the power switching elements in accordance with the control signals.

Example 2: The method, apparatus, and/or non-transitory computer readable medium of Example 1, wherein the control system is a cascaded control system comprising: a central controller including a processing unit, the central controller configured to: determine the rotational reference frame targets, and generate the N control reference targets; and at least one local controller, each of the at least one local controller including a local processing unit, each of the at least one local controller configured to: receive a control reference target of the N control reference targets, and drive a portion of the power switching elements, associated with the local controller, in accordance with the control reference target.

Example 3: The method, apparatus, and/or non-transitory computer readable medium of Example 1 or 2, wherein to drive the portion of the power switching elements in accordance with the control reference target, each of the at least one local controller is configured to: implement model predictive control (MPC) to generate control signaling for the portion of the power switching elements.

Example 4: The method, apparatus, and/or non-transitory computer readable medium of any of Examples 1 to 3, wherein the central controller is further configured to: receive at least one electrical operational characteristic from each of the at least one local controller, the electrical operational characteristics in the stationary reference frame; convert the at least one electrical operational characteristic to the rotating reference frame; and determine a direct axis (D-axis) component and a quadrature axis (Q-axis) component of the rotational reference frame targets based on the at least one electrical operational characteristic in the rotating reference frame.

Example 5: The method, apparatus, and/or non-transitory computer readable medium of any of Examples 1 to 4, wherein the central controller is further configured to: determine a frequency of an alternating power signal of the AC section of the power converter based on a first characteristic of the at least one electrical operational characteristic in the rotating reference frame.

Example 6: The method, apparatus, and/or non-transitory computer readable medium of any of Examples 1 to 5, wherein to determine the direct axis (D-axis) component and the quadrature axis (Q-axis) component of the rotational reference frame targets based on the at least one electrical operational characteristic in the rotating reference frame, the central controller is configured to: convert a current signal from the AC section of the power converter to a direct axis (D-axis) current component and a quadrature axis (Q-axis) current component in the rotational reference frame, generate a D-axis voltage component, as the D-axis component of the rotational reference frame targets, based on a comparison of the D-axis current component to a desired D-axis current, and generate a Q-axis voltage component, as the Q-axis component of the rotational reference frame targets, based on a comparison of the Q-axis current component to a desired Q-axis current; and wherein, to generate the N control reference targets in the stationary reference frame based on the rotational reference frame targets, the central controller is further configured to: convert the D-axis voltage component, Q-axis voltage component, and the zero-sequence component target to the stationary reference frame.

Example 7: The method, apparatus, and/or non-transitory computer readable medium of any of Examples 1 to 6, wherein the zero-sequence component target includes a sum of a DC offset and the multiple of N-th phase harmonic injection.

Example 8: The method, apparatus, and/or non-transitory computer readable medium of Example 7, wherein at least one of the DC offset is half a DC bus voltage of the DC voltage section of the power converter, or N is 3 and the multiple of N-th phase harmonic injection is a third order of a fundamental frequency of the AC voltage section of the power converter.

Example 9: The method, apparatus, and/or non-transitory computer readable medium of any of Examples 7 to 8, wherein the multiple of N-th phase harmonic injection comprises: a sinusoidal signal derived based on an N-th order of a fundamental frequency of the AC voltage section of the power converter; or a triangular signal derived based on mean values of maximum and minimum values of the fundamental frequency of the AC voltage section of the power converter.

Example 10: The method, apparatus, and/or non-transitory computer readable medium of any of Examples 7 to 9, wherein the multiple of N-th phase harmonic injection is a feedback signal that is calculated from at least one selected from the group of: N previous control reference targets generated by the control system in a stationary reference frame based on previously received rotational reference frame targets, N voltage measurements provided by a respective voltage sensor for each phase of the N phases of the power converter, or N voltage measurements communicated by at least one local controller indicating a respective voltage for each phase of the N phases of the power converter.

Example 11: The method, apparatus, and/or non-transitory computer readable medium of any of Examples 1 to 10, wherein the power switching elements include, for each phase of the N phases of the power converter, a high-side element and a low-side element connected at a midpoint node, and wherein the midpoint node of each phase of the N phases of the power converter is coupled to a respective LC filter including an inductor coupled between the midpoint node and a filter node, and one or more of a first capacitor coupled between the filter node and a positive DC bus of the power converter or a second capacitor coupled between the filter node and a negative DC bus of the power converter.

Example 12: The method, apparatus, and/or non-transitory computer readable medium of any of Examples 1 to 11, wherein the power converter is one or more of an AC-to-DC rectifier and a DC-to-AC inverter.

Example 13: The method, apparatus, and/or non-transitory computer readable medium of any of Examples 1 to 12, wherein the AC section of the power converter is coupled to an AC power grid or an AC motor.

Example 14: The method, apparatus, and/or non-transitory computer readable medium of any of Examples 1 to 13, wherein an LC filter including a switch-side inductor and capacitor; and a sensor configured to sense a first electrical characteristic of a first component of the LC filter selected from the group of the switch-side inductor and the capacitor, and to generate sensor data indicative of the first electrical characteristic; and wherein each of the at least one local controller is further configured to: receive the sensor data from the sensor, perform state estimation, based on the sensor data, to estimate a second electrical characteristic of a second component of the LC filter that is different from the first component, and to drive the portion of the power switching elements further based on the second electrical characteristic.

Example 15: The method, apparatus, and/or non-transitory computer readable medium of any of Examples 1 to 14, wherein, to drive the portion of the power switching elements, each of the at least one local controller is further configured to: drive the portion of the power switching elements with variable-frequency critical soft switching control signals.

Example 16: The method, apparatus, and/or non-transitory computer readable medium of any of Examples 1 to 15, further comprising: N power converter modules, where N>1, each power converter module including: a positive direct current (DC) terminal and a negative DC terminal, a power switching element pair including a high side power switching element coupled to the positive DC terminal and a low side power switching element coupled to the negative DC terminal, wherein the high side power switching element and the low side power switching element are coupled together at a midpoint node, an LC filter including a capacitor and an inductor, the inductor coupled between the midpoint node and a capacitor, the capacitor coupled between the inductor and the negative DC terminal, a local controller of the at least one local controllers configured to drive the power switching element pair, wherein the power switching element pair is the portion of power switching elements associated with the local controller, and a circuit board having located thereon the positive and negative DC terminals, the power switching element pair, the LC filter, and the local controller; wherein the positive DC terminal of each of the N power converter modules are coupled together and the negative DC terminal of each of the one or more power converters are coupled together; and wherein the central controller is located on a separate circuit board than the circuit boards having the local controllers.

Example 17: A method, apparatus, and/or non-transitory computer-readable medium storing processor-executable instructions for converting voltage, comprising a first step of determining rotational reference frame targets where the rotational reference frame targets including a zero-sequence component target where the zero-sequence component target is based on a multiple of N-th phase harmonic injection. The method includes a second step of generating N control reference targets in a stationary reference frame based on the rotational reference frame targets where one control reference target is generated for each of N-phases of a non-isolated N-phase power converter, where N≥1. The power converter includes a dc voltage section, an N-phase AC voltage section, and power switching elements. The method includes a third step of driving the power switching elements of the power converter in accordance with the N control reference targets.

Example 18: The method, apparatus, and/or non-transitory computer readable medium of Example 17, further comprising, by a cascaded control system: determining, by a central controller, the rotational reference frame targets; generating, by the central controller, the N control reference targets; receiving, by each of at least one local controller, a control reference target of the N control reference targets; and driving, by each of the at least one local controller, a portion of the power switching elements in accordance with the control reference target.

Example 19: The method, apparatus, and/or non-transitory computer readable medium of Example 17 or 18, wherein driving, by each of the at least one local controller, the portion of the power switching elements in accordance with the control reference target, comprises: implementing, by each of the at least one local controller, model predictive control (MPC) to generate control signaling for the portion of the power switching elements.

Example 20: The method, apparatus, and/or non-transitory computer readable medium of any of Examples 17 to 19, further comprising one or more of: rectifying, by the power converter, AC power to DC power based on the driving of the power switching elements of the power converter in accordance with the N control reference targets, or inverting, by the power converter, DC power to AC power based on the driving of the power switching elements of the power converter in accordance with the N control reference targets.

Example 21: The method, apparatus, and/or non-transitory computer readable medium of any of Examples 17 to 20, further comprising one or more of: receiving AC power, by the AC section of the power converter, from an AC power grid, providing AC power, by the AC section of the power converter, to the AC power grid, or providing AC power, by the AC section of the power converter, to an AC motor.

Example 22: A method, apparatus, and/or non-transitory computer-readable medium storing processor-executable instructions for a power convertor system, comprising a non-isolated N-phase power converter, for N≥1, with a DC voltage section and an N-phase AC voltage section. The power converter includes, for each of the N-phases, an LC filter, power switching elements; and a cascaded control system to control the power converter. The cascaded control system may include: a central controller including a processing unit and the central controller configured to receive electrical operational characteristics of the power converter and generate at least n control reference targets including at least one control reference target for each of the N-phases of the power converter. At least one local model predictive control (MPC) controller, each of the at least one local MPC controllers corresponding to a phase of the N-phase power converter, including a local processing unit, and being configured to: receive a control reference target of the n control reference targets, and generate, using model predictive control (MPC), control signaling based on the control reference target to actuate at least one switching element of the power switching elements corresponding to the phase of the local MPC controller.

Example 23: The method, apparatus, and/or non-transitory computer readable medium of Example 22, wherein to generate control signaling using MPC, at each control period, each local MPC controller of the at least one local MPC controller is configured to: determine local electrical characteristics for a phase of the N phases that is associated with the local MPC controller; solve a cost function using the local electrical characteristics and the control reference target received by the local MPC controller to predict future steps of control signals to control the phase of the N phases towards the control reference target; and generate the control signaling based on a first step of the future steps of control signals.

Example 24: The method, apparatus, and/or non-transitory computer readable medium of any of Examples 22 to 23, wherein each local MPC controller is associated with a respective state estimator, wherein, for each local MPC controller, the respective state estimator is configured to estimate a first local electrical characteristic of the local electrical characteristics for the phase that is associated with the local controller, wherein the estimate is based on samplings of other local electrical characteristics of the local electrical characteristics for the phase that is associated with the local MPC controller; and wherein each local MPC controller, to determine the local electrical characteristics for the phase of the N phases that is associated with the local MPC controller, receives the first local electrical characteristic estimated by the state estimator associated with the local MPC controller.

Example 25: The method, apparatus, and/or non-transitory computer readable medium of any of Examples 22 to 24, wherein the at least one local MPC controller includes N local MPC controllers, and each local MPC controller corresponds to a different phase of the N-phases.

Example 26: The method, apparatus, and/or non-transitory computer readable medium of any of Examples 22 to 25, wherein the central controller is configured to: determine rotational reference frame targets, the rotational reference frame targets including a zero-sequence component target, wherein the zero-sequence component target is based on a multiple of N-th phase harmonic injection, wherein the at least N control reference targets are generated based on the rotational reference frame targets.

Example 27: The method, apparatus, and/or non-transitory computer medium of any of Examples 22 to 26, wherein the central controller is further configured to: determine a direct axis (D-axis) component and a quadrature axis (Q-axis) component of the rotational reference frame targets based on the electrical operational characteristics in the rotating reference frame.

Example 28: The method, apparatus, and/or non-transitory computer readable medium of any of Examples 22 to 27, wherein the central controller is further configured to: determine a frequency of an alternating power signal of the AC voltage section of the power converter based on a first characteristic of the electrical operational characteristics in the rotating reference frame.

Example 29: The method, apparatus, and/or non-transitory computer readable medium of any of Examples 22 to 28, wherein, to determine the direct axis (D-axis) component and the quadrature axis (Q-axis) component of the rotational reference frame targets based on the electrical operational characteristics in the rotating reference frame, the central controller is configured to: convert a current signal from the AC voltage section of the power converter to a direct axis (D-axis) current component and a quadrature axis (Q-axis) current component in the rotational reference frame, generate a D-axis voltage component, as the D-axis component of the rotational reference frame targets, based on a comparison of the D-axis current component to a desired D-axis current, and generate a Q-axis voltage component, as the Q-axis component of the rotational reference frame targets, based on a comparison of the Q-axis current component to a desired Q-axis current; and herein, to generate the N control reference targets in the stationary reference frame based on the rotational reference frame targets, the central controller is further configured to: convert the D-axis voltage component, Q-axis voltage component, and the zero-sequence component target to the stationary reference frame.

Example 30: The method, apparatus, and/or non-transitory computer readable medium of any of Examples 22 to 29, wherein the power switching elements include, for each phase of the N phases of the power converter, a high-side element and a low-side element connected at a node, and wherein the node of each phase of the N phases of the power converter is coupled to a respective LC filter including an inductor coupled between the node and a filter node, and one or more of a first capacitor coupled between the filter node and a positive DC bus of the power converter or a second capacitor coupled between the filter node and a negative DC bus of the power converter.

Example 31: The method, apparatus, and/or non-transitory computer readable medium of any of Examples 22 to 30, wherein the power converter is one or more of an AC-to-DC rectifier and a DC-to-AC inverter.

Example 32: The method, apparatus, and/or non-transitory computer readable medium of any of Examples 22 to 31, wherein the AC voltage section of the power converter is coupled to an AC power grid or an AC motor.

Example 33: The method, apparatus, and/or non-transitory computer readable medium of any of Examples 22 to 32, wherein, to generate the control signaling to actuate the at least one power switching element, each of the at least one local MPC controller is further configured to: generate the control signaling with variable-frequency critical soft switching control signals.

Example 34: The method, apparatus, and/or non-transitory computer readable medium of any of Examples 22 to 33, further comprising: N power converter modules, where N>1, each power converter module including: a positive direct current (DC) terminal and a negative DC terminal, a power switching element pair of the power switching elements, the power switching element pair including a high side power switching element coupled to the positive DC terminal and a low side power switching element coupled to the negative DC terminal, wherein the high side power switching element and the low side power switching element are coupled together at a midpoint node, an LC filter including a capacitor and an inductor, the inductor coupled between the midpoint node and a capacitor, the capacitor coupled between the inductor and the negative DC terminal, a local MPC controller of the at least one local MPC controllers configured to drive the power switching element pair, wherein the power switching element pair is the portion of power switching elements associated with the local MPC controller, and a circuit board having located thereon the positive and negative DC terminals, the power switching element pair, the LC filter, and the local MPC controller; wherein the positive DC terminal of each of the N power converter modules are coupled together and the negative DC terminal of each of the one or more power converters are coupled together; and wherein the central controller is located on a separate circuit board than the circuit boards having the local controllers.

Example 35: A method, apparatus, and/or non-transitory computer readable medium comprising: receiving, by a central controller of a cascaded control system including at least one local model predictive control (MPC) controller cascaded with the central controller, electrical operational characteristics of the power converter, the electrical operational characteristics being characteristics of a non-isolated N-phase power converter, for N≥1, with a DC voltage section and an N-phase AC voltage section, the power converter including power switching elements; generating, by the central controller, at least N control reference targets including at least one control reference target for each of the N-phases of the power converter; receiving, by each of the at least one local MPC controllers, a control reference target of the N control reference targets, and generating, by each of the at least one local MPC controller using model predictive control (MPC), control signaling based on the control reference target received to actuate at least one switching element of the power switching elements corresponding to a phase of the local MPC controller.

Example 36: The method, apparatus, and/or non-transitory computer readable medium of Example 35, further comprising one or more of: rectifying, by the power converter, AC power to DC power based on the control signaling, or inverting, by the power converter, DC power to AC power based on the control signaling.

Example 37: The method, apparatus, and/or non-transitory computer readable medium of any of Examples 35 to 36, further comprising one or more of: receiving AC power, by the AC section of the power converter, from an AC power grid, providing AC power, by the AC section of the power converter, to the AC power grid, or providing AC power, by the AC section of the power converter, to an AC motor.

Example 38: A method, apparatus, and/or non-transitory computer readable medium for a non-isolated N-phase power converter system, for N≥1, comprising: a DC voltage section; an N-phase AC voltage section; and for each of the N-phases: an LC filter including switch-side inductor, capacitor, or output-side inductor; power switching elements; a sensor configured to sense a first electrical characteristic of a first component of the LC filter selected from the group of the switch-side inductor, capacitor, or output-side inductor, and to generate sensor data indicative of the first electrical characteristic; and a controller power converter including an electronic processor, the controller configured to: receive the sensor data from the sensor, perform state estimation, based on the sensor data, to estimate a second electrical characteristic of a second component of the LC filter that is different from the first component, and generate control signaling, based on the second electrical characteristic, to drive the power switching elements.

Example 39: The method, apparatus, and/or non-transitory computer readable medium of Example 38, wherein, for each of the N-phases: the sensor is further configured to sense a third electrical characteristic of a third component of the LC filter that is different from the first component and the second component, the sensor data generated by the sensor is further indicative of the third electrical characteristic, and the state estimation to estimate the second electrical characteristic is based on the sensor data that is indicative of both the first electrical characteristic and the third electrical characteristic.

Example 40: The method, apparatus, and/or non-transitory computer readable medium of any of Examples 38 to 39, wherein, for each of the N-phases: wherein the first electrical characteristic is voltage of the capacitor, wherein the second electrical characteristic is current of the switch-side inductor, and wherein the third electrical characteristic is current of the output-side inductor.

Example 41: The method, apparatus, and/or non-transitory computer readable medium of any of Examples 38 to 40, wherein, for each of the N-phases, the controller includes a model predictive control (MPC) controller that is configured to generate a duty cycle of the control signaling, based on the second electrical characteristic, using model predictive control (MPC).

Example 42: The method, apparatus, and/or non-transitory computer readable medium of any of Examples 38 to 41, wherein, for each of the N-phases, the local controller is further configured to generate a switching frequency of the control signaling, based on the second electrical characteristic, to drive the power switching elements with variable-frequency critical soft switching control signals.

Example 43: The method, apparatus, and/or non-transitory computer readable medium of any of Examples 38 to 42, further comprising: a cascaded control system, the cascaded control system comprising: a central controller including a central electronic processor, the central controller configured to: generate at least N control reference targets including at least one control reference target for each phase of the N-phases; and the local controller for each phase of the N-phases, wherein the local controller for each phase of the N-phases is further configured to generate the control signaling based on a control reference target of the N control reference targets received from the central controller.

Example 44: The method, apparatus, and/or non-transitory computer readable medium of any of Examples 38 to 43, wherein the power converter system is a multiphase power converter system where N=3.

Example 45: A method, apparatus, and/or non-transitory computer readable medium with a non-isolated N-phase power converter, for N≥, comprising: sensing, by a sensor, a first electrical characteristic of a first component of an LC filter of the power converter, to generate sensor data indicative of the first electrical characteristic, the first component of the LC filter selected from the group of a switch-side inductor, a capacitor, or an output-side inductor; receiving, by a local controller, the sensor data from the sensor; performing state estimation, by the local controller based on the sensor data, to estimate a second electrical characteristic of a second component of the LC filter that is different from the first component; and generating, by the local controller, control signaling to drive power switching elements associated with the LC filter based on the second electrical characteristic.

Example 46: The method, apparatus, and/or non-transitory computer readable medium of Example 45 further comprising: sensing, by the sensor, a third electrical characteristic of a third component of the LC filter that is different from the first component and the second component, wherein the sensor data generated by the sensor is further indicative of the third electrical characteristic, and wherein the state estimation to estimate the second electrical characteristic is based on the sensor data that is indicative of both the first electrical characteristic and the third electrical characteristic.

Example 47: The method, apparatus, and/or non-transitory computer readable medium of any of Examples 45 to 46, wherein the sensor includes a voltage sensor and a current sensor, wherein sensing the first electrical characteristic includes sensing voltage of the capacitor, wherein the second electrical characteristic is current of the switch-side inductor, and wherein sensing the third electrical characteristic includes sensing current of the output-side inductor.

Example 48: The method, apparatus, and/or non-transitory computer readable medium of any of Examples 45 to 47 wherein generating the control signaling includes: generating a duty cycle, using model predictive control, based on the second electrical characteristic.

Example 49: The method, apparatus, and/or non-transitory computer readable medium of any of Examples 45 to 48, wherein generating the control signaling includes: generating a switching frequency, based on the second electrical characteristic, to drive the power switching elements with variable-frequency critical soft switching control signals.

Example 50: The method, apparatus, and/or non-transitory computer readable medium of any of Examples 45 to 49 generating, by a central controller, at least N control reference targets including at least one control reference target for each phase of the N-phases; and receiving, by the local controller, a first control reference target of the N control reference targets, wherein generating the control signaling is further based on the first control reference target.

Example 51: The method, apparatus, and/or non-transitory computer readable medium of any of Examples 45 to 50, wherein the power converter is a multiphase power converter where N=3, wherein the multiphase power converter includes: N local converters including the local controller, a second local controller, and a third local controller, N sensors including the sensor, a second sensor corresponding to with the second local controller, and a third sensor corresponding to the third local controller, and N LC filters including the LC filter, a second LC filter corresponding to a second phase of the N phases, and a third LC filter corresponding to a third phase of the N phases, and the method further comprising: performing state estimation, by the second local controller based on second sensor data from the second sensor, to estimate an electrical characteristic of a component of the second LC filter; generating, by the second local controller, second control signaling, based on the electrical characteristic of the component of the second LC filter, to drive power switching elements corresponding to the second phase of the N phases; performing state estimation, by the third local controller based on third sensor data from the third sensor, to estimate an electrical characteristic of a component of the third LC filter; and generating, by the third local controller, third control signaling, based on the electrical characteristic of the component of the third LC filter, to drive power switching elements corresponding to the third phase of the N phases.

Example 52: The method, apparatus, and/or non-transitory computer readable medium of any of Examples 45 to 51, further comprising: generating, by a central controller, at least N control reference targets including at least one control reference target for each phase of the N-phases; receiving, by the local controller, a first control reference target of the N control reference targets, wherein generating the control signaling is further based on the first control reference target; receiving, by the second local controller, a second control reference target of the N control reference targets, wherein generating the second control signaling is further based on the second control reference target; and receiving, by the third local controller, a third control reference target of the N control reference targets, wherein generating the third control signaling is further based on the third control reference target.

Example 53: A method, apparatus, and/or non-transitory computer readable medium comprising: one or more power converter modules, each power converter module including: a positive direct current (DC) terminal and a negative DC terminal, a power switching element pair including a high side power switching element coupled to the positive DC terminal and a low side power switching element coupled to the negative DC terminal, wherein the high side power switching element and the low side power switching element are coupled together at a midpoint node, an LC filter coupled to the midpoint node, the positive DC terminal, and the negative DC terminal, and a local controller configured to: receive a control reference target; generate control signaling to drive the power switching element pair based on the control reference target using model predictive control (MPC) and variable frequency soft switching.

Example 54: The method, apparatus, and/or non-transitory computer readable medium of Example 53, wherein the local controller of each power converter module is further configured to: generate, using MPC, a duty cycle value for the power switching element pair; and generate a switching frequency for the power switching element pair.

Example 55: The method, apparatus, and/or non-transitory computer readable medium of any of Examples 53 to 54, wherein, to generate the duty cycle value using MPC, the local controller is configured to, at each control period: determine local electrical characteristics for a phase of AC that is associated with the local controller; solve a cost function using the local electrical characteristics and the control reference target received by the local controller to predict future steps of control signals to control the phase of the N phases towards the control reference target; and generate the control signaling based on a first step of the future steps of control signals.

Example 56: The method, apparatus, and/or non-transitory computer readable medium of any of Examples 53 to 55, wherein, to generate the switching frequency, the local controller is configured to, at each control period: calculate a switching frequency based on the duty cycle value and local electrical characteristics for a phase of AC that is associated with the local controller.

Example 57: The method, apparatus, and/or non-transitory computer readable medium of any of Examples 53 to 56, wherein, to generate the switching frequency, the local controller is configured to, at each control period: calculate a switching frequency using a continuous switching frequency function or a discrete switching frequency function.

Example 58: The method, apparatus, and/or non-transitory computer readable medium of any of Examples 53 to 57, wherein the local controller of each power converter module is further configured to: estimate, using a state estimator, a first local electrical characteristic of local electrical characteristics for a phase of AC that is associated with the local controller, wherein the estimate is based on samplings of other local electrical characteristics of the local electrical characteristics for the AC phase that is associated with the local controller; generate, using MPC, a duty cycle value for the power switching element pair based on the first local electrical characteristic and on the control reference target; and generate a switching frequency for the power switching element pair based on the duty cycle value and the first local electrical characteristic.

Example 59: The method, apparatus, and/or non-transitory computer readable medium of any of Examples 53 to 58, wherein the LC filter of each power converter module includes: a switch-side inductor, an upper capacitor, and a lower capacitor, the switch-side inductor coupled between the midpoint node and a filter node, the upper capacitor coupled between the filter node and the positive DC terminal, and the lower capacitor coupled between the filter node and the negative DC terminal.

Example 60: The method, apparatus, and/or non-transitory computer readable medium of any of Examples 53 to 59, further comprising: a central controller including a processing unit, the central controller forming a cascaded control system with the local controller, the central controller configured to: determine rotational reference frame targets, and generate the control reference target based on the rotational reference frame targets.

Example 61: The method, apparatus, and/or non-transitory computer readable medium of any of Examples 53 to 60, wherein the one or more power converter modules includes at least three power converter modules, the central controller further configured to: generate the control reference target for the local controller of each of the at least three power converter modules based on the rotational reference frame targets.

Example 62: The method, apparatus, and/or non-transitory computer readable medium of any of Examples 53 to 61, wherein the at least one power converter module is one or more of an AC-to-DC rectifier and a DC-to-AC inverter.

Example 63: The method, apparatus, and/or non-transitory computer readable medium of any of Examples 53 to 62, wherein the at least one power converter module further includes AC interface terminals coupled to an AC power grid or an AC motor.

Example 64. A method, apparatus, and/or non-transitory computer readable medium comprising: receiving, by a local controller of a power converter module, a control reference target, wherein the local controller is coupled to a power switching element pair including a high side power switching element coupled to a positive DC terminal for of the power converter module and a low side power switching element coupled to the negative DC terminal of the power converter module, wherein the high side power switching element and the low side power switching element are coupled together at a midpoint node, and an LC filter is coupled to the midpoint node, the positive DC terminal, and the negative DC terminal; generating, by the local controller, control signaling to drive the power switching element pair based on the control reference target using model predictive control (MPC) and variable frequency soft switching; and filtering, by the LC filter, a power signal provided to or received from the midpoint node.

Example 65: The method, apparatus, and/or non-transitory computer readable medium of Example 64, further comprising: generating, by the local controller, a duty cycle value for the power switching element pair using MPC; and generating, by the local controller, a switching frequency for the power switching element pair

Example 66: The method, apparatus, and/or non-transitory computer readable medium of any of Examples 64 to 65, wherein generating, by the local controller, the duty cycle value using MPC comprises, at each control period: determining local electrical characteristics for a phase of AC that is associated with the local controller; solving a cost function using the local electrical characteristics and the control reference target received by the local controller to predict future steps of control signals to control the phase of the N phases towards the control reference target; and generating the control signaling based on a first step of the future steps of control signals.

Example 67: The method, apparatus, and/or non-transitory computer readable medium of any of Examples 64 to 66, wherein generating, by the local controller, the switching frequency comprises, at each control period: calculating a switching frequency based on the duty cycle value and local electrical characteristics for a phase of AC that is associated with the local controller.

Example 68: The method, apparatus, and/or non-transitory computer readable medium of any of Examples 64 to 67, wherein generating, by the local controller, the switching frequency comprises, at each control period: calculating a switching frequency using a continuous switching frequency function or a discrete switching frequency function.

Example 69: The method, apparatus, and/or non-transitory computer readable medium of any of Examples 64 to 68, estimating, by the local controller using a state estimator, a first local electrical characteristic of local electrical characteristics for a phase of AC that is associated with the local controller, wherein the estimate is based on samplings of other local electrical characteristics of the local electrical characteristics for the AC phase that is associated with the local controller; generating, by the local controller using MPC, a duty cycle value for the power switching element pair based on the first local electrical characteristic and on the control reference target; and generating, by the local controller, a switching frequency for the power switching element pair based on the duty cycle value and the first local electrical characteristic.

Example 70: The method, apparatus, and/or non-transitory computer readable medium of any of Examples 64 to 69, wherein the LC filter of each power converter module includes: a switch-side inductor, an upper capacitor, and a lower capacitor, the switch-side inductor coupled between the midpoint node and a filter node, the upper capacitor coupled between the filter node and the positive DC terminal, and the lower capacitor coupled between the filter node and the negative DC terminal.

Example 71: The method, apparatus, and/or non-transitory computer readable medium of any of Examples 64 to 70, further comprising: determining, by a central controller, rotational reference frame targets, wherein the central controller forms a cascaded control system with the local controller; and generating, by the central controller, the control reference target for the local controller based on the rotational reference frame targets.

Example 72: The method, apparatus, and/or non-transitory computer readable medium of any of Examples 64 to 71, wherein the local controller is a first local controller and the power converter module is a first power converter module of a three-phase power converter that further includes a central controller, a second power converter module with a second local controller, and a third power converter module with a third local controller, the method further comprising: determining, by the central controller, rotational reference frame targets, wherein the central controller forms a cascaded control system with the first local controller, the second local controller, and the third local controller; generating, by the central controller, the control reference target for the first local controller based on the rotational reference frame targets; generating, by the central controller, a second control reference target for the second local controller based on the rotational reference frame targets; generating, by the central controller, a third control reference target for the third local controller based on the rotational reference frame targets; generating, by the second local controller, control signaling to drive a second power switching element pair based on the second control reference target using model predictive control (MPC) and variable frequency soft switching; and generating, by the third local controller, control signaling to drive a third power switching element pair based on the third control reference target using model predictive control (MPC) and variable frequency soft switching.

Example 73: The method, apparatus, and/or non-transitory computer readable medium of any of Examples 64 to 72, further comprising one or more of: rectifying, by the at least one power converter, AC power to DC power based on the control signaling, or inverting, by the least one power converter, DC power to AC power based on the control signaling.

Example 74: A method, apparatus, and/or non-transitory computer readable medium comprising: a non-isolated N-phase power converter, for N≥1, with a DC voltage section, an N-phase AC voltage section; and a cascaded control system to control the power converter, the cascaded control system comprising: a central controller including a processing unit, the central controller configured to: receive electrical operational characteristics of the power converter, and generate at least N control reference targets including at least one control reference target for each of the N-phases of the power converter; and a plurality of local model predictive control (MPC) controllers including at least two local MPC controllers per phase of the N-phase power converter, each local MPC controller being associated with a respective converter block that includes a pair of power switching elements and an LC filter for the phase corresponding to the local MPC controller, and each of the local MPC controllers being configured to: receive a control reference target of the N control reference targets for the phase associated with the local MPC controllers, and generate, using model predictive control (MPC), control signaling based on the control reference signal to drive the pair of power switching elements associated with the local MPC controller.

Example 75: The method, apparatus, and/or non-transitory computer readable medium of Example 74, wherein each LC filter includes a switch side inductor and a lower capacitor, and wherein each converter block associated with one of the local MPC controllers further includes: a midpoint node connecting a high-side element and a low-side element of the power switching elements of the converter block, and a filter node, wherein the switch side inductor of the LC filter of the converter block is coupled between the midpoint node and the filter node, and wherein the lower capacitor of the converter block is coupled between the filter node and a negative DC bus of the DC voltage section of the power converter.

Example 76: The method, apparatus, and/or non-transitory computer readable medium of any of Examples 74 to 75, wherein each LC filter further includes an upper capacitor, and wherein each converter block associated with one of the local MPC controllers further includes: the upper capacitor of the LC filter of the converter block coupled between the filter node of the converter block and the negative DC bus of the DC voltage section of the power converter.

Example 77: The method, apparatus, and/or non-transitory computer readable medium of any of Examples 74 to 76, wherein, to generate the control signaling using MPC, at each control period, each local MPC controller of the plurality of local MPC controllers is configured to: determine local electrical characteristics for the converter block that is associated with the local MPC controller; solve a cost function using the local electrical characteristics and the control reference target received by the local MPC controller to predict future steps of control signals to control the phase of the N phases towards the control reference target; and generate the control signaling based on a first step of the future steps of control signals.

Example 78: The method, apparatus, and/or non-transitory computer readable medium of any of Examples 74 to 77, wherein each local MPC controller is associated with a respective state estimator, wherein, for each local MPC controller, the respective state estimator is configured to estimate a first local electrical characteristic of the local electrical characteristics for the converter block that is associated with the local MPC controller, wherein the estimate is based on samplings of other local electrical characteristics of the local electrical characteristics for the converter block that is associated with the local MPC controller; and wherein each local MPC controller, to determine the local electrical characteristics for the converter block that is associated with the local MPC controller, receives the first local electrical characteristic estimated by the state estimator associated with the local MPC controller.

Example 79: The method, apparatus, and/or non-transitory computer readable medium of any of Examples 74 to 78, wherein the central controller is configured to: determine rotational reference frame targets, the rotational reference frame targets including a zero-sequence component target, wherein the zero-sequence component target is based on a multiple of N-th phase harmonic injection, wherein the at least N control reference targets are generated based on the rotational reference frame targets.

Example 80: The method, apparatus, and/or non-transitory computer readable medium of any of Examples 74 to 79, wherein the central controller is further configured to: determine a direct axis (D-axis) component and a quadrature axis (Q-axis) component of the rotational reference frame targets based on the electrical operational characteristics in the rotating reference frame.

Example 81: The method, apparatus, and/or non-transitory computer readable medium of any of Examples 74 to 80, wherein, to determine the direct axis (D-axis) component and the quadrature axis (Q-axis) component of the rotational reference frame targets based on the electrical operational characteristics in the rotating reference frame, the central controller is configured to: convert a current signal from the AC voltage section of the power converter to a direct axis (D-axis) current component and a quadrature axis (Q-axis) current component in the rotational reference frame, generate a D-axis voltage component, as the D-axis component of the rotational reference frame targets, based on a comparison of the D-axis current component to a desired D-axis current, and generate a Q-axis voltage component, as the Q-axis component of the rotational reference frame targets, based on a comparison of the Q-axis current component to a desired Q-axis current; and wherein, to generate the N control reference targets in the stationary reference frame based on the rotational reference frame targets, the central controller is further configured to: convert the D-axis voltage component, Q-axis voltage component, and the zero-sequence component target to a the stationary reference frame.

Example 82: The method, apparatus, and/or non-transitory computer readable medium of any of Examples 74 to 81, wherein the power converter is one or more of an AC-to-DC rectifier and a DC-to-AC inverter.

Example 83: The method, apparatus, and/or non-transitory computer readable medium of any of Examples 74 to 82, wherein the AC voltage section of the power converter is coupled to an AC power grid or an AC motor.

Example 84: The method, apparatus, and/or non-transitory computer readable medium of any of Examples 74 to 83, wherein, to generate the control signaling to drive the pair of power switching elements associated with the local MPC controller, each local MPC controller is further configured to: generate the control signaling with variable-frequency critical soft switching control signals.

Example 85: The method, apparatus, and/or non-transitory computer readable medium of any of Examples 74 to 84, further comprising: a plurality of power converter modules, each power converter module including: a positive direct current (DC) terminal and a negative DC terminal, a local MPC controller of the plurality of local MPC controllers, the converter block associated with the local MPC controller, and a circuit board having located thereon the positive and negative DC terminals, the local MPC controller, and the converter block associated with the local converter; wherein the positive DC terminal of each of the plurality of power converter modules are coupled together and the negative DC terminal of the plurality of power converter modules are coupled together; and wherein the central controller is located on a separate circuit board than the circuit boards having the local MPC controllers.

Example 86: The method, apparatus, and/or non-transitory computer readable medium of any of Examples 74 to 85, wherein N=3 and the non-isolated N-phase power converter is a three-phase power converter.

Example 87: A method, apparatus, and/or non-transitory computer readable medium for voltage conversion with a non-isolated N-phase power converter for N≥1, comprising: receiving, by a central controller of a cascaded control system including a plurality of local model predictive control (MPC) controllers cascaded with the central controller, electrical operational characteristics of the power converter, the power converter including a DC voltage section, and an N-phase AC voltage section, wherein the plurality of local MPC controllers include at least two local MPC controllers per phase of the N-phase power converter and each local MPC controller is associated with a respective converter block that includes a pair of power switching elements and an LC filter for the phase corresponding to the local MPC controller; generating, by the central controller, at least N control reference targets including at least one control reference target for each of the N-phases of the power converter; receiving, by each of the local MPC controllers, a control reference target of the N control reference targets for the phase associated with the local MPC controller, and generating, by each of the local MPC controllers, using model predictive control (MPC), control signaling based on the control reference target received to drive the pair of power switching elements associated with the local MPC controller.

Example 88: The method, apparatus, and/or non-transitory computer readable medium of Example 87, further comprising: filtering, by each LC filter, wherein each LC filter includes a switch side inductor and a lower capacitor, and wherein each converter block associated with one of the local MPC controllers further includes: a midpoint node connecting a high-side element and a low-side element of the power switching elements of the converter block, and a filter node, wherein the switch side inductor of the LC filter of the converter block is coupled between the midpoint node and the filter node, and wherein the lower capacitor of the converter block is coupled between the filter node and a negative DC bus of the DC voltage section of the power converter.

Example 89: The method, apparatus, and/or non-transitory computer readable medium of any of Examples 87 to 88, wherein each LC filter further includes an upper capacitor, and wherein each converter block associated with one of the local MPC controllers further includes: the upper capacitor of the LC filter of the converter block coupled between the filter node of the converter block and the negative DC bus of the DC voltage section of the power converter.

Example 90: The method, apparatus, and/or non-transitory computer readable medium of any of Examples 87 to 89, wherein generating the control signaling using MPC includes, at each control period, each local MPC controller of the plurality of local MPC controllers: determining local electrical characteristics for the converter block that is associated with the local MPC controller; solving a cost function using the local electrical characteristics and the control reference target received by the local MPC controller to predict future steps of control signals to control the phase of the N phases towards the control reference target; and generating the control signaling based on a first step of the future steps of control signals.

Example 91: The method, apparatus, and/or non-transitory computer readable medium of any of Examples 87 to 90, wherein each local MPC controller is associated with a respective state estimator, the method further comprising: estimating, by each state estimator, a first local electrical characteristic of the local electrical characteristics for the converter block that is associated with the local MPC controller that is associated with the state estimator, wherein the estimate is based on samplings of other local electrical characteristics of the local electrical characteristics for the converter block that is associated with the local MPC controller; and wherein determining the local electrical characteristics for the converter block that is associated with the local MPC controller further includes each local MPC controller receiving the first local electrical characteristic estimated by the state estimator associated with the local MPC controller.

Example 92: The method, apparatus, and/or non-transitory computer readable medium of any of Examples 87 to 91, further comprising: determining, by the central controller, rotational reference frame targets, the rotational reference frame targets including a zero-sequence component target, wherein the zero-sequence component target is based on a multiple of N-th phase harmonic injection, wherein the at least N control reference targets are generated based on the rotational reference frame targets.

Example 93: The method, apparatus, and/or non-transitory computer readable medium of any of Examples 87 to 82, wherein the central controller is further configured to: determine a direct axis (D-axis) component and a quadrature axis (Q-axis) component of the rotational reference frame targets based on the electrical operational characteristics in the rotating reference frame.

Example 94: The method, apparatus, and/or non-transitory computer readable medium of any of Examples 87 to 93, wherein determining the direct axis (D-axis) component and the quadrature axis (Q-axis) component of the rotational reference frame targets includes: converting a current signal from the AC voltage section of the power converter to a direct axis (D-axis) current component and a quadrature axis (Q-axis) current component in the rotational reference frame, generating a D-axis voltage component, as the D-axis component of the rotational reference frame targets, based on a comparison of the D-axis current component to a desired D-axis current, and generating a Q-axis voltage component, as the Q-axis component of the rotational reference frame targets, based on a comparison of the Q-axis current component to a desired Q-axis current; and wherein generating the N control reference targets in the stationary reference frame based on the rotational reference frame targets includes: converting the D-axis voltage component, Q-axis voltage component, and the zero-sequence component target to the stationary reference frame.

Example 95: The method, apparatus, and/or non-transitory computer readable medium of any of Examples 87 to 94, wherein generating, by each local MPC controller, the control signaling to drive the pair of power switching elements associated with the local MPC controller includes: generating, by each local MPC controller, the control signaling with variable-frequency critical soft switching control signals.

1. A power converter system comprising:
a non-isolated N-phase power converter, for N≥1, with a DC voltage section and an N-phase AC voltage section, the power converter including power switching elements; and
a control system configured to control the power converter, the control system configured to:
determine rotational reference frame targets, the rotational reference frame targets including a zero-sequence component target, wherein the zero-sequence component target is based on a multiple of N-th phase harmonic injection,
generate N control reference targets in a stationary reference frame, one for each of the N-phases of the N-phase power converter, based on the rotational reference frame targets,
generate control signals for the power switching elements based on the N control reference targets, and
drive the power switching elements in accordance with the control signals.

2. The power converter system of claim 1, where the control system is a cascaded control system comprising:
a central controller including a processing unit, the central controller configured to:
determine the rotational reference frame targets, and generate the N control reference targets; and
at least one local controller, each of the at least one local controller including a local processing unit, each of the at least one local controller configured to:
receive a control reference target of the N control reference targets, and
drive a portion of the power switching elements, associated with the local controller, in accordance with the control reference target.

3. The power converter system of claim 2, wherein, to drive the portion of the power switching elements in accordance with the control reference target, each of the at least one local controller is configured to:
implement model predictive control (MPC) to generate control signaling for the portion of the power switching elements.

4. The power converter system of claim 2, wherein the central controller is further configured to:
receive at least one electrical operational characteristic from each of the at least one local controller, the electrical operational characteristics in the stationary reference frame;
convert the at least one electrical operational characteristic to the rotating reference frame; and
determine a direct axis (D-axis) component and a quadrature axis (Q-axis) component of the rotational reference frame targets based on the at least one electrical operational characteristic in the rotating reference frame.

5. The power converter system of claim 4, wherein the central controller is further configured to:
determine a frequency of an alternating power signal of the AC section of the power converter based on a first characteristic of the at least one electrical operational characteristic in the rotating reference frame.

6. The power converter system of claim 4,
wherein, to determine the direct axis (D-axis) component and the quadrature axis (Q-axis) component of the rotational reference frame targets based on the at least one electrical operational characteristic in the rotating reference frame, the central controller is configured to:
convert a current signal from the AC section of the power converter to a direct axis (D-axis) current component and a quadrature axis (Q-axis) current component in the rotational reference frame,
generate a D-axis voltage component, as the D-axis component of the rotational reference frame targets, based on a comparison of the D-axis current component to a desired D-axis current, and
generate a Q-axis voltage component, as the Q-axis component of the rotational reference frame targets, based on a comparison of the Q-axis current component to a desired Q-axis current; and
wherein, to generate the N control reference targets in the stationary reference frame based on the rotational reference frame targets, the central controller is further configured to:
convert the D-axis voltage component, Q-axis voltage component, and the zero-sequence component target to the stationary reference frame.

7. The power converter system of claim 1, wherein the zero-sequence component target includes a sum of a DC offset and the multiple of N-th phase harmonic injection.

8. The power converter system of claim 7, wherein at least one of the DC offset is half a DC bus voltage of the DC voltage section of the power converter, or
N is 3 and the multiple of N-th phase harmonic injection is a third order of a fundamental frequency of the AC voltage section of the power converter.

9. The power converter system of claim 8, wherein the multiple of N-th phase harmonic injection comprises:
a sinusoidal signal derived based on an N-th order of a fundamental frequency of the AC voltage section of the power converter; or
a triangular signal derived based on mean values of maximum and minimum values of the fundamental frequency of the AC voltage section of the power converter.

10. The power converter system of any of claim 8, wherein the multiple of N-th phase harmonic injection is a feedback signal that is calculated from at least one selected from the group of:
N previous control reference targets generated by the control system in a stationary reference frame based on previously received rotational reference frame targets,
N voltage measurements provided by a respective voltage sensor for each phase of the N phases of the power converter, or
N voltage measurements communicated by at least one local controller indicating a respective voltage for each phase of the N phases of the power converter.

11. The power converter system of claim 1, wherein the power switching elements include, for each phase of the N phases of the power converter, a high-side element and a low-side element connected at a midpoint node, and
wherein the midpoint node of each phase of the N phases of the power converter is coupled to a respective LC filter including an inductor coupled between the midpoint node and a filter node, and one or more of a first capacitor coupled between the filter node and a positive DC bus of the power converter or a second capacitor coupled between the filter node and a negative DC bus of the power converter.

12. The power converter system of claim 1, wherein the power converter is one or more of an AC-to-DC rectifier and a DC-to-AC inverter.

13. The power converter system of claim 1, wherein the AC section of the power converter is coupled to an AC power grid or an AC motor.

14. The power converter system of claim 2, wherein
an LC filter including a switch-side inductor and capacitor; and
a sensor configured to sense a first electrical characteristic of a first component of the LC filter selected from the group of the switch-side inductor and the capacitor, and to generate sensor data indicative of the first electrical characteristic; and
wherein each of the at least one local controller is further configured to:
receive the sensor data from the sensor,
perform state estimation, based on the sensor data, to estimate a second electrical characteristic of a second component of the LC filter that is different from the first component, and
to drive the portion of the power switching elements further based on the second electrical characteristic.

15. The power converter system of claim 2, wherein, to drive the portion of the power switching elements, each of the at least one local controller is further configured to:
drive the portion of the power switching elements with variable-frequency critical soft switching control signals.

16. The power converter system of claim 2, further comprising:
N power converter modules, where N>1, each power converter module including:
a positive direct current (DC) terminal and a negative DC terminal,
a power switching element pair including a high side power switching element coupled to the positive DC terminal and a low side power switching element coupled to the negative DC terminal, wherein the high side power switching element and the low side power switching element are coupled together at a midpoint node,
an LC filter including a capacitor and an inductor, the inductor coupled between the midpoint node and a capacitor, the capacitor coupled between the inductor and the negative DC terminal,
a local controller of the at least one local controllers configured to drive the power switching element pair, wherein the power switching element pair is the portion of power switching elements associated with the local controller, and
a circuit board having located thereon the positive and negative DC terminals, the power switching element pair, the LC filter, and the local controller;
wherein the positive DC terminal of each of the N power converter modules are coupled together and the negative DC terminal of each of the one or more power converters are coupled together; and
wherein the central controller is located on a separate circuit board than the circuit boards having the local controllers.

17. A method of converting voltage, the method comprising:
determining rotational reference frame targets, the rotational reference frame targets including a zero-sequence component target, wherein the zero-sequence component target is based on a multiple of N-th phase harmonic injection;
generating N control reference targets in a stationary reference frame based on the rotational reference frame targets, where one control reference target is generated for each of N-phases of a non-isolated N-phase power converter, where N≥1, and where the power converter includes a DC voltage section, an N-phase AC voltage section, and power switching elements; and
driving the power switching elements of the power converter in accordance with the N control reference targets.

18. The method of claim 17, further comprising, by a cascaded control system:
determining, by a central controller, the rotational reference frame targets;
generating, by the central controller, the N control reference targets;
receiving, by each of at least one local controller, a control reference target of the N control reference targets; and
driving, by each of the at least one local controller, a portion of the power switching elements in accordance with the control reference target.

19. The method of claim 18, wherein driving, by each of the at least one local controller, the portion of the power switching elements in accordance with the control reference target, comprises:
implementing, by each of the at least one local controller, model predictive control (MPC) to generate control signaling for the portion of the power switching elements.

20. The method of claim 18, further comprising:
receiving, by the central controller, at least one electrical operational characteristic from each of the at least one local controller, the at last one electrical operational characteristic in the stationary reference frame;
converting, by the central controller, the at least one electrical operational characteristic to the rotating reference frame; and
determining, by the central controller, a direct axis (D-axis) component and a quadrature axis (Q-axis) component of the rotational reference frame targets based on the at least one electrical operational characteristic in the rotating reference frame.

21. The method of claim 20, wherein the central controller is further configured to:
determining, by the central controller, a frequency of an alternating power signal of the AC section of the power converter based on a first characteristic of the at least one electrical operational characteristic in the rotating reference frame.

22. The method of claim 20,
wherein determining the direct axis (D-axis) component and the quadrature axis (Q-axis) component of the rotational reference frame targets based on the at least one electrical operational characteristic in the rotating reference frame comprises:
converting a current signal from the AC section of the power converter to a direct axis (D-axis) current component and a quadrature axis (Q-axis) current component in the rotational reference frame,
generating a D-axis voltage component, as the D-axis component of the rotational reference frame targets, based on a comparison of the D-axis current component to a desired D-axis current, and
generating a Q-axis voltage component, as the Q-axis component of the rotational reference frame targets, based on a comparison of the Q-axis current component to a desired Q-axis current; and
wherein generating the N control reference targets in the stationary reference frame based on the rotational reference frame targets comprises:
converting the D-axis voltage component, Q-axis voltage component, and the zero-sequence component target to the stationary reference frame.

23. The method of claim 22, wherein the zero-sequence component target includes a sum of a DC offset and the multiple of N-th phase harmonic injection.

24. The method of claim 23, wherein at least one of the DC offset is half a DC bus voltage of the DC voltage section of the power converter, or
N is 3 and the multiple of N-th phase harmonic injection is a third order of a fundamental frequency of the AC voltage section of the power converter.

25. The method of claim 24, wherein the multiple of N-th phase harmonic injection comprises:
a sinusoidal signal derived based on an N-th order of a fundamental frequency of the AC voltage section of the power converter; or
a triangular signal derived based on mean values of maximum and minimum values of the fundamental frequency of the AC voltage section of the power converter.

26. The method of claim 24, wherein the multiple of N-th phase harmonic injection is a feedback signal that is calculated from at least one selected from the group of:
N previous control reference targets generated by the control system in a stationary reference frame based on previously received rotational reference frame targets,
N voltage measurements provided by a respective voltage sensor for each phase of the N phases of the power converter, and
N voltage measurements communicated by at least one local controller indicating a respective voltage for each phase of the N phases of the power converter.

27. The method of claim 17, wherein the power switching elements include, for each phase of the N phases of the power converter, a high-side element and a low-side element connected at a node, and
wherein the node of each phase of the N phases of the power converter is coupled to a respective LC filter including an inductor coupled between the node and a filter node, and one or more of a first capacitor coupled between the filter node and a positive DC bus of the power converter or a second capacitor coupled between the filter node and a negative DC bus of the power converter.

28. The method of claim 17, further comprising one or more of:
rectifying, by the power converter, AC power to DC power based on the driving of the power switching elements of the power converter in accordance with the N control reference targets, or
inverting, by the power converter, DC power to AC power based on the driving of the power switching elements of the power converter in accordance with the N control reference targets.

29. The method of claim 17, further comprising one or more of:
receiving AC power, by the AC section of the power converter, from an AC power grid,
providing AC power, by the AC section of the power converter, to the AC power grid, or
providing AC power, by the AC section of the power converter, to an AC motor.

30.-111. (canceled)
